(19) United States
(12) Patent Application Publication
(10) Pub. No.: US 2026/0268252 A1
(43) Pub. Date: Sep. 10, 2026

(54) SYSTEMS AND METHODS FOR AI-DRIVEN WORKFLOW PLATFORM WITHOUT MOVING DATA FROM CLOSED DATA WAREHOUSE

(71) Applicant: ELEMENTUM LTD, San Mateo, CA (US)

(72) Inventors: David A. BLONSKI, San Francisco, CA (US); Karen JENKINS, Atlanta, GA (US); Nader MIKHAIL, Huntington Beach, CA (US); Robert HUGHES, Lehi, UT (US); Porter HOSKINS, Saratoga Springs, UT (US); Josh WAITE, West Jordan, UT (US)

(21) Appl. No.: 19/354,627

(22) Filed: Oct. 9, 2025

Related U.S. Application Data
(60) Provisional application No. 63/769,451, filed on Mar. 10, 2025.
(60) Provisional application No. 63/802,083, filed on May 8, 2025.

(51) Int. Cl. G06Q 10/0631; G06F 3/0486

(52) U.S. Cl. CPC G06Q 10/06316; G06F 3/0486; G06F 9/4881; G06F 16/254; G06Q 40/03055

(57) ABSTRACT

A method is provided for an artificial intelligence (AI)-driven workflow platform. The method comprises: (a) executing a workflow, where at least a portion of the workflow is automated by an AI agent, the AI agent resides on a data cloud configuration that is operatively coupled to the AI-driven workflow platform; (b) storing, by an agent memory residing on the data cloud configuration, context data or workflow states generated during execution of the workflow; (b) generating, by an agent orchestrator residing on the AI-driven workflow platform, a structured prompt for the AI agent and one or more parameters for executing one or more tools provided by the AI-driven workflow platform. The structured prompt is generated based at least in part on the context data or workflow states stored on the data cloud configuration.

### CROSS-REFERENCE

This application claims the priority and benefit of U.S. Provisional Application No. 63/802,083, filed May 8, 2025, and U.S. Provisional Application No. 63/769,451, filed Mar. 10, 2025, each of which is incorporated herein by reference in its entirety.

### BACKGROUND

Computing systems are ubiquitous in modern businesses and typically are employed as critical operating resources. For example, many enterprises utilize so-called “enterprise resource planning” (or “ERP”) systems to assist with various aspects of financial management, human resources, inventory management, and the like. Other commonly utilized distributed computing business systems include those known as “transportation management systems” (or “TMS”), which may be utilized to plan, monitor, and optimize logistics and transportation, as well as those known as “risk management systems” (or “RMS”), which may be utilized to assist compliance officers and others regarding the risk profile of an enterprise as well as levels of adherence to applicable rules and regulations. The global ERP software market alone is estimated to be in the range of $45 billion annually, with providers such as SAP®, Oracle®, Workday® and others providing various solutions.

Agentic artificial intelligence (AI) and AI agent has been employed in automating business workflows. Agentic artificial intelligence (AI) is the technology that powers AI agents so they can act autonomously without human oversight. Agentic AI facilitates seamless interaction between AI agents and humans, fostering a collaborative environment where both can work together. However, current AI agents may need to access large amount of data which requires duplicating data or moving data. Additionally, AI agent may have agent hallucinations where the AI generates plausible-sounding but incorrect outputs. Traditional mitigation techniques often involve increasing model size, fine-tuning, or post-processing. however, such traditional mitigation methods may not fully solve the problem or lack of the capability to scale securely.

### SUMMARY

Current data-heavy applications (e.g., ERP software, ERP application, RMS application, etc.) may require integration with the cloud lake or data warehouse, copying or downloading the data from the cloud for business intelligence analysis, computation and execute workflows on the local data. For example, ETL (extract, transform, load) or ELT (load and transform in data warehouse) processes are required to move data from one database, multiple databases, or other sources to a unified repository.

A need exists for a service management cloud that can be connected natively to the cloud, allowing for cloud applications created and executed on real-time data in the existing cloud-based repository without the need to integrate, transform, or download. The present disclosure provides systems and methods allowing for users to create, customize and manage applications for managing data flows and processes utilizing distributed computing systems. In particular, systems and methods herein may be utilized for business process optimization wherein operations and processes may be managed and utilized without conventional relocation and/or duplication of enterprise data. The present disclosure provides a unified AI-driven workflow (e.g., cloud-native SaaS platform for no-code business applications with data-driven workflows) for users, organizations or cloud services providers to access their cloud data, process the cloud data for business applications that initiate and manage workflows by connecting natively to the cloud without the need to integrate, transform, or download the data thereby improving efficiency. The platform herein may allow users to create, customize and/or configure cloud applications via a no-code user interface with built-in features such as data mining, configurable and automated workflows, and dynamic relationships discovery and creation.

The platform may comprise an AI-driven workflow platform that allows users to leverage any AI agents, AI model, machine learning (ML) model or large language model (LLM) to extract insights and drive workflows without moving or duplicating data. For example, at least an action or a component of the workflow may be performed by an AI model, an AI agent, a machine learning (ML) model or a large language model (LLM). The present disclosure may provide an architecture and implementation of running an AI-driven agent on the platform without requiring data movement from a customer's data warehouse or storage. The system enables real-time processing, decision-making, and workflow automation while maintaining data residency within the customer's environment.

In some embodiments, the platform and system may reduce AI agent hallucinations (instances the AI generates plausible-sounding but incorrect outputs) by constraining agent behavior through defined tools. For instance, agents are guided or constrained to call approved tools instead of generating free-form answers. The platform may provide user interface allowing users to define and manage a toolset. A toolset may include but not limited to, business logic, permission boundaries, and expected inputs/outputs. The system or platform may allow AI agents to execute tools in-place (against the user's data environment or customer environment), without storing or persisting customer data. The system herein may further comprise observability and traceability features built into the tool invocation chain, allowing audits and debugging of agent reasoning.

In an aspect, an artificial intelligence (AI)-driven workflow platform is provided. The platform comprises: a graphical user interface (GUI) for a user to build an interactive workflow, where at least a portion of the interactive workflow is automated by an AI agent; an agent orchestrator residing on the AI-driven workflow platform for managing an execution; the AI agent residing on a data cloud configuration that is operatively coupled to the AI-driven workflow platform, where the agent orchestrator is configured to generate a structured prompt for the AI agent and one or more parameters for executing one or more tools provided by the AI-driven workflow platform; and an agent memory residing on the data cloud configuration for storing context data or workflow states. In some embodiments, the agent orchestrator is configured to generate the structured prompt based at least in part on the context data or workflow states stored on the data cloud configuration.

In some embodiments, the structured prompt comprise context information and constraints injected by the agent orchestrator. In some cases, the structured prompt is generated further based on an execution parameter or data access policy. In some embodiments, the one or more tools comprise at least one of a workflow automation tool, a communication tool, a data retrieval tool, an integration application programming interface (API), and a decision support tool. In some cases, the interactive workflow is executed without moving data from the data cloud configuration.

In an aspect, a computer-implemented method for an artificial intelligence (AI)-driven workflow platform is provided. The method comprises: (a) executing a workflow, wherein at least a portion of the workflow is automated by an AI agent, where the AI agent resides on a data cloud configuration that is operatively coupled to the AI-driven workflow platform; (b) storing, by an agent memory residing on the data cloud configuration, context data or workflow states generated during execution of the workflow; (b) generating, by an agent orchestrator residing on the AI-driven workflow platform, a structured prompt for the AI agent and one or more parameters for executing one or more tools provided by the AI-driven workflow platform. The structured prompt is generated based at least in part on the context data or workflow states stored on the data cloud configuration.

In a separate yet related aspect, a system for providing an artificial intelligence (AI)-driven workflow platform is disclosed. The system comprises at least one processor and instructions executable to cause the at least one processor to perform operations comprising: (a) executing a workflow, wherein at least a portion of the workflow is automated by an AI agent, where the AI agent resides on a data cloud configuration that is operatively coupled to the AI-driven workflow platform; (b) storing, by an agent memory residing on the data cloud configuration, context data or workflow states generated during execution of the workflow; (b) generating, by an agent orchestrator residing on the AI-driven workflow platform, a structured prompt for the AI agent and one or more parameters for executing one or more tools provided by the AI-driven workflow platform. The structured prompt is generated based at least in part on the context data or workflow states stored on the data cloud configuration.

In some embodiments, the structured prompt comprises context information and constraints injected by the agent orchestrator thereby limiting data to be accessed by the AI agent. In some embodiments, the agent orchestrator is configured to generate the context information by selecting one or more referential fields of the data to be accessed by the AI agent. In some cases, the one or more referential fields of the data are defined in a design-time configuration and are dynamically adjusted by the agent orchestrator in a run-time configuration.

In some embodiments, the structured prompt is generated further based on an execution parameter or a data access policy. In some embodiments, the one or more tools comprise at least one of a workflow automation tool, a communication tool, a data retrieval tool, an integration application programming interface (API), and a decision support tool.

In some embodiments, the method further comprises storing one or more constraints associated with the one or more tools in a toolset registry provided by the AI-driven workflow platform. In some cases, the toolset registry is configurable by a user via a graphical user interface (GUI) provided by the AI-driven workflow platform. In some instances, executing the one or more tools comprises validating an input or output of the AI agent against the one or more constraints associated with the one or more tools.

In some embodiments, the workflow is executed to perform operations on data objects stored in the data cloud configuration without using an extract, transform and load (ETL) data integration process. In some embodiments, the data cloud configuration comprises one or more data clouds storing data objects, and wherein the AI-driven workflow platform is granted permission to access, process, and edit the data objects stored on the one or more data clouds. In some cases, executing the one or more tools comprises mapping selected data objects stored on the one or more data clouds to a data storage model of the AI-driven workflow platform. In some instances, the method further comprises defining a relationship between the selected data objects and an element of the data storage model. For example, the relationship is defined by a user via a graphical user interface (GUI) provided by the AI-driven workflow platform. In some cases, the GUI permits the user to link one or more data fields of selected data objects to one or more data fields or the element of the data storage model. In some cases, the workflow is an interactive workflow and is built via the GUI. For instance, the interactive flow permits a user to add, remove or modify one or more components of a cloud application by dragging and dropping one or more graphical elements to the interactive flow.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, and the accompanying drawings (also “Figure” and “FIG.” herein), of which:

FIG. 1 shows an example of storing enterprise data in conventional database systems.

FIG. 2 shows an example of cloud-based repository providers.

FIG. 3 schematically shows an example of cloud services and SaaS.

FIG. 4 illustrates an example configuration where a service management cloud system may be configured to have direct interconnectivity between a user and a Data Cloud configuration; FIG. 5 illustrates an example configuration where a service management cloud system may be configured to have direct interconnectivity between a user and a Data Cloud configuration; FIG. 6 illustrates an example configuration where a service management cloud system may be configured to have direct interconnectivity between a user and a Data Cloud configuration; FIG. 7 illustrates an example configuration where a service management cloud system may be configured to have direct interconnectivity between a user and a Data Cloud configuration.

FIG. 8 schematically illustrates a platform providing an interface for view, access and manage process-data all secured within a data cloud.

FIG. 9 schematically illustrates an exemplary service management cloud system.

FIG. 10 illustrates a Service Management Cloud configuration.

FIG. 11 illustrates a Service Management Cloud session configuration.

FIG. 12 illustrates a Service Management Cloud session configuration with write-back capability.

FIG. 13 illustrates a hierarchy configuration for access management, control, and collaboration within the platform; FIG. 14 shows an example of collaboration within and outside of an organization; FIG. 15 shows an example of collaboration within the platform.

FIG. 16 illustrates the platform with secure and efficiently-administered access.

FIG. 17 illustrates an example of setting up connection to data sources in a data cloud, and mapping the source data to data elements in the platform.

FIG. 18 shows examples of use cases for configuring and employing Data-driven workflow platform variations in sophisticated business processes with varying levels of automation; FIG. 19 shows an example of ESG analysis; FIG. 20 shows an example of supply-chain-related business process.

FIG. 21 shows an example of GUIs for creating and/or editing an automation; FIG. 22 shows an example of a GUI for editing an automation; FIG. 23 shows examples of the GUI for a user to create an action.

FIG. 24 shows examples of GUI for a creating or adding a relationship; FIG. 25 shows another example of the GUI for creating a relationship.

FIG. 26 shows examples of GUIs for creating workflows; FIG. 27 shows another example of a GUI for displaying a workflow with one or more stages; FIG. 28 shows an example of GUI displaying a workflow for a second stage; FIG. 29 shows an example of GUI displaying a workflow for a third stage; FIG. 30 shows an example of GUI displaying a workflow for a fourth stage.

FIG. 31 and FIG. 32 show an example of GUI displaying a created workflow with tracked progress and analytics.

FIG. 33 shows examples of a logistics application suite; FIG. 34 shows an example of a lead time optimization workflow; FIG. 35 shows an example of temperature alert workflow; FIG. 36 shows an example of customer issues workflow; FIG. 37 shows an example of a late shipment workflow; FIG. 38 shows an example of an expedite request workflow.

FIG. 39 show examples of GUI for configuring or creating data mining; FIG. 40 shows an example of GUI for creating data mining; FIG. 41 shows an example of the GUI for a user to aggregate columns; FIG. 42 shows an example of the GUI for a user to define aggregation; FIG. 43 shows an example of the GUI for a user to set up parameters.

FIG. 44 schematically illustrates an architecture for the data-driven workflow platform.

FIG. 45 schematically shows an example of AI-based Application discovery feature, in accordance with some embodiments of the present disclosure.

FIG. 46 shows examples of GUI for an AI-based Application discovery feature; FIG. 47 illustrates examples of predefined applications identified by the system as the model output; FIG. 48 shows an example of creating an application.

FIG. 49 schematically shows an example of AI-generated workflow feature, in accordance with some embodiments of the present disclosure.

FIG. 50 shows examples of GUI of an AI-generated workflow feature; FIG. 51 shows examples of gathering data; FIG. 52 shows an example of LLM outputting one or more stages; FIG. 53 shows an example of the LLM outputting actions for each stage.

FIG. 54 shows an example of a GUI for creating a new data mine function.

FIG. 55 shows an example of GUI for machine learning-based anomaly detection setup and report; FIG. 56 shows an example of setting up input data to the detection model; FIG. 57 shows an example of a GUI allowing a user to preview the detection result and confirm the setup or reconfigure the detection; FIG. 58 shows an example of GUI allowing a user to setup schedule for data mine process runs.

FIG. 59 shows an example of listing of applications discovered by the AI or LLM algorithms; FIG. 60 shows an example of GUI for creating an application list and publish to the platform.

FIG. 61 shows an example of GUI allowing users to interact with large language model (LLM) by creating custom questions.

FIG. 62 shows an example of GUI for document ingestion.

FIG. 63 shows an example of GUI displaying various LLM options for a user to initial a workflow.

FIG. 64 shows an example of the platform that provides an architecture for implementing AI agents in a workflow without moving the cloud data from cloud services providers.

FIG. 65 shows an example of a structured prompt.

FIG. 66 illustrates an example of handoffs and data sources.

FIG. 67 shows an example of Level 1 agent provided by the platform herein.

FIG. 68 shows a GUI of AI-driven workflow provided by the platform herein for orchestrating prior-authorization deflection;

FIG. 69 shows an example of the GUI for prior-authorization deflection;

FIG. 70 shows an example of the GUI for prior-authorization deflection;

FIG. 71 shows another example of the GUI for prior-authorization deflection.

FIG. 72 shows an example of provider management dashboard showing overall provider performance.

FIG. 73 shows an example of UI for defining and managing a toolset and an AI agent in a workflow.

FIG. 74 shows an example system architecture for a workflow automation system.

FIG. 75 shows an example of structured input and output generated by the system for an AI agent and the referential data.

FIG. 76 shows an example of workflow including context constraint AI agent.

FIG. 77 shows examples of input schema and output schema.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

### Certain Definitions

Unless otherwise defined, all technical terms used herein have the same meaning as commonly understood by one of ordinary skill in the art to which this invention belongs.

Reference throughout this specification to “some embodiments,” or “an embodiment,” means that a particular feature, structure, or characteristic described in connection with the embodiment is included in at least one embodiment. Thus, the appearances of the phrase “in some embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” “unit” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In some cases, a component can emulate an electronic component via a virtual machine, e.g., within a cloud computing system.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

### Overview of Cloud Service

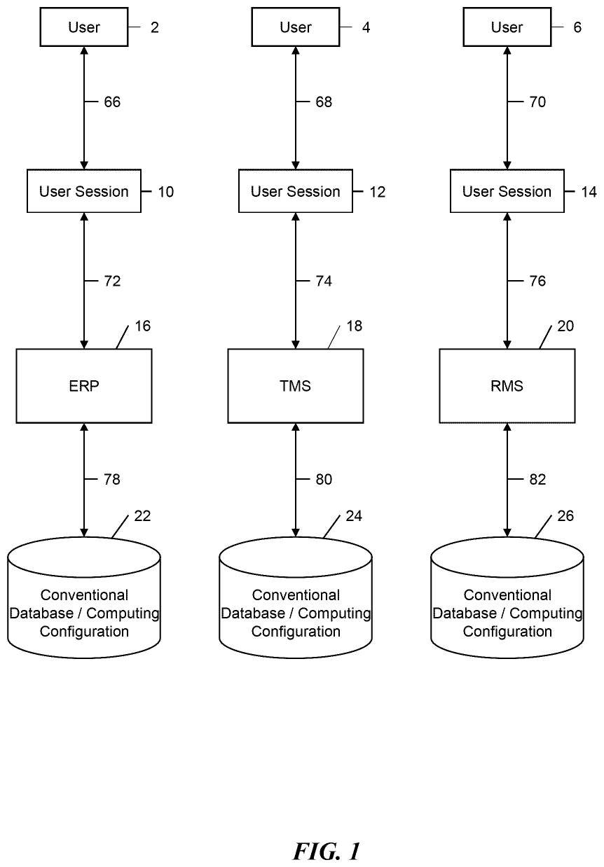

FIG. 1 shows an example of storing enterprise data in conventional database systems. As illustrated in the example, typically one or more users (2, 4, 6; such users may be the same user operating through separate systems, or may represent three different users operating separate systems) within an enterprise will establish separate user sessions (10, 12, 14) with each connected (66, 68, 70; 72, 74, 76) system (16—an ERP system, for example; 18—a TMS system, for example; 20—an RMS system, for example) with which such one or more users (2, 4, 6) have credentials and authority for access and utilization. Typically each system (16, 18, 20) will be operatively coupled (78, 80, 82) to one or more database systems (22, 24, 26) configured to store pertinent data and conduct sorting, report generation, and/or computation utilizing such data, for example, dynamic to the requests coming through the interconnected systems (16, 18, 20). Enterprises using such configurations often have specific information technology resources available to maintain, update, and address various aspects of the database/computing systems (22, 24, 26), and there are inherent operating risks and inefficiencies for such enterprises pertaining to the proprietary and arcane nature of many ERP/database/computing configurations, as is discussed in further detail below.

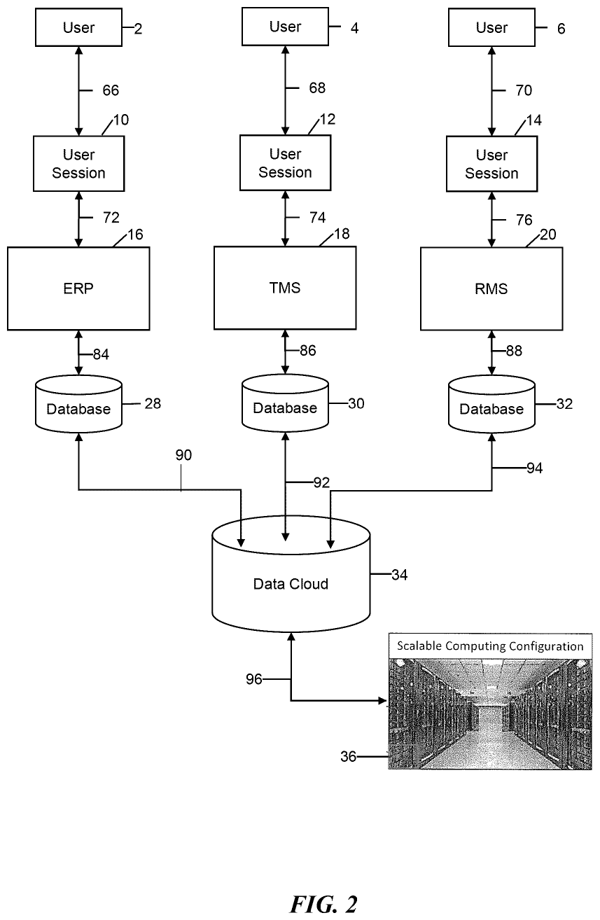

A next-generation configuration has evolved wherein enterprise data is becoming more separated from computing resources. As illustrated in FIG. 2, cloud-based repository providers (e.g., Snowflake®) continue to gain market share from conventional ERP/database/computing configurations (such as that illustrated in FIG. 1) by providing systems wherein a data cloud system configured for the particular enterprise (34) is established to essentially separate the data of the enterprise from the core computing resources, which may reside in an intercoupled (96, such as via high-throughput connectivity) scalable computing configuration (36), such as those made available by Amazon®, Google®, and Microsoft® under the tradenames Amazon Web Services®, GoogleCloud®, and Azure®.

As illustrated in FIG. 2, one or more users (2, 4, 6; such users may be the same user operating through separate systems, or may represent three different users operating separate systems) within an enterprise may utilize one or more computing sessions (10, 12, 14) to operate one or more connected systems (16, 18, 20), which may be intercoupled (84, 86, 88; 90, 92, 94) to the data cloud configuration (34). Many such systems, such as those shown in FIG. 2 (16, 18, 20) still typically will require a significant level or amount of enterprise data maintained (such as via a conventional system integration such as an application programming interface (or “API”), batched table, XML dispatch, or the like) using a separate database (28, 30, 32) to be able to operate, and thus even though some of the data of the enterprise, such as reporting and/or audit data, may be stored in and then copied from the data cloud (34) with operational computing provided by an intercoupled (96) scalable computing configuration (36), data and data processing typically remains distributed on other disparate systems (18, 20, 22), which again presents various efficiency, complexity, expense, and risk management downsides to such enterprise.

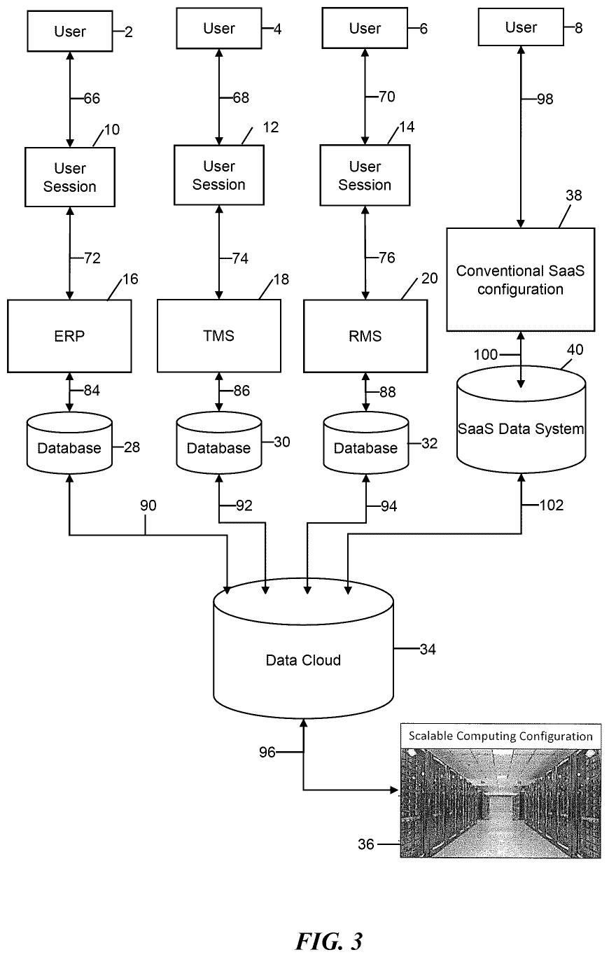

Recently, cloud services and SaaS (software-as-a-service) may provide enterprise computing resources that are more scalable, functional, efficient, upgradeable, and less isolated, while also remaining secure. Particularly in the scenario of a typical modern enterprise navigating various issues such as supply chain challenges, the number of disparate pieces of information from disparate systems that must be integrated and entertained, often manually, to make a timely and informed business decision can be extreme. For example, as illustrated in FIG. 3, it would not be unusual for a typical enterprise manufacturing a complex technology product to be trying to pull information from multiple conventionally-integrated systems (16, 18, 20) and/or SaaS (38) systems (e.g., software to examine approved purchase orders for key parts for goods to be manufactured, as well as to examine shipping/transportation status, operational risks, payment status, and pertinent weather data) to understand whether a particular shipment is actually going to arrive on time to the appropriate manufacturing facility to assist in making manufactured goods to be shipped in time for a particular holiday.

Perhaps more importantly, even in a scenario wherein enough users/operators are able to be present for a real-time discussion to address such compound and complex issues, they would likely be bringing data from disparate systems which is not linked, not coordinated, probably not updated in real or near-real time, and not already worked through business process analysis to assist in making a decision based upon many inputs. In other words, such a discussion can require 30 operators, each coming with their own perspective and data from disparate systems (some of which may not be within the enterprise firewall), each wanting to join into a real-time discussion regarding the issues present and potential solutions to address. Described herein are systems and methods for business process operation, management, and automation, which are configured to meet these and other operational challenges within the modern enterprise.

Referring to FIG. 3, an enterprise configuration similar to that illustrated in FIG. 2 is shown, with the addition of one or more so-called “software-as-a-service” (or “SaaS”) systems (38) configured to allow a user (8) to engage a SaaS configuration (38), such as Customer Relationship Management (CRM), Enterprise Resource Planning (ERP), Content Management System (CMS), Project Management Software, Sales, Marketing, or eCommerce software (e.g., SalesForce®, Adobe Creative Cloud®, ServiceNow®, and the like). Such systems typically utilize an intercoupled (100) SaaS Data System (40), such as a database, specifically configured to facilitate operation of the SaaS configuration (38) by pulling certain data from the intercoupled Data Cloud Configuration (34), such as via a conventional system integration as discussed above in reference to the interconnected systems (16, 18, 20). As with the system configuration illustrated in FIG. 2, even though some of the data of the enterprise will be located on the data cloud (34) with operational computing provided by a scalable computing configuration (36), there will remain some data distributed on other disparate systems (28, 30, 32, 40), which again presents various efficiency, complexity, expense, and risk management downsides to such enterprise.

### Service Management Cloud System (Data-Driven Workflow Platform)

The present disclosure provides an improved service management cloud system or a cloud-native SaaS platform for no-code applications with data-driven workflows utilizing cloud data. The service management cloud system as described herein may provide configurable and automated data-driven workflows via no-code applications. The service management cloud system may be natively integrated to any data cloud and may allow for configurable applications for workflows or processes without the need of ETL (extract, transform, load) or ELT (load and transform in data warehouse). The term “service management cloud” or “cloud-native SaaS platform” may also be referred to as “data-driven workflow platform” which are utilized interchangeably throughout the specification.

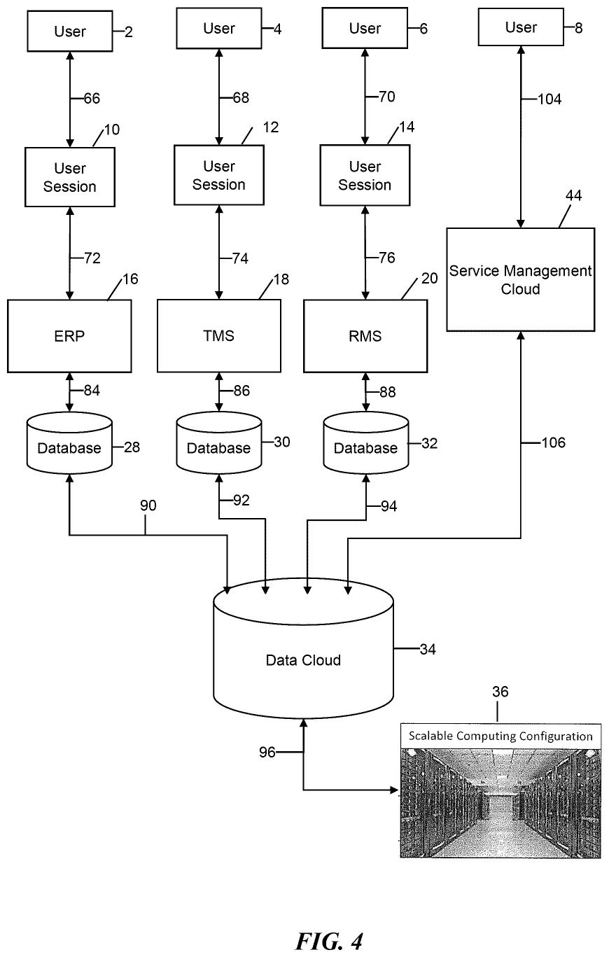

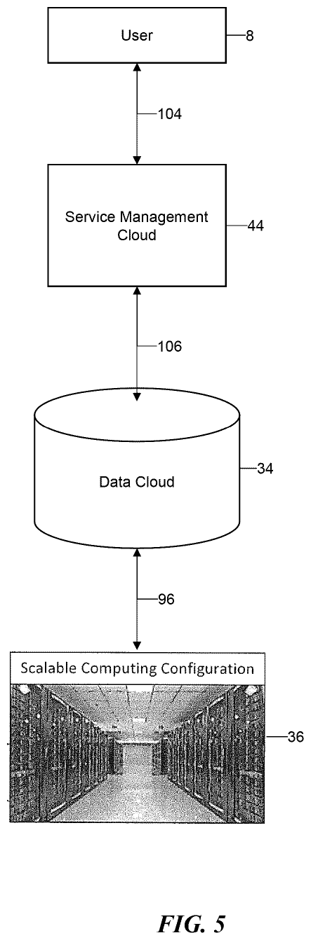

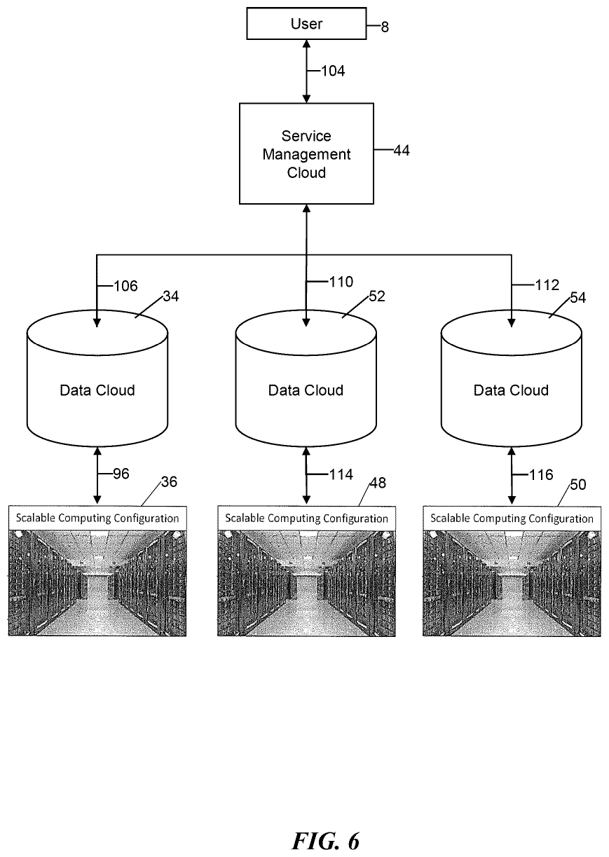

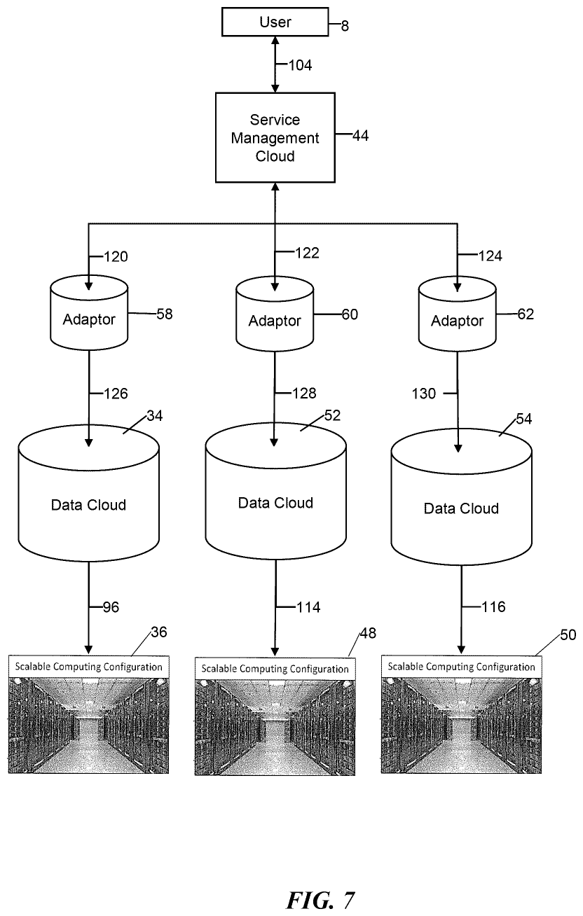

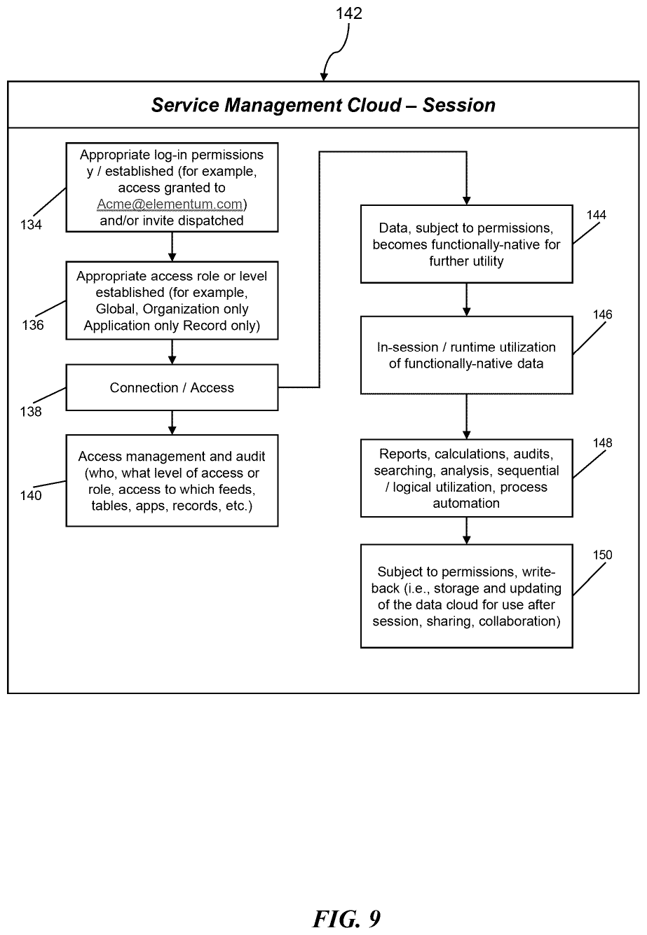

FIGS. 4-7, illustrate various configurations wherein a service management cloud system (44) may be configured to have direct interconnectivity (104, 106) between a user (8) and a Data Cloud configuration (34). The service management cloud system (44) may be specifically configured to operate without requiring a significant amount of data migration from the Data Cloud configuration (34) to other systems, while also providing visibility and utility to the user (8) through the Service Management Cloud (44) to manage business activities and processes in an efficient and scalable manner, as described in further detail below. As described in further detail below in reference to FIG. 9, for example, the service management cloud system (44) may be specifically configured to not only provide efficient and globally controllable access to various interconnected systems and data via the use of duly granted privileges, but also to connect these data and systems such that the data becomes available to the service management cloud system (44) with efficiency and latency similar to that which would be present if the data was local to the service management cloud system (44). In other words, during a given session, the service management cloud system (44) and intercoupled resources (34, 36) preferably may be configured to cause targeted data to become “functionally-native” to the subject service management cloud system (44) session—and such condition brings about significant additional opportunities for utilization of the data as an enterprise, while also assuring that the data continues to be updated, such as in real-time or near-real-time, and continues to reside entirely, or at least primarily, on the data cloud (34).

Referring to FIG. 4, an enterprise data configuration is illustrated wherein conventional connected business systems (16, 18, 20), such as those illustrated in FIG. 2, remain in place (i.e., within the data cloud) to assist one or more given users (2, 4, 6) in conventional operations through sessions (10, 12, 14) with such systems (16, 18, 20) and their connected data (28, 30, 32; 34), and wherein a separate Service Management Cloud system (44) is configured to provide direct access to the intercoupled (106) Data Cloud configuration (34), such that the user (8) of the Service Management Cloud system (44) may not only examine information contained upon the Data Cloud Configuration (34) in the form of views of returns to queries, reports, and the like without migrating data toward the user (8) from the Data Cloud Configuration (34), but also wherein the user (8) may create, operate, and manage business processes by utilizing the combined interconnected resources of the Service Management Cloud system (44), the Data Cloud Configuration (34), and the associated Scalable Computing Configuration (36) without migrating data toward the user (8) from the Data Cloud Configuration (34), as discussed further below, such as in reference to FIG. 9.

FIG. 5 illustrates a variation without the integrated conventional enterprise systems (16, 18, 20 of FIG. 4, for example) present, for simplicity purposes. Such a configuration may occur in a paradigm wherein such conventional configurations may have been migrated to Service Management (44) and Data Cloud (34) configurations, or wherein conventional functionality has been obviated by the functionality available with Service Management (44) and Data Cloud (34) configurations.

FIG. 6 illustrates an embodiment wherein three separate Data Cloud Configurations (34, 52, 54) are shown interconnected (106, 110, 112) between the Service Management Cloud system (44) and three separate interconnected (96, 114, 116) Scalable Computing Configurations (36, 48, 50), which may be maintained by different and/or distinct providers (for example, AmazonWebServices®, GoogleCloud®, and/or Azure®). Such a configuration illustrates that a single user (8) may utilize a single instantiation of a Service Management Cloud (44) to examine and control data, and conduct computing operations, from various disparate interconnected systems, as described further below in reference to FIG. 9, again without heavy reliance upon pulling data from such systems toward the user (8), depending to some extent upon the Data Cloud Configurations (34, 52, 54). For example, in an embodiment wherein a particular Data Cloud Configuration is one featuring remote compute management features such as those offered by Snowflake® under the tradename “Streams”®, or where a suitable adapter has been built in its place, data manipulation language (“DML”) changes made to tables, directory tables, external tables, or underlying tables in one or more views (including secure views) may be recorded for a given source object, thereby allowing for a form of trackable remote operation or remote manipulation of the Snowflake Data Cloud Configuration instantiation. Such streaming configurations may be utilized to provide the Service Management Cloud (44) with access to the data within one or more of the Data Cloud Configurations (34, 52, 54) along with access to computing manipulation thereof through one or more pertinent interconnected (96, 114, 116) Scalable Computing Configurations (36, 48, 50).

Referring to FIG. 7, one or more interconnected (120, 122, 124; 126, 128, 130) adaptor (58, 60, 62) modules may be configured to assist with specific utility of the subject Data Cloud configurations (34, 52, 54) by the Service Management Cloud (44), such as to assist with functions pertaining to utilizing the Scalable Computing Configurations (36, 48, 50) for as much of the associated computing as possible. The adapter may enable data hosted in the data cloud (e.g., Snowflake) to appear like it is native inside of the service management cloud platform. For instance, during the configuration or integration between the data cloud (e.g., Snowflake) and the Service Management Cloud for the targeted data, the adapter may setup a mapping and data type matching without changing the data or applying any type of modifications to the data within the data cloud. Details about the adapter, data type matching, assignment and data mapping (setting up connection to data source) are described later herein.

As noted above, in many multifactorial modern business challenges, it can require personnel, information, and expertise from not only various people and sources within a particular organization, but also from other (i.e., outside) organizations. For example, a typical enterprise may contract for various aspects of its logistics operation. To understand and address a particular urgent business challenge which may involve logistics, the enterprise may need to involve personnel and information from the outside logistics service provider. Such involvement conventionally may require emails, teleconferences, phone calls, and many people. A key benefit of the subject Service Management Cloud (44) configurations is an enhanced ability to bring people into collaborative processes with specific and controlled levels of access, whether they are within a particular organization, department, generalized security, or not.

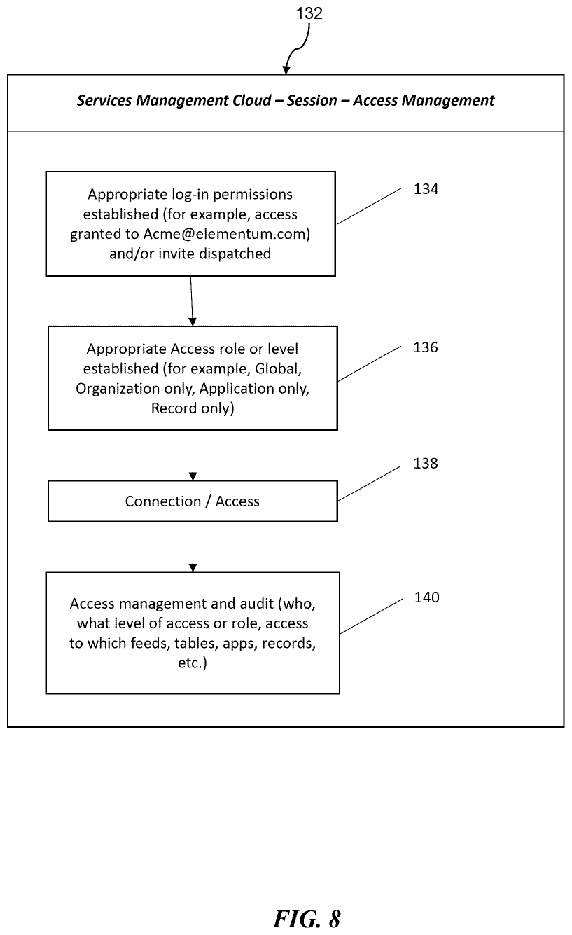

The service management cloud platform may allow for process sharing. In addition to sharing data securely within the data cloud, participants or different entities involved in a workflow may share processes. For example, supply chain team may collaborate, working directly with partners on the same data within the same workflows via the platform herein. The platform may provide an interface for view, access and manage process-data such as tasks, assignments, reminders, all secured within the data cloud. Referring to configuration (132) FIG. 8, the Service Management Cloud (44) preferably may be configured to allow pre-established, or in-app defined, (134) log-in permissions which may provide specific access roles or levels (for example, total global access, organization only, application only, and even limited to a single record) (136). The Service Management Cloud (44) may be configured to allow appropriate connection and access to the information using the data cloud (34) and associated computing resources (such as 36 in FIG. 4).

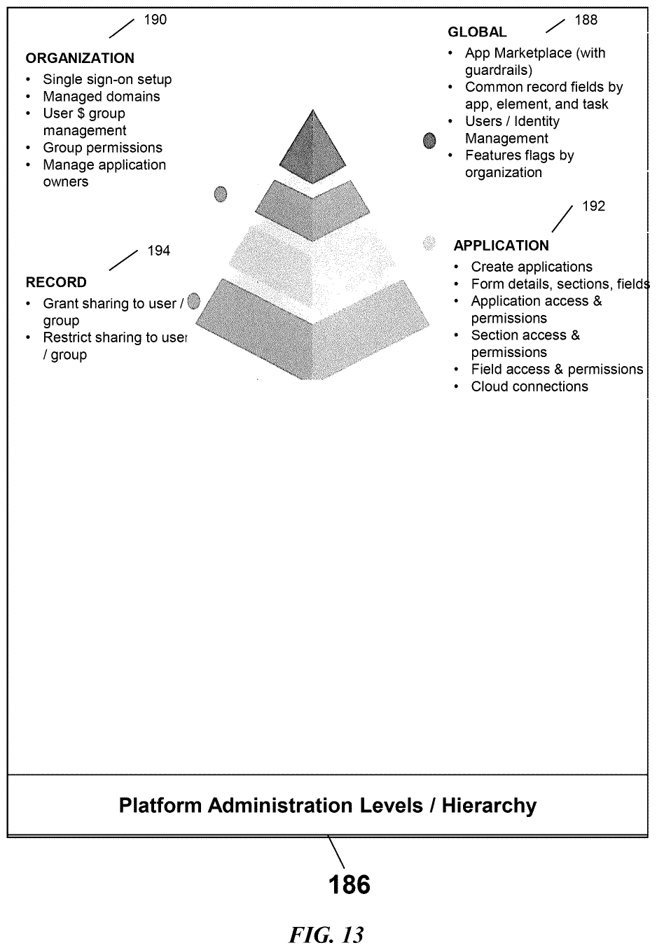

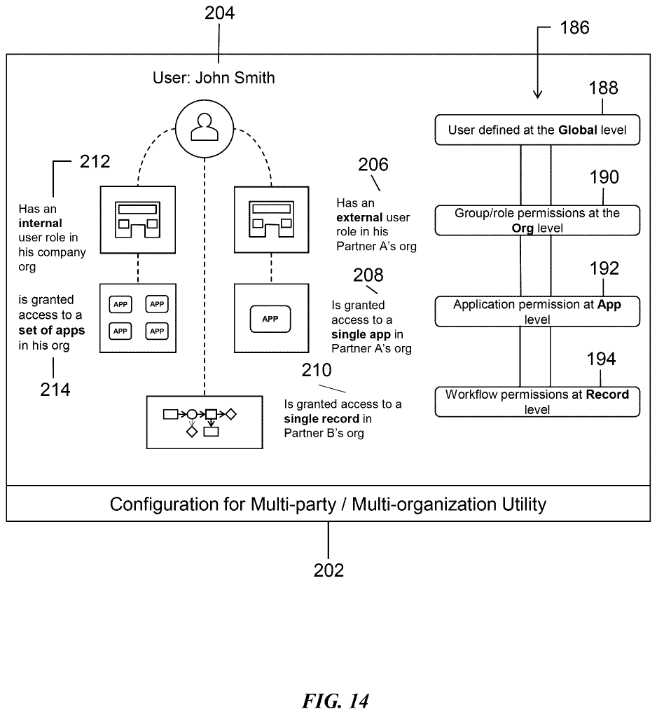

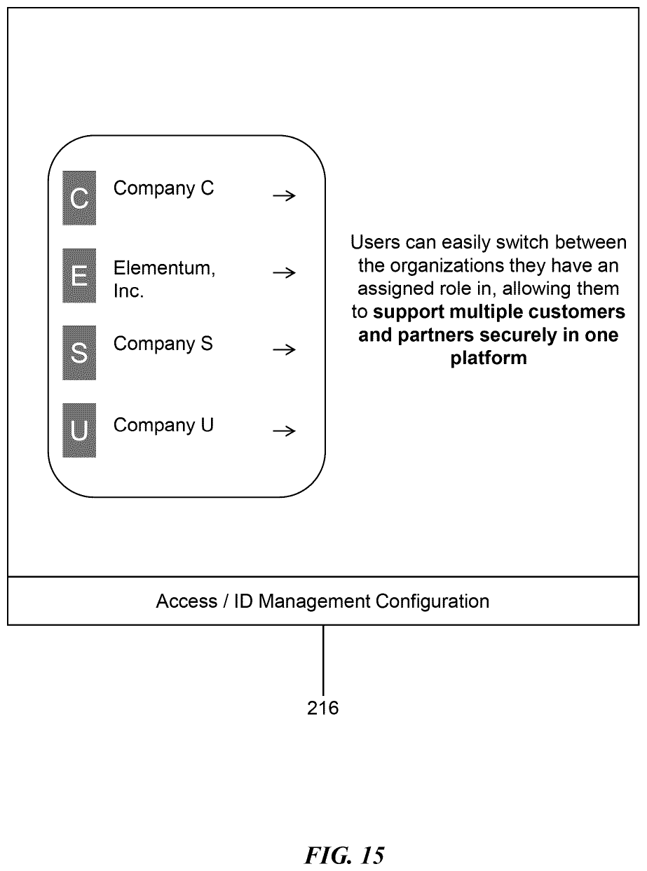

Further, with precision access and tracking by record, application, organization, role, and the like, the access to each particular aspect of the enterprise data and system may be tracked and audited (140). For example, a report, user-interface dashboard, or notification may be set up to allow administrators of a Service Management Cloud (44) configuration to conveniently, with real-time or near-real-time updating, understand who has access to what, throughout the system. Referring ahead to FIGS. 13-15, further aspects of preferred access management, control, and collaboration are illustrated. Referring to FIG. 13, a hierarchy configuration is illustrated (186), which, as noted above, may be utilized to assist an administrator of a Service Management Cloud (44) configuration in providing very specific access to aspects of the system, such as based upon individual records (194), applications (192), on an organization basis (190), or globally (188), subject to appropriate limitations. Thus, for example, referring to FIG. 14, collaboration within and outside of a given organization, by one or many parties, is facilitated with such configuration (202). A user (“John Smith” 204) is illustrated having an internal role (212) in a given company organization with appropriate access (214) to this company's Service Management Cloud (44). Using the access configurability as discussed in reference to FIG. 8, John Smith (204) also may be granted separate and distinct access to external resources of a partner organization's Service Management Cloud (44), such as based upon his role (206) with that external partner organization, or on an app-specific basis (208). FIG. 14 also illustrates that John Smith (204) may have limited access to a single record (210) within the Service Management Cloud (44) of a third organization. Thus John Smith (204) may conveniently and efficiently collaborate with persons, processes, and data of three or more organizations, securely, and in real or near-real time, through the cloud using the subject configurations of Service Management Cloud and without needing to log-in and log-out of multiple systems.

FIG. 15 illustrates that with such a Service Management Cloud (44) configuration (216) a user such as John Smith (element 204 of FIG. 6B) may easily switch between organizations to collaborate. In other words, “bringing in someone from another organization to help on this urgent/particular issue”—becomes very efficient, secure, and controlled, and can be automated in many regards, as described further below. Further, preferably the Service Management Cloud (44) is configured to be platform-independent, such that it may be accessed and utilized from any web interface, thereby allowing appropriate users to administer any platform from anywhere, generally backed by the significant computing capabilities of a secure data center, such as the Scalable Computing Configuration (36) operatively coupled (96) to the Data Cloud (34) in the embodiment of FIG. 4.

Referring to FIG. 9, with a robust, precise, and convenient paradigm for managing access, operators are able to not only visualize data that is being updated in real or near-real time, but also utilize it in new ways in business processes of many kinds, with various levels of automation. As shown in FIG. 9, data, subject to appropriate access limitations, becomes functionally-native for further utility. As noted above the notion of functionally-native is in reference to the fact that the Service Management Cloud (44) may be configured to present a given user with access to data that is constantly updated in real or near-real time, with a level of latency and access as though the data was resident in their local computing operation, notwithstanding the fact that the data generally is actually residing on the Data Cloud (34) and is being supported by significant Scalable Computing Configuration (such as element 36 of FIG. 4). With updated data available efficiently, subject to appropriate permissions, it may be utilized for various in-session operations (146), such as the creation of reports or notifications, calculations of various types, audits, searching, analysis, sequential and/or logical utilization, process automation, and the like (150). Further, subject to appropriate permissions, data may be written-back (150) such that changes or new data are stored on the Data Cloud and may be utilized to update other interconnected systems and databases thereof.

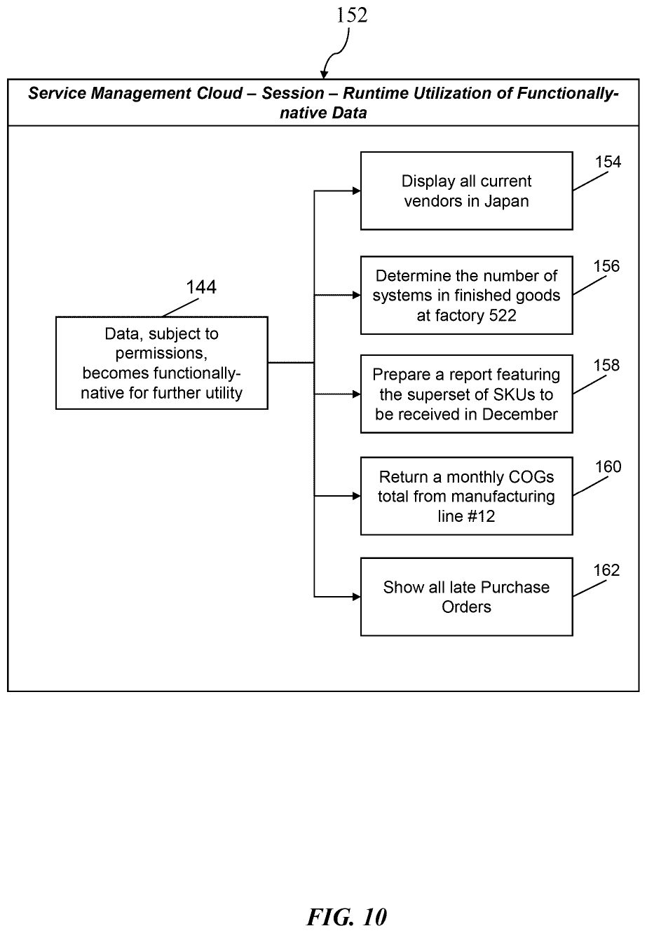

Referring to FIG. 10, an expanded illustrative view of a Service Management Cloud (44) configuration (152) is shown wherein given functionally-native access to the data, many operations may be efficiently accomplished using the Service Management Cloud (44) through a web service, again, on a platform-independent basis. For example, a cloud application (“App”) may be created to conduct various operations on a repeated or one-time basis, such as those that would functionally: “display all current vendors in Japan” (154); “determine the number of assemblies in finished goods inventory at Factory #522” (156); “prepare a report featuring the superset of SKUs to be received in December” (158); “return a monthly cost of goods sold total from Manufacturing Line #12” (160); and “show all late Purchase Orders since January” (162).

With regard to the utilization of data that has been made functionally-native during a given session on a Service Management Cloud (44), the system may be configured to deliver data into a given user's session based upon factors such as: the platform being used by the user to access the Service Management Cloud (44) (for example, a smart-phone-based platform may not have the ability to throughput or receive as much data as a robust desktop workstation); the quality of the connection between the user's client device and the Service Management Cloud (44); the bandwidth or latency of the connection between the user's client device and the Service Management Cloud (44); and/or the location of the user's client device relative to the Data Cloud (such as element 34 of FIG. 4, for example, it may be desirable to allow a user to configure his or her particular session in the Service Management Cloud (44) to prioritize data most immediately local to the user) and Scalable Computing Configuration (such as element 36 of FIG. 4). In other words, the Service Management Cloud (44) may be configured to automatically modulate the delivery of data into the user's session based upon various factors, to enhance utility and generally support the user in collaboration and other business operations.

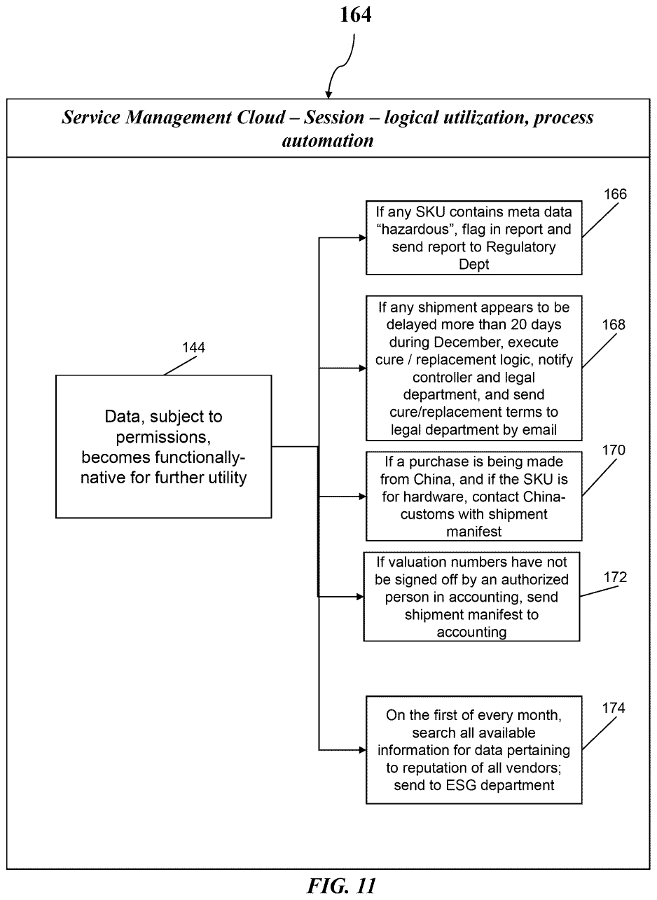

Referring to FIG. 11, a Service Management Cloud (44) session configuration (164) is illustrated wherein functionally-native data (144) may be utilized for sophisticated business process automation. For example, the Service Management Cloud (44) may be configured to functionally and automatically run processes that utilize the available data, such as: “if any SKU contains meta data ‘hazardous’, flag in report and send report to Regulatory Department” (166); “if any shipment appears to be delayed more than 20 days during December, execute cure/replacement logic, notify controller and legal department, and send cure/replacement terms to legal department by email” (168); “if a purchase is being made in China, and if the SKU is hardware, contact China-customs with shipment manifest” (170); “if valuation numbers have not been signed off by an authorized person in Accounting, send shipment manifest to Accounting” (172); “on the first day of every month, search all available information for data pertaining to reputation of all vendors, send to ESG department” (174).

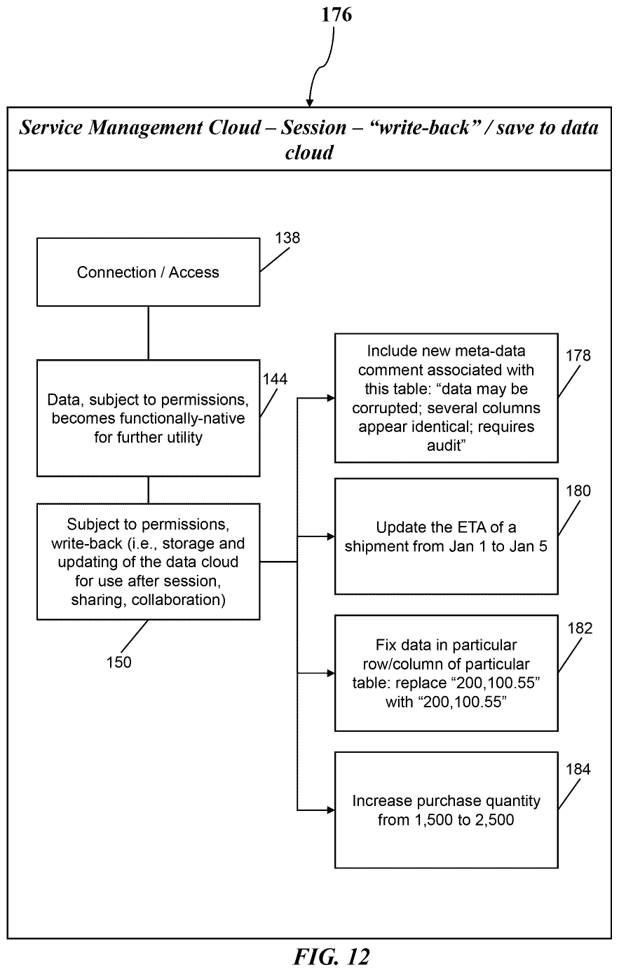

Referring to FIG. 12, a Service Management Cloud (44) session configuration (176) is illustrated wherein the real-time or near-real-time access (138) to functionally-native data (144) may be utilized for write-back purposes (150). For example, the Service Management Cloud (44) may be configured to functionally write back to the Data Cloud (such as element 34 of FIG. 4), which may be utilized to update other intercoupled systems, as noted above, in the following example scenarios: “include new meta-data comment associated with this table: ‘data may be corrupted; several columns appear identical; requires audit’” (178); “update the ETA of a shipment from Jan 1 to Jan 5” (180); “fix data in particular row/column of this particular table: replace ‘2oo,100.55’ with ‘200,100.55’” (182); “increase purchase quantity from 1,500 to 2,500” (184). Such write-backs may represent significant changes in operation, and the ability to efficiently navigate them through one interface, securely, and have the data populate out to other users immediately, presents another key paradigm shift. As the Service Management Cloud is connected directly to the data stored on a Data Cloud provider and the workload or queries run in the Data Cloud, the source data may be updated, modified in the Data Cloud, and/or new data may be added to the data cloud (e.g., upon execution of actions in the automation setting that are requested to update data). The Service Management Cloud may provide an alternative capability to call an API directly to a Cloud Service (e.g., Salesforce) to perform an action (e.g., add a new data record in a new column or table in the data cloud) or update the source data. The platform may be capable to write-back to the Cloud Service (e.g., Salesforce), directly to the source systems (e.g., ERP, CRM, CMS, etc.) or a combination of both. In some cases, the platform may allow a user to set up preference or permission of write-back. For example, a user may set up the write-back as enabled for both the Cloud Service and the connected source systems. Alternatively, a user may set up the write-back as enabled for the Cloud Service only.

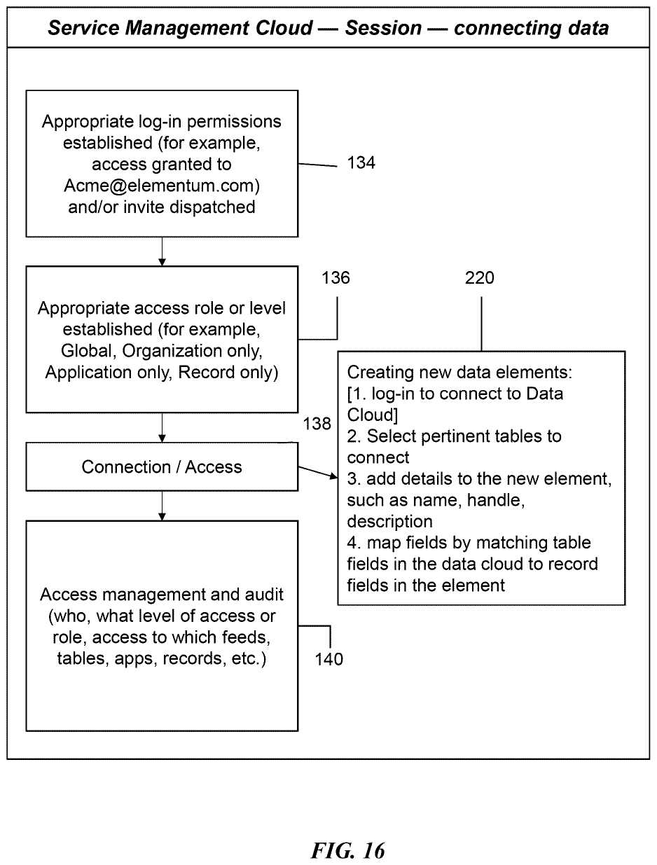

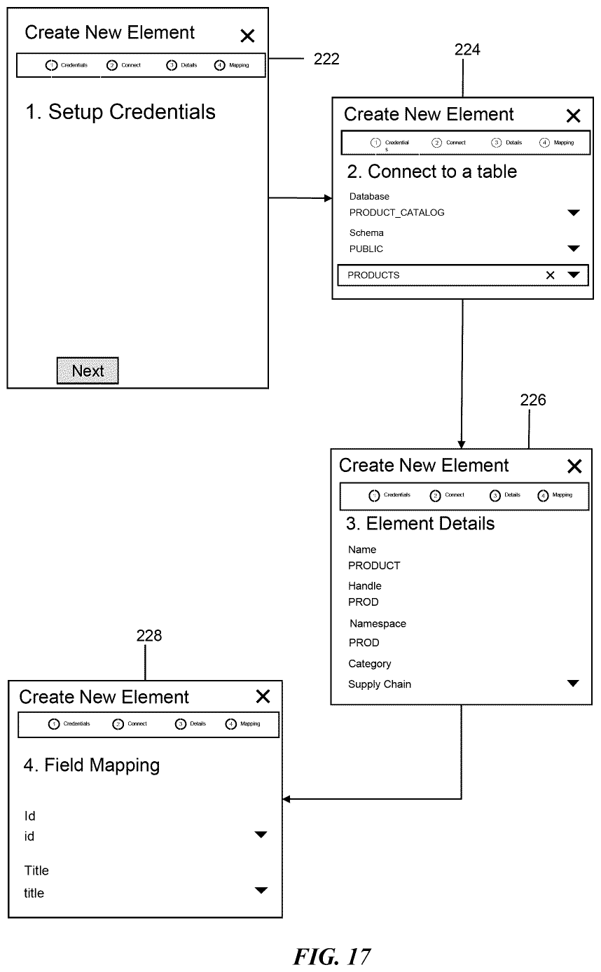

Referring to FIG. 16, with secure and efficiently-administered access (138) on a platform-independent basis as discussed above, making additional data available on a functionally-native basis may be accomplished using the Service Management Cloud (44) as shown (220): 1. log-in using credentials to connect to the Data Cloud; 2. Select pertinent tables to connect; 3. Add details in the new element, such as name, handle, and/or description; 4. Map fields by matching table fields in the Data Cloud to record fields in the element. Referring to FIG. 17, such steps are illustrated in views of a Service Management Cloud (44) session user interface (set up credentials 222; connect to a table 224; associate element details 226; configure field mapping 228).

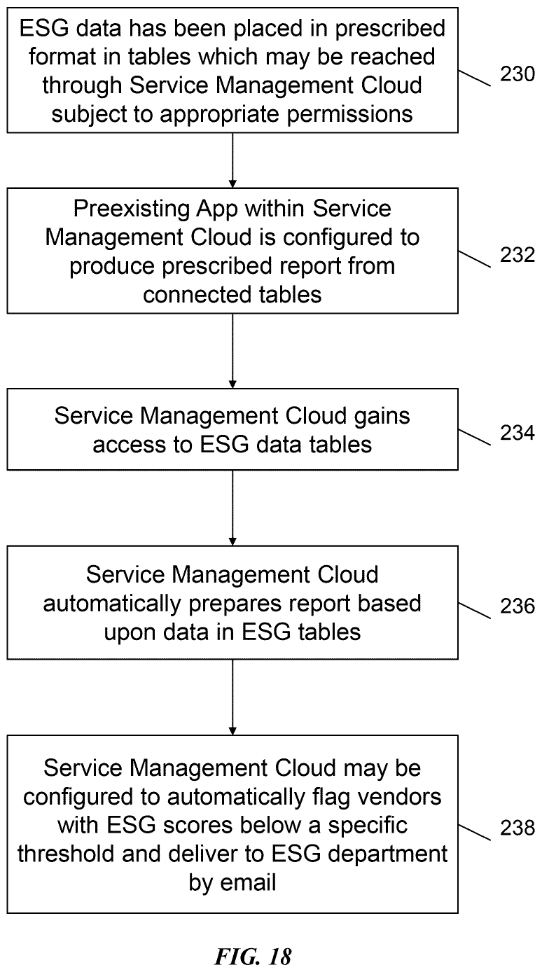

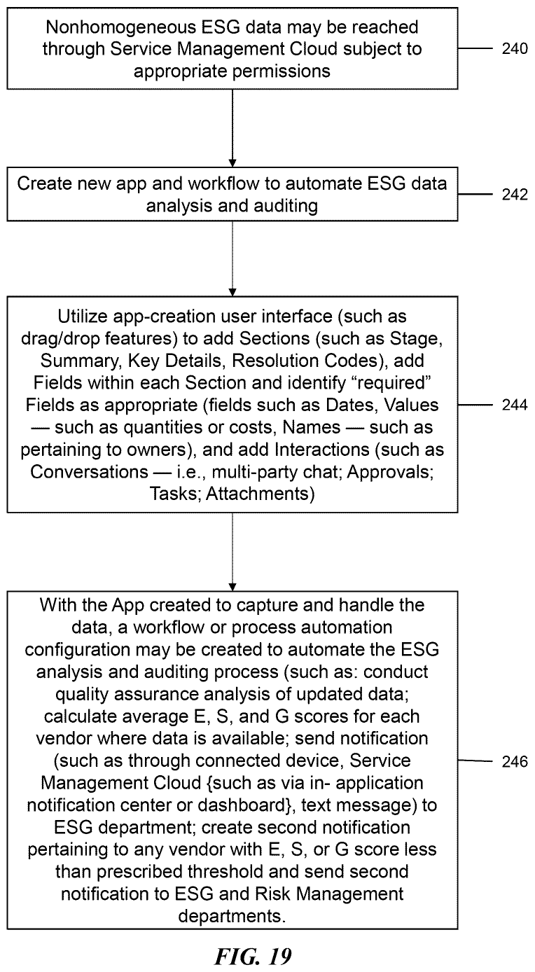

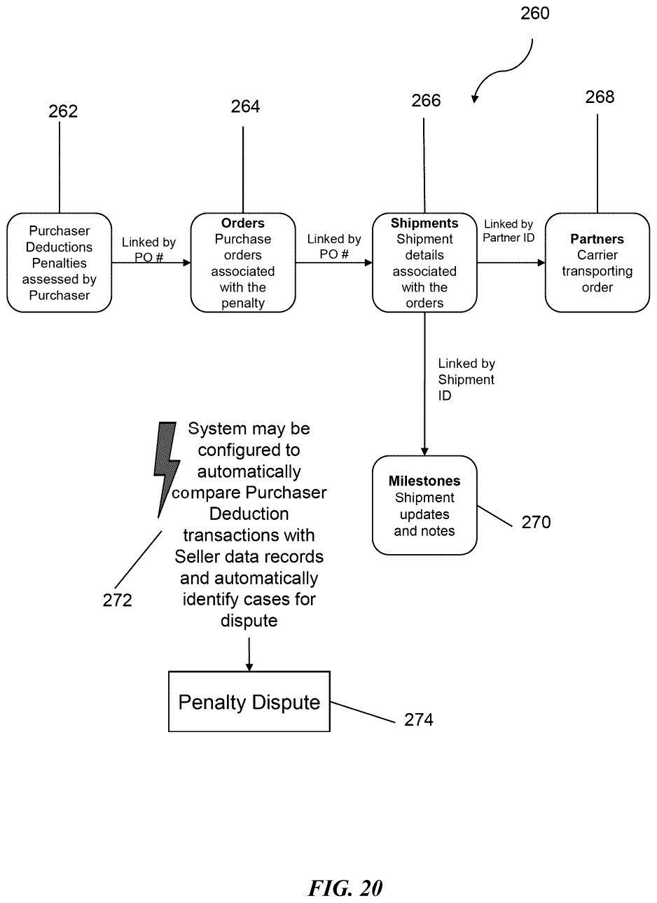

Referring to FIGS. 18-20, several use cases are illustrated for configuring and employing Service Management Cloud (44) variations in sophisticated business processes with varying levels of automation.

Referring to FIG. 18, environmental, social, and governance (“ESG”) scoring and the monitoring thereof has become a key priority in many business organizations. Data can be utilized from many sources, in many forms, with various levels of latency, certainty, and other key factors, resulting in various complexities within such business organizations FIG. 18 illustrates a scenario wherein an organization has required that all of its partners provide ESG-related data in a prescribed format, in a prescribed table, in a prescribed location such that it may be made available subject to appropriate permissions using the Service Management Cloud (44). Thus ESG data has been placed in the prescribed format in tables which may be reached through the Service Management Cloud (44) subject to the appropriate permissions (230); to facilitate efficient and automatic use of the relatively standardized and predictable data from the various partners, a pre-existing App may be created and configured to automatically (236) produce a prescribed record or report (232) based upon connectivity (234) with the ESG data tables. Further the Service Management Cloud (44) may be configured to automatically flag vendors or partners with ESG scores that may be below a specific predetermined or customizable threshold, and automatically deliver such information, such as via an emailed written report document or an electronic notification to a Service Management Cloud (44) dashboard interface, smart phone, or the like (238).

Referring to FIG. 19, an embodiment is illustrated pertaining to ESG analysis wherein available data may not be homogeneous or standardized, but rather made available through the Service Management Cloud (44) in non-homogenous form (240). In such case, rather than using or modifying one of several pre-created Apps available on the Service Management Cloud (44), an operator of the Service Management Cloud (44) may create a custom App to operate within the Service Management Cloud (44) using sophisticated and simplified (“no-code” and/or “drag-and-drop” configuration interfaces of the Service Management Cloud). Details about the user interface and systems for the workflow creation are described later herein. Referring again to FIG. 19, a user may utilize an app-creation user interface (such as drag/drop features) to add Sections (such as Stage, Summary, Key Details, Resolution Codes), add Fields within each Section and identify “required” Fields as appropriate (fields such as Dates, Values—such as quantities or costs, Names—such as pertaining to owners), and add Interactions (such as Conversations—i.e., multi-party chat; Approvals; Tasks; Attachments; Update Component) (244); With the App created to capture and handle the data, a workflow or process automation configuration may be created to automate the ESG analysis and auditing process (such as: conduct quality assurance analysis of updated data; calculate average E, S, and G scores for each vendor where data is available; send notification (such as through connected device, Data-driven workflow platform {such as via in-application notification center or dashboard}, text message) to ESG department; create second notification pertaining to any vendor with E, S, or G score less than prescribed threshold and send second notification to ESG and Risk Management departments (246).

Referring to FIG. 20, a supply-chain-related business process challenge may be automated using configuration of the subject Service Management Cloud (44). A particular Purchaser (such as a large Fortune 500 entity) may require that all Suppliers/Partners precisely meet their delivery needs (i.e., orders are timely, not over, not under, not damaged, etc.) or they will be issued a Penalty fine that is payable and not disputable unless disputed within a relatively short window of time after the Penalty is provisionally issued. With many operators involved from within and outside of a particular Supplier/Partner organization (for example, Partner manufacturing, shipping, logistics personnel; vendor logistics personnel; potential information made available in the Data Cloud via outside vendors such as Project 44, which may geo-track shipping containers and the like, etc.), appropriately flagging and supporting potential Penalty disputes may be very challenging (and, indeed, as a result, many simply may not be disputed in time, resulting in significant operating costs for the various players). In some embodiments, a custom App may be created to bring in any proposed Purchaser Deductions or Penalties (262), original Order information (264), pertinent Shipping information (266), information from Partners (268), final shipment/arrival and other milestone information (270), and automatically (272) and efficiently create a package of information to be utilized in support of a penalty dispute (274) with the Purchaser, and which can be automatically submitted to the Purchaser's dispute resolution portal via automatically-generated workflows from the Service Management Cloud.

With additional data and experience in solving various business challenges automatically, and with the significant amount of data that continues to be updated and aggregated using various instantiations of the Service Management Cloud (44), neural network configurations may be created to assist users and organizations in addressing various business challenges based upon correlations, labeled data, heuristics and algorithms, and reinforcement learning models based upon business goals. Further, the subject Service Management Cloud (44) systems may be configured to automatically identify gaps in various datasets, tables, and/or documents, and to seek to bridge such gaps automatically. For example, in one embodiment, in a configuration wherein an App or process is configured to utilize certain information from “Purchase Order” documents, such as in a business process automation configuration, and wherein a given Purchase Order has all information required but is missing the Supplier's physical mailing address, the system may be configured to identify the Supplier based upon a unique SKU or other field in the data, and to provide the Supplier's physical mailing address from other data linked to the Supplier.

### Data-Driven Automation

As described above, the data-driven workflow platform herein may allow for no-code automation of processes at various levels. In some embodiments, the platform may provide a graphical user interface (GUI) allowing users to configure, create and manage automations thereby initiating workflows upon a change in the data. In some cases, the automation may be created by defining a rule for automating an action triggered by a triggering event of selected data objects. In some cases, the rule may comprise a definition of a triggering event, a definition of condition for executing an action, and a definition of the action.

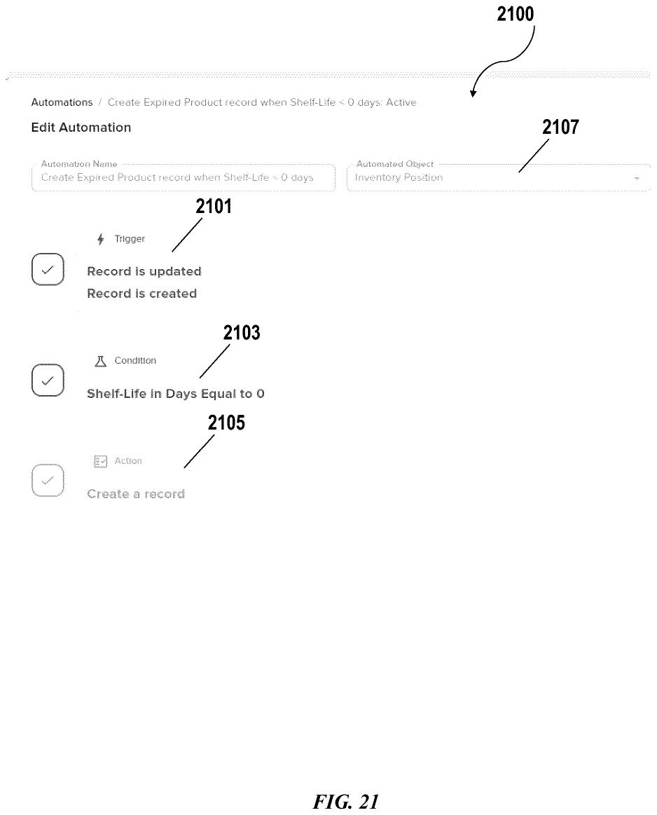

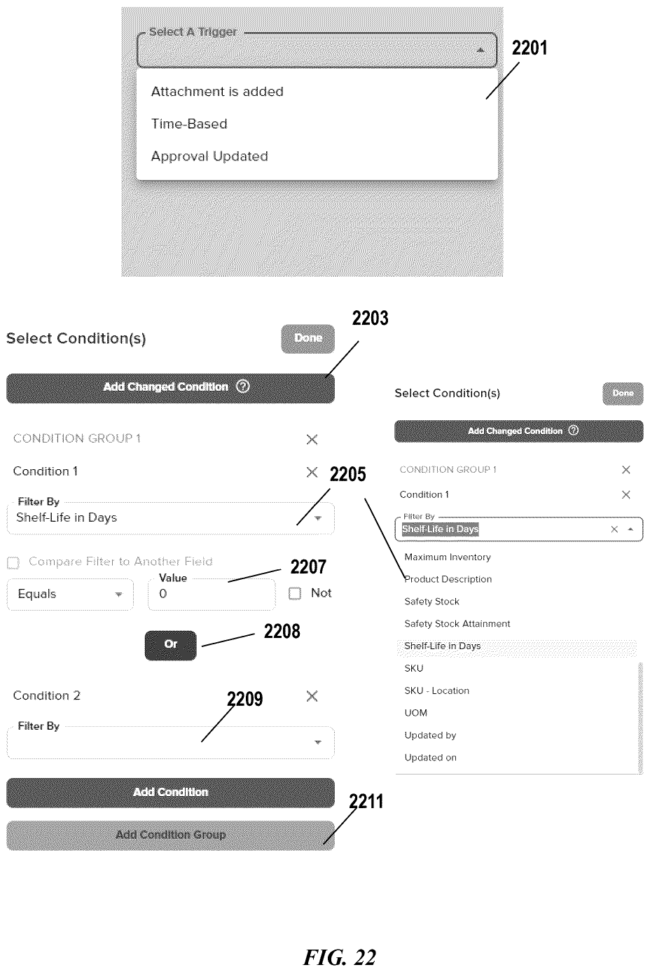

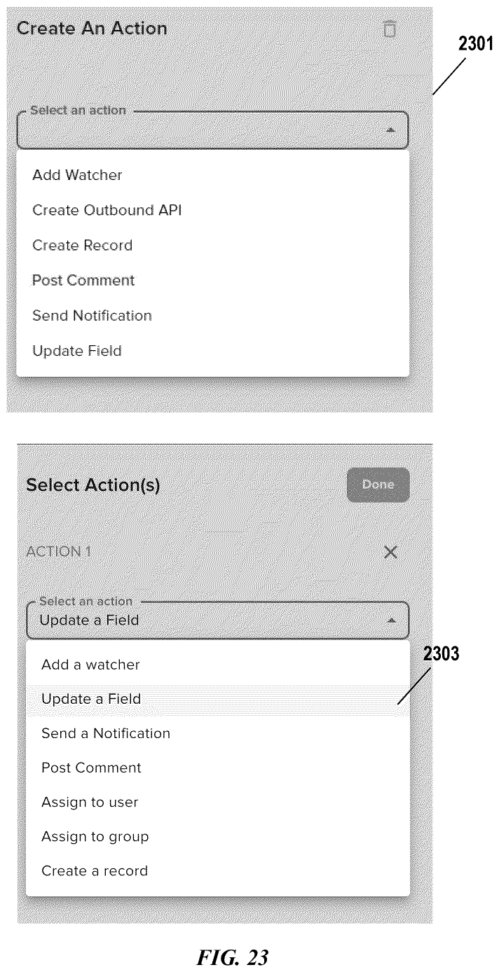

FIGS. 21-23 show examples of GUIs for creating and/or editing an automation. As shown in FIG. 21, the GUI 2100 may allow users to create, modify or edit an automation with a plurality of configurable fields. For example, the automation GUI 2100 may provide at least three fields including trigger 2101, condition 2103 and action 2105 allowing for convenient configuration of a triggers-conditions-actions type of automation.

In some embodiments, the automation may be data-driven. For instance, each field (e.g., trigger 2101, condition 2103 and action 2105) may be configurable with auto-populated values or data fields. The auto-populated values or data fields may be dynamically determined based on the connected data objects 2017. For example, upon setting up the automated object 2107, a drop-down menu 2201 with dynamically populated options (e.g., attachment is added, time-based, approval updated) may be provided as shown in FIG. 22. A user may be permitted to assign a trigger based on record create, state update, data change, quantity change, value change or various other type of triggering event. A user may select from the list of options 2201 to set up the triggering event. In some cases, the options provided in the drop-down menu 2201 may change dynamically according to the connected data objects. For example, the trigger options may indicate the data field (e.g., column) upon which a change may trigger an action. In another example, a trigger may include an action/operation executed in the connected cloud database (e.g., creation of a new record).

In some cases, a user may be permitted to define the conditions for the trigger. A condition may define the particular value or state of a condition for the trigger. For example, the condition may be a new stage, days until or past due date, quantity over or under a threshold and the like. As illustrated in FIG. 22, the GUI may also allow a user to set up or define the conditions via a condition panel 2203. The condition panel 2203 may provide data fields such as filter by 2205 with auto-populated options. A user may select from a list of options provided in the drop-down menu 2205 to select a column to apply the filter. In some cases, the list of options may be automatically populated based on the connected data objects. A user may be permitted to further define the condition(s) for the filter (e.g., no value, greater than, equal, less than, between, greater than or equals, less than or equals, etc.) via the condition panel 2203. For example, a user may define a threshold value 2207 and relationship (e.g., equals) to apply the filter. In some cases, a user may create compound conditions (e.g., condition group) via the operator (e.g., AND, OR) 2208 to combine multiple conditions (e.g., filters) 2209. The GUI 2203 may also allow users to create complex conditions such as by adding a condition or a condition group 2211. The condition group may be added via any suitable operations (e.g., AND). The trigger event, and conditions may then be converted to a query language (e.g., Structured Query Language (SQL)) compatible with the database technology supported by the connected data cloud. In some cases, the trigger and condition of the trigger may be implemented via a data mining feature of the platform. For example, the data mining capability may automatically detect a change in the data as defined by the triggering event and the condition. Details about the data mining feature are described later herein.

FIG. 23 shows examples of the GUI for a user to create an action. An action may be related to assigning an owner, escalate an alert, updating a selected data field, placing an order and various others. As shown in the example, a user may select an action from a drop-down menu 2302 presenting a list of action options. The action options may be dynamically determined based on the connected objects. As shown in the example, the actions may include, without limiting, Add Watcher, create outbound API, create record, post comment, send notification update field, assign to user, assign to group and the like. In some cases, the action may involve directly adding or modifying data within the connected data cloud. For instance, execution of an action may call an API directly to a Cloud Service (e.g., Salesforce) to perform an action (e.g., add a new data record in a new column or table in the data cloud) or update the source data objects (e.g., update a field 2303). Such automated write-backs capability as described elsewhere herein may beneficially allowing for reduced latency and improved efficiency without the need of transformation or data cleansing as required by conventional ETL.

In some cases, the list of options for defining the trigger and/or the actions may be fixed across different connected data objects. For instance, the trigger options and/or actions may be pre-built based on industry knowledge and expertise. For example, the trigger options and/or actions may be built on top of the connected data cloud monitoring service (e.g., available API calls). Alternatively, the auto-populated list of options for defining an action and/or trigger may be provided dynamically based on the selected data objects. The auto-populated list of options may be determined based on pre-determined rules, industry knowledge and expertise, and/or data pattern extracted from past data. For instance, different action options may be mapped to different type of data objects. In some cases, the list of action options may be provided dynamically according to past behavior associated with a user, an organization, an industry and the like. For example, the action menu for a first user/industry may be different from the action menu presented to a second user/industry based on the past data associated with the user/industry. In some cases, action options may be provided dynamically based on time. For example, different menus or options may be provided based on different times of the year (e.g., different months, different seasons, etc.).

In some embodiments, in addition to the GUI for creating or defining an automation, the data-driven workflow platform herein may provide smart automations or automation recommendations utilizing artificial intelligence (AI) technology. For example, an AI model may be trained using past actions, conditions, and trigger data and the connected data objects. Once trained, the AI model may be capable of automatically determining a trigger condition (e.g., condition value) and/or action for recommendation to a user.

### Dynamic Relationship and Data Model

The data-driven workflow platform as described herein may allow users to create dynamic relationships within data. Such dynamic relationship capability beneficially allows for flexible rules to join data elements together. For example, a user may understand that certain elements such as the master and transactional data is related: the shipment is related to the port of entry, the SKU is related to the PO, the computer is related to the vendor. When something happens upstream (e.g., automation is triggered upstream), such upstream data can be used to identify the impacts downstream, thus avoiding the delays (e.g., days or weeks) to identify the impact.

In some embodiments, a relationship may be created by joining data models or elements of data models within the platform. As described above, the Data-driven workflow platform may comprise adaptors configured to connect to data objects in a cloud repository. The adapter may allow a user to map fields between the storage data models of the platform and table fields in the Data Cloud. The storage data models in the platform may comprise different types of datasets. In some cases, the different types of data may include, for example, such as “elements,” “tasks,” “applications,” and the like. The adapter may enable the data hosted in the data cloud (e.g., Snowflake) to appear as native inside of the platform. For example, as illustrated in FIG. 17, the adaptor may provide a GUI allowing a user to set up a mapping and data type matching. For instance, a user may assign a data type (e.g., transaction, element, application, etc.) to the data field or table of the data hosted in the data cloud. For example, for creating an ESG application, the adaptor may connect to tables stored in the data cloud, and the platform may automatically identify elements such as suppliers, product, economic, environmental, labor, social, etc., related to the ESG application, and display a GUI with auto-populated fields allowing a user to assign a data type to the extracted elements. For example, a user may assign data type an element type to Suppliers and Products (e.g., master/static data), or assign an element type to Economic, Environmental, Labor and/or Social (e.g., transactional/streaming data). Such operation may not apply any modification or change to the data in the data cloud.

A relationship may be created between the storage data models within the platform. The storage data models provided by the platform may dynamically map the relationships within the cloud data. For example, a relationship may be created between an “element” type data named “Products” that contains the complete listing of all products a customer makes or sells and a “transaction” type data named “Inventory Positions” that indicates how much of each product a customer has on-hand.

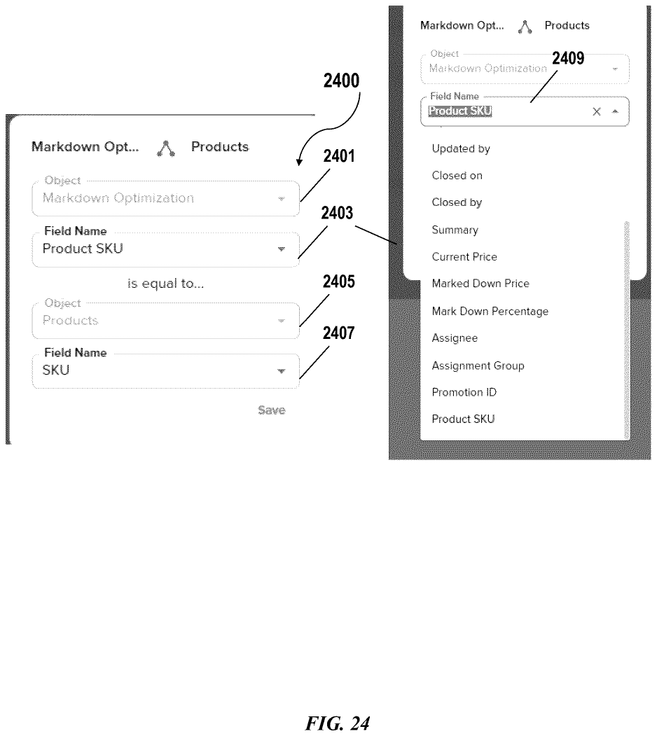

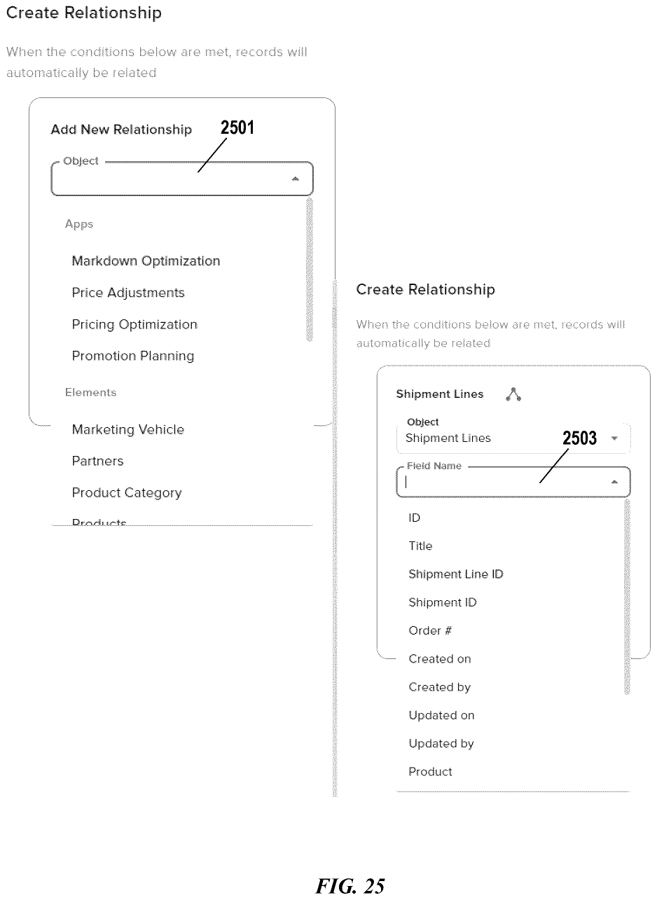

In some cases, a relationship may be created manually by a user via a GUI provided by the platform. FIGS. 24 and 25 show examples of GUI for a creating or adding a relationship. As shown in FIG. 24, the GUI 2400 may provide fields for a user to create a relationship (e.g., equal to) by selecting one or more data fields 2403 of a first data model or element of a first data model 2401 and selecting one or more data fields 2405 of a second data model or element of a second data model 2407. The field name options may be automatically populated in a drop-down menu 2409 for the selected object. As illustrated in FIG. 25, the relationship can be created between two objects of various data types as defined within the platform. For example, the object 2501 may be an application type, element type or transaction type. Upon selection of an object 2501, the associated data fields 2503 may be provided in the drop-down menu for selection.

In some cases, a relationship may be created automatically without user intervention. For instance, the platform may analyze the storage data models within the platform and may recommend creating relationships automatically. For example, the platform may automatically identify that a data model “Inventory” having a column named “sku” should be related to a “Products” data model having a column named “sku.” The platform may generate a recommendation to the user to setup the recommended relationship. A user may choose to accept, reject or modify the recommended relationship. In some cases, the platform may develop an AI model for automatically identifying a relationship. Alternatively, the relationship may be identified based on pre-determined rules (e.g., build relationships based on common identifiers, expert knowledge, or other criterion). The platform may also permit users to manage and share all the relationships created for one or more applications. A user may view the relationships in real-time, dynamically modify the relationship at any point in time and make decisions based on the multi-tier organization.

### No-Code Application Creation

As described above, the Data-driven workflow platform provide a no-code configuration interfaces for creating cloud applications. The platform may allow users to create, customize and/or configure cloud applications via a no-code user interface with built-in features such as configurable and automated workflows and dynamic relationships discovery and creation. In some cases, the platform may provide pre-built applications such that a user may further customize the pre-built application via a “drag-and-drop” GUI. For instance, the platform may provide initial “pre-built” automations for “App Suites” (e.g., Inventory Management or Merchandising). In some cases, these initial automations may be generated based on industry knowledge and expertise.

The platform may automatically provide initial workflows based on the connected data objects. In some cases, the platform may initiate workflows automatically based on the connected data objects and may allow for collaboration securely with third parties. The workflow may be highly configurable with computations, approvals, tasks, analytics, automations and the like.

The platform may automatically select from a library of app suites, including logistics, merchandising, inventory management, risk management, procurement, finance, HR, business development, and the like based on the connected data objects. For instance, based on insights extracted from the cloud data (e.g., data mining), the platform may select an initial application/workflow from the library of app suites.

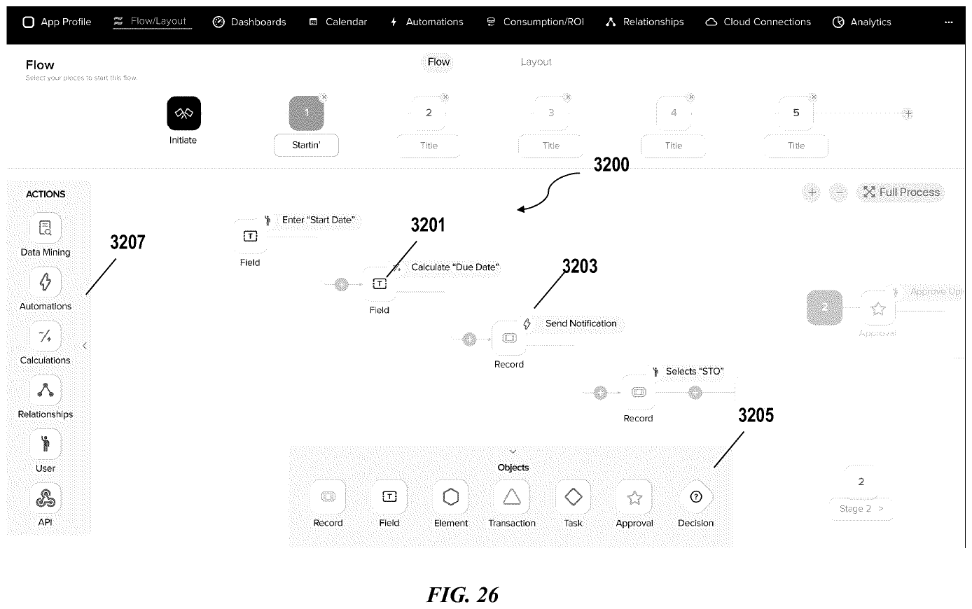

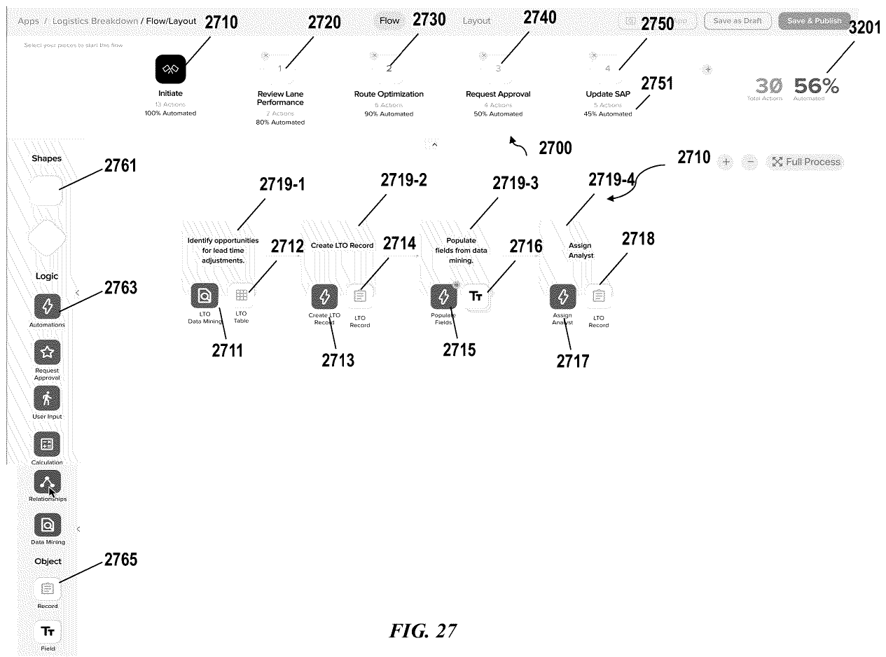

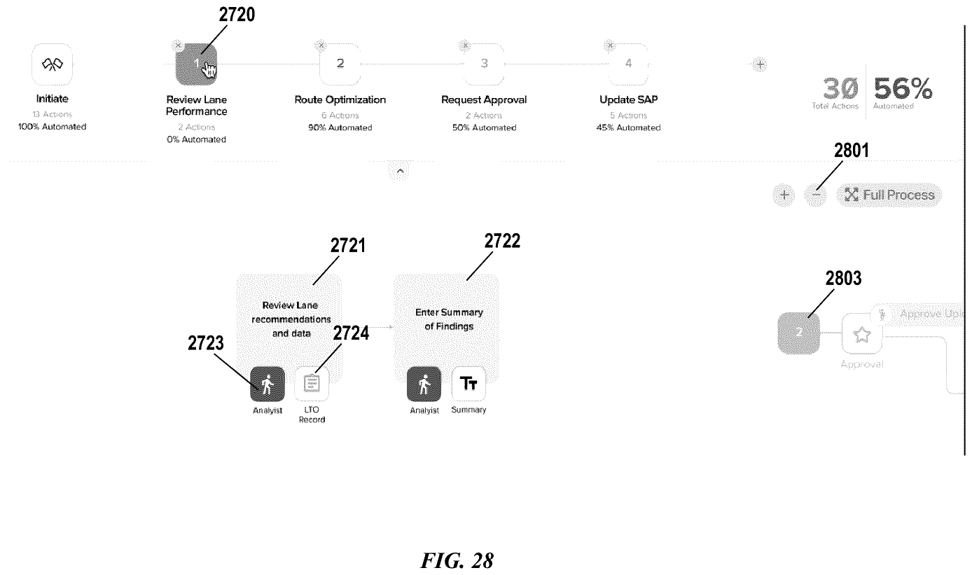

In some cases, the platform may provide a GUI for a user to configure or edit a pre-built workflow. This beneficially allows for a no-code creation of cloud applications with pre-built automations. FIG. 26 shows an example of a GUI 3200 for creating workflows. The initial workflow may be created with pre-built automations 3203 in one or more locations. A user may modify the initial workflow via drag-and-drop functions. For example, a user may add an object 3201 such as a task, record, element, transaction, approval, field to the workflow in any desired location by dragging the component from the “object” panel 3205 and dropping it to the workflow. A user may be permitted to further add actions to a selected object by dragging an element (e.g., data mining, automation, calculations, relationship, assign user, API, etc.) from the actions panel 3207 to an object in the workflow. In some cases, a user may add an object and/or action by clicking on a graphical element 3203 (e.g., plus icon for adding an object or an object icon) in the workflow to activate a menu for selecting the object and/or action to be added. In some cases, a user may choose to delete or modify an action (e.g., automation) or object that is provided in the initial workflow by interacting with the graphical element corresponding to the action or object.

FIGS. 27-30 shows another example of a GUI for creating workflows. As shown in FIG. 27, the GUI may display a workflow with one or more stages 2710, 2720, 2730, 2740, 2750. The GUI may display general information related to each stage such as the number of actions included in each stage and percentage of automation 2751. Different stages may have different automation percentage. As an example illustrated in FIG. 27, an initiate stage 2710 may be 100% automated. The initial stage may comprise a plurality of actions 2719-1, 2719-2, 2719-3, 2719-4. In some cases, an action may include a logic 2711, 2713, 2715, 2717 and an object 2712, 2714, 2716, 2718. The logic and object may define “who” (logic) does “what” (object). A logic may be, for example, automations, request approval, user input, calculation, relationship, data mining and the like. An object may be, for example, record, field, table, summary and various other objects/elements provided by the system. In some cases, a user may modify a workflow by dragging an element from the panel (left panel) and dropping to the workflow. The panel may provide, for example, shapes 2761 (e.g., square shape may be used to represent Action, diamond shape may be used to represent decision), logic options 2763 and a list of objects 2765. The GUI may also display information related to the overall process such as the percentage of automation and total number of actions 3201 in the entire process/workflow.

FIG. 28 shows an example of GUI displaying a workflow for the second stage 2720. Similarly, the second stage workflow may comprise one or more actions 2721, 2722 and each action may include logic 2723 and object 2724. In some cases, an initial workflow for a stage may be recommended by the system and displayed on the GUI then a user may choose to accept, modify or rejection any components of the workflow. In some cases, a user may be permitted to zoom in/out from any stage to view the full process 2801. The GUI may also display a preview 2803 of the next stage. FIG. 29 shows an example of GUI displaying a workflow for the third stage 2730. In the example, the workflow may be 50% automated because one action includes human analyst and the other action includes an automation. FIG. 30 shows an example of GUI displaying a workflow for the fourth stage 2740.

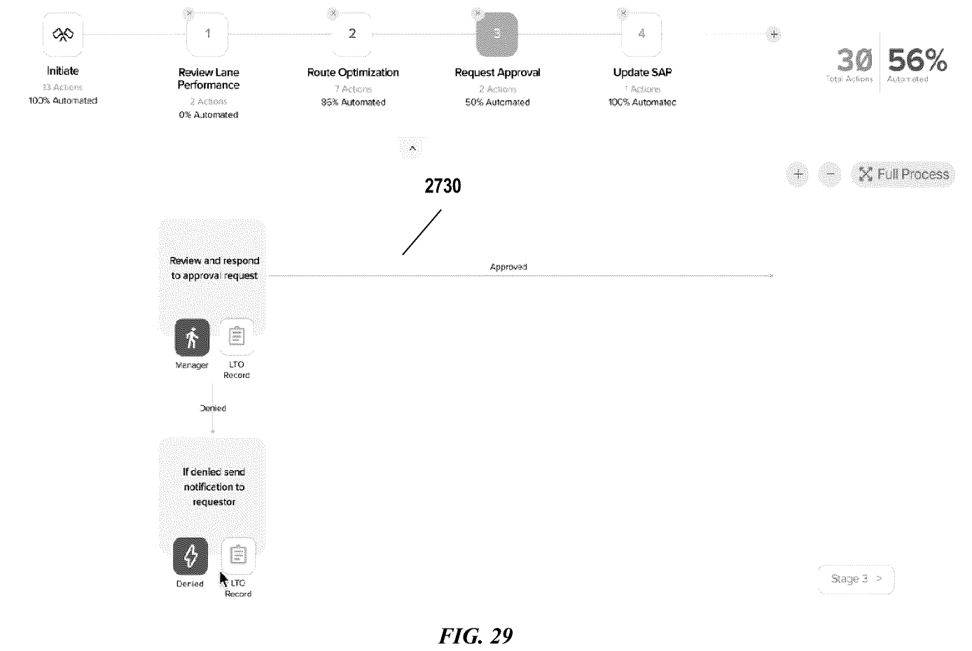

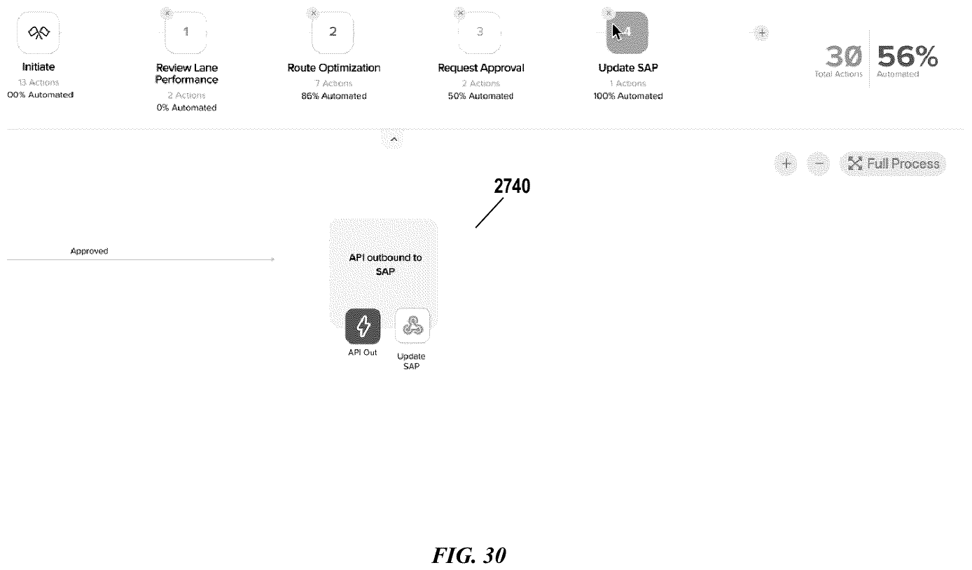

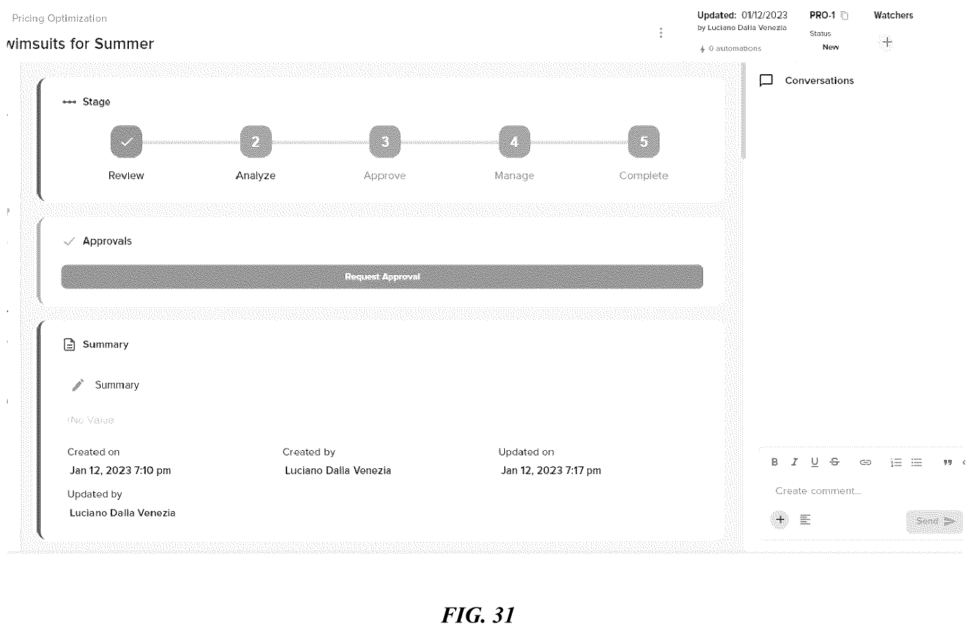

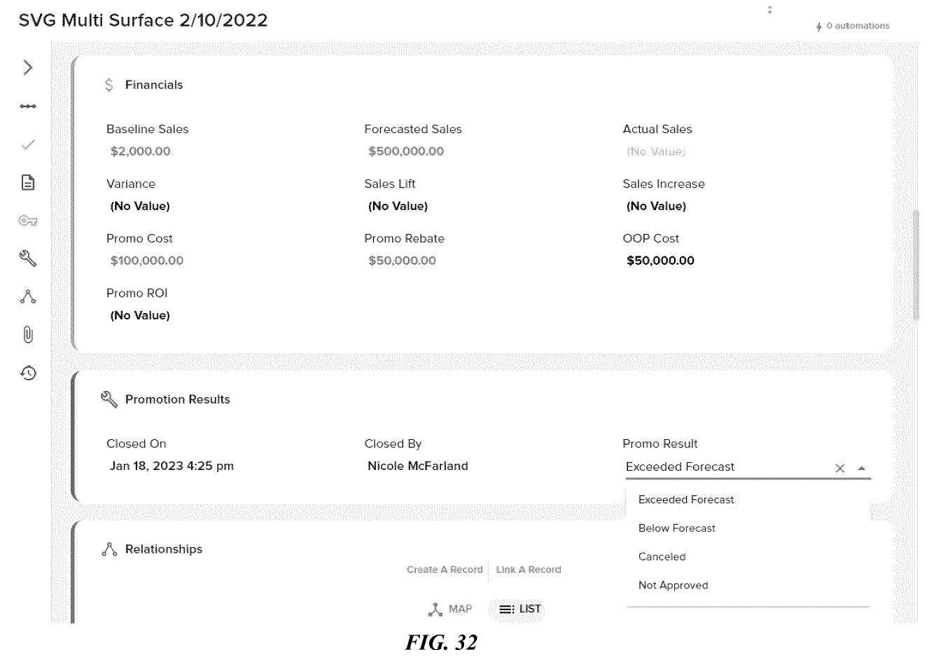

FIG. 31 shows an example of GUI displaying a created workflow with tracked progress. As illustrated in FIG. 31 and FIG. 32, once a workflow is deployed and executed, details about the data analytics, computation, actions, progress and the like may be displayed to a user on the GUI.

### Examples of Use Cases

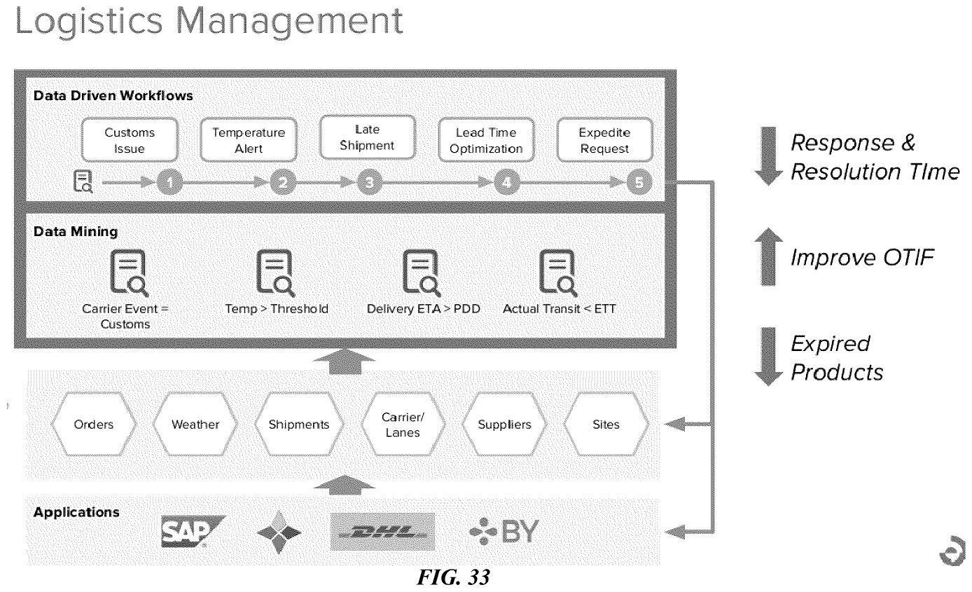

As mentioned above, the platform may automatically select an initial workflow from a library of app suites, including logistics, merchandising, inventory management, risk management, procurement, finance, HR, business development, and the like based on the connected data objects. For instance, based on insights extracted from the cloud data (e.g., data mining), the platform may select an initial application/workflow from the library of app suites. An app suite may include a plurality of workflows. FIGS. 33-38 show examples of logistics application suite. As shown in the examples, a logistics application suite may comprise a plurality of workflows. A workflow may comprise data mining to identify dynamic relationship between objects, and automations (e.g., trigger condition and action). For example, as shown in FIG. 34, the lead time optimization workflow may be provided which reduces excess inventory by proactively addressing lane variance gaps. Data connected to the workflow (e.g., Lanes, Shipments, Partners, Sites) may be mined to identify when the actual lead times are within the defined tolerance levels and actions are automated to adjust the lead time. As shown in FIG. 35, the temperature alert workflow may be provided to reduce expired product volumes by proactively managing temperature conditions during transit. Data is mined to identify temperature issues of goods in transit. Actions are automated between the logistics team and the carrier to address the alert. The customer issues workflow as illustrated in FIG. 36 may be created to reduce customs delays by proactively managing issues. Data is mined to alert logistics of potential issues based on port congestion, strikes and other impacts to the port. Actions between logistics and the broker are automated. The late shipment workflow as illustrated in FIG. 37 may be created to improves OTIF by proactively identifying late shipments. Data is mined to identify when a shipments estimated arrival time is greater than the promised delivery date. Actions to identify alternate sources, expedite and mitigate the delay are automated. The expedite request workflow as illustrated in FIG. 38 may be created to provide full transparency and accountability of who authorizes the cost for expedite requests is managed and centralized in one platform. Actions are automated to notify carriers, logistics and others of the approval.

### AI-Based Recommendation

In some embodiments, the initial workflow may be provided with AI-based recommendations. For instance, the platform may develop an AI model to generation predictions about when to initiate an action (e.g., location in the workflow), what action to take, or other features in the initial workflow. The AI model may be trained and developed using training datasets collected within the platform. For example, past pattern of actions may be extracted from the action or processes data defined within the platform and the data may be utilized as training data to develop the AI model. In some cases, the data fields involved in a workflow may also be predicted by an AI model.

The provided systems may employ any suitable artificial intelligence techniques to generate the workflow, identify an automation, dynamically relate identification, data model conversion (e.g., normalize original data in the cloud to conform with storage data model in the platform) and/or perform other functions as described elsewhere herein. Artificial intelligence, including machine learning algorithms, may be used to train a predictive model for predicting a recommendation (e.g., automation, workflow etc.), extracting the data relationship, normalizing data, performing impact analytics as described above, and various other functionalities as described elsewhere herein. A machine learning algorithm may be a neural network, for example. Examples of neural networks include a deep neural network, a convolutional neural network (CNN), and a recurrent neural network (RNN). The machine learning algorithm may comprise one or more of the following: a support vector machine (SVM), a naïve Bayes classification, a linear regression model, a quantile regression model, a logistic regression model, a random forest, Isolation Forest (iForest) model, a neural network, CNN, RNN, a gradient-boosted classifier or repressor, or another supervised or unsupervised machine learning algorithm (e.g., generative adversarial network (GAN), Cycle-GAN, etc.). In some cases, a machine learning algorithm trained model may be pre-trained and implemented on the provided system, and the pre-trained model may undergo continual training or refinement with custom data that may involve continual tuning of the predictive model or a component of the predictive model (e.g., classifier) to adapt to changes in the implementation environment or use application over time (e.g., changes in the user data, insight data, model performance, third-party data, etc.).

### Data Mining

The data-driven workflow may provide data mining capability that allows for extracting insights from the data in the data cloud. In some cases, the data mining feature of the platform may be utilized to trigger insights generation directly from the data within the data cloud, and/or automatically identify data events (e.g., change of data, adding/deleting data, data anomalies, or other data analytics provided by the cloud provider). The platform may provide a GUI for user to configure or set up a data mining for selected data in a convenient manner. The data mining feature may be seamlessly integrated with other functions such as Automation. For example, a data mining configuration or data mining result may be used as trigger and condition for an automation to initiate the automation or trigger actions.

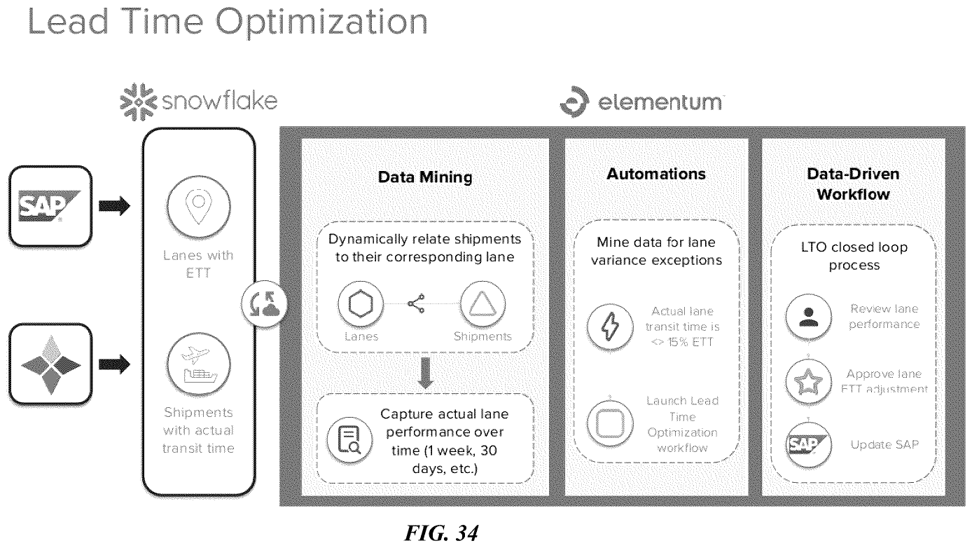

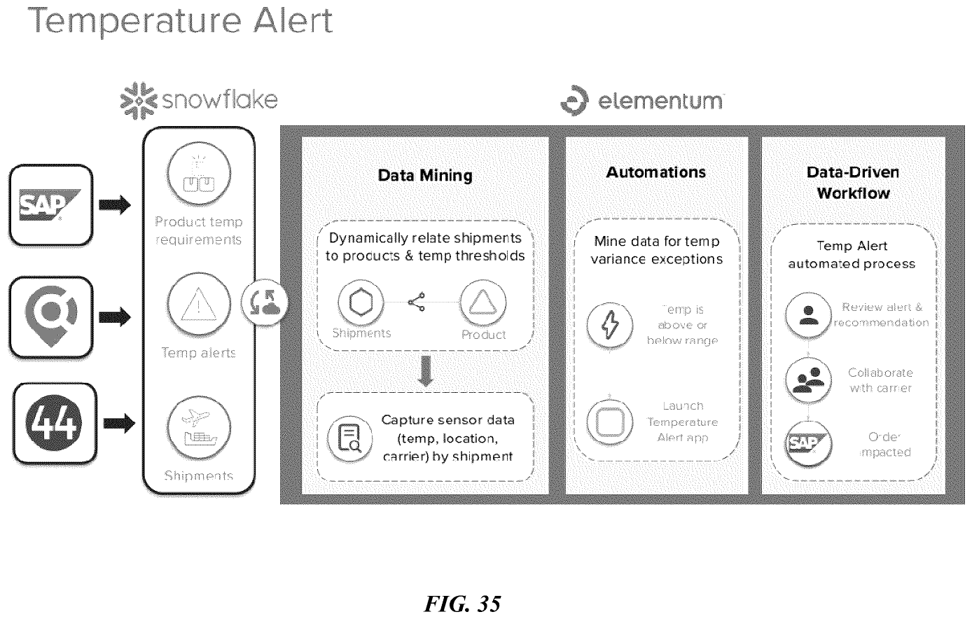

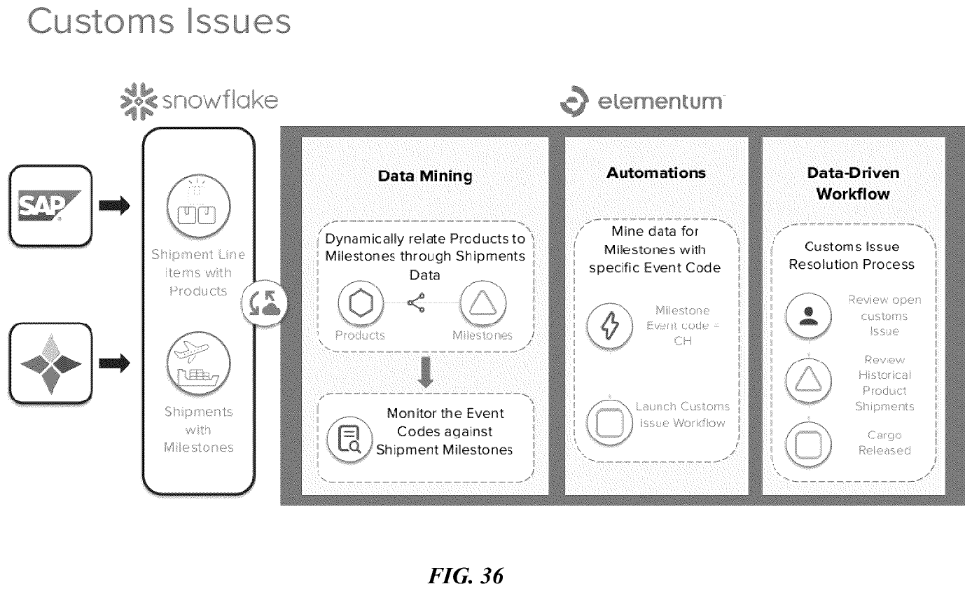

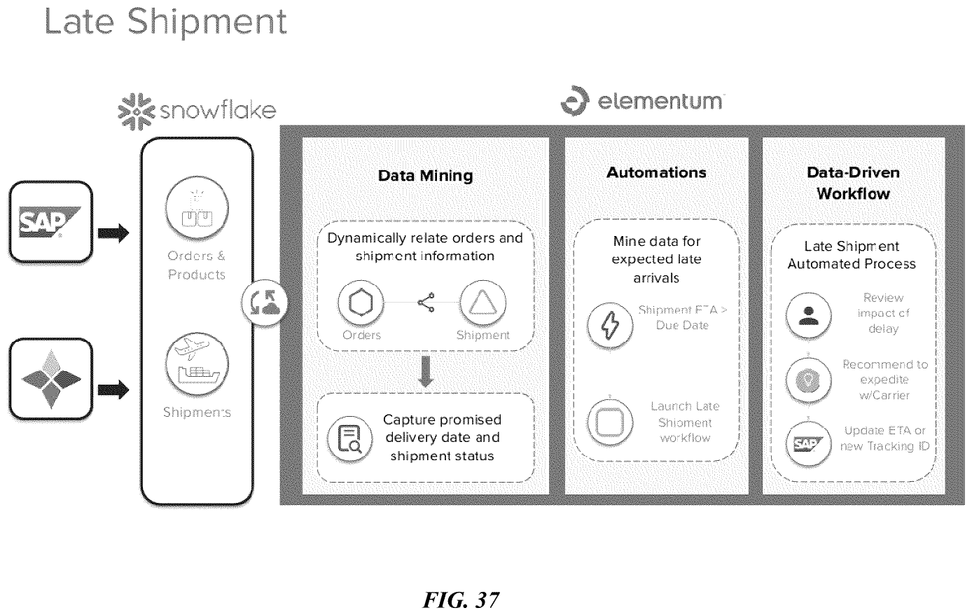

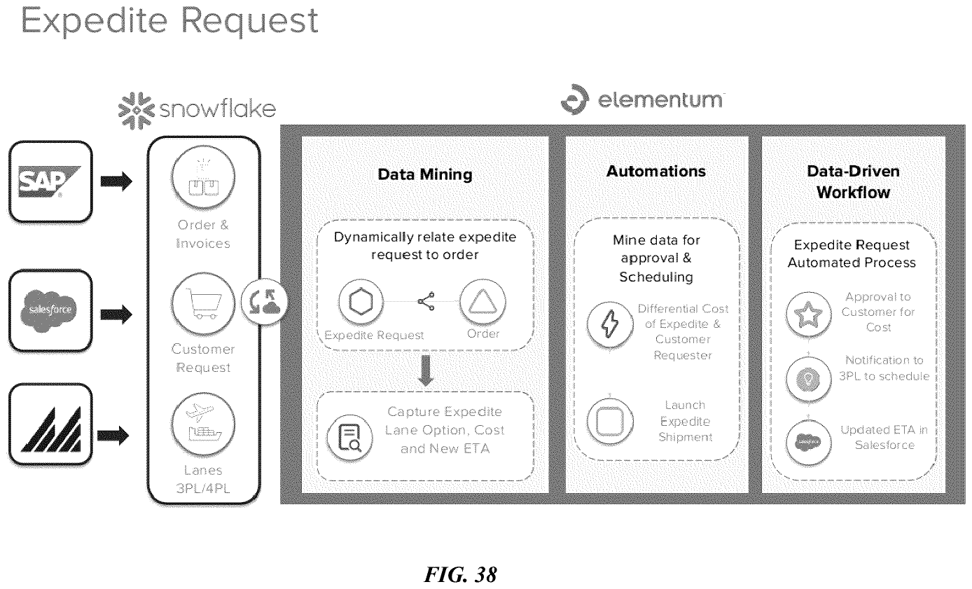

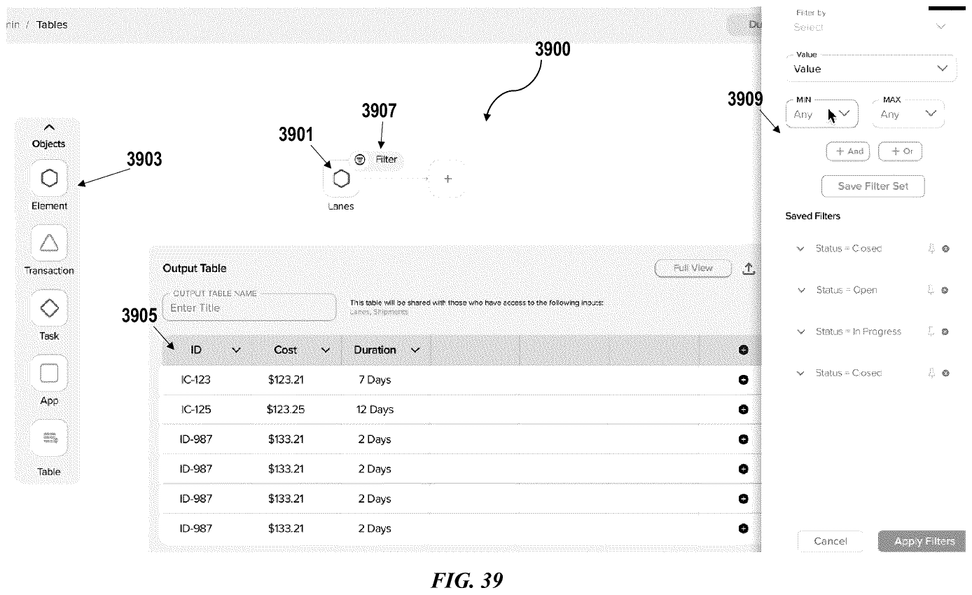

FIGS. 39-43 show examples of GUI for configuring or creating data mining. In some cases, a user may configure or set up the data (e.g., table) to mine and one or more parameters to run data mining on the data. FIGS. 39-42 show examples of a GUI 3900 for creating an object (e.g., table) to data mine. As shown in FIG. 39, a user may drag on an element 3903 from the objects pane and drop the selected element (e.g., Lane 3901). For example, a user may click on the Element icon in the left pane and select the object e.g., Lane from the drop-down menu. The table 3905 of the selected element may be automatically populated on the GUI. A user may choose to filter the selected object 3901 such as clicking on the “filter” icon 3907, then a filter pane 3909 may pop up with a plurality of configurable fields for a user to set up the filter. For example, a user may set up the values, combine filters, set up filter status and the like to set up a filter to be applied to the object 3901. Once the filter is applied, the table 3905 may be automatically updated and information about the filter 4001 may also be displayed with the object as shown in FIG. 40.

A user may be prompted to drag-and-drop another object e.g., shipments 4003. Similarly, a user may be prompted 4005 to set up a filter to be applied to the second object 4003. Once the second object and the second filter are set up, the user may be prompted to set up a relationship or view the relationship between the two objects. For example, upon clicking on the relation icon 4007, a relation pane may pop up and allow a user to define the relationship between the two objects as described elsewhere herein. The table may be automatically updated as the relationship, and/filter are configured.

As shown in FIG. 41, the GUI may provide options for a user to aggregate columns 4101 in the output table. For instance, a user may choose to select columns for aggregation and/or define a filter as shown in FIG. 42. The GUI 4201 may allow the user to select columns to include in the output table and define how to aggregate the selected columns. A user may also be permitted to create a new column 4203 in the output table via the GUI.

The GUI may further allow a user to set up actions to be executed on the created table. For example, as illustrated in FIG. 41, the GUI may display message 4103 prompting a user to select actions to be applied to the table. A user may click on the Automation icon 4105 and select from the action options (e.g., create record, send notification) in the drop-down menu to set up the action for the Automation.

Once the table is created and saved (e.g., data can be written-back to the data cloud directly), a user may set up one or more parameters for running data mine. For example, the GUI illustrated in FIG. 43 may prompt 4301 a user to set up one or more parameters to schedule the frequency, and/or time to run the data mine and/or one or more parameters for filtering the table. As shown in the example, upon clicking on the schedule button 4303, options 4307 to set up a frequency and/time to run the data mine may be displayed. A user may select from the frequency options such as hourly, daily, weekly and/or set up the start time via the GUI. A user may also be permitted to set up a filter via the GUI 4309 to be applied to the data mine by clicking on the filter button 4305.

### GUI for Machine Learning-Based Anomaly Detection and Data Mining

In some embodiments, methods and systems here may provide front-end interfaces allowing users to set up a machine-learning based data mining. The front-end interfaces (e.g., GUI) may also permit users to set up trigger and condition of the trigger for automating a workflow via the machine-learning-based data mining feature. For instance, a model may be trained by machine learning algorithm (supervised, unsupervised, semi-supervised, etc.) for anomaly detection. The anomaly detection algorithm (e.g., machine learning algorithm) may allow users to detect outliers in time series data. For example, the anomaly detection algorithm may be powered by a gradient boosting machine (GBM) which uses a differencing transformation to model data with a non-stationary trend and uses auto-regressive lags of the historical target data as model variables. Any other suitable algorithms can be utilized for anomaly detection.

In some cases, the machine-learning models for anomaly detection may be trained and developed by the underlying data cloud structure. However, users may be required coding skills to call the machine learning (ML) functions to create and train a detection model and/or to make an inference using the trained model. The platform herein beneficially provides a no-code user interface (GUIs) allowing users to conveniently set up input data time window, data segmentation, retrain the model, and/or control a sensitivity level of the detection (e.g., how strict the anomaly detection is). In some cases, the anomaly detection feature may be integrated as part of the Automation to be set up as a triggering event and the condition. In some cases, the anomaly detection feature may be part of the data mining feature.

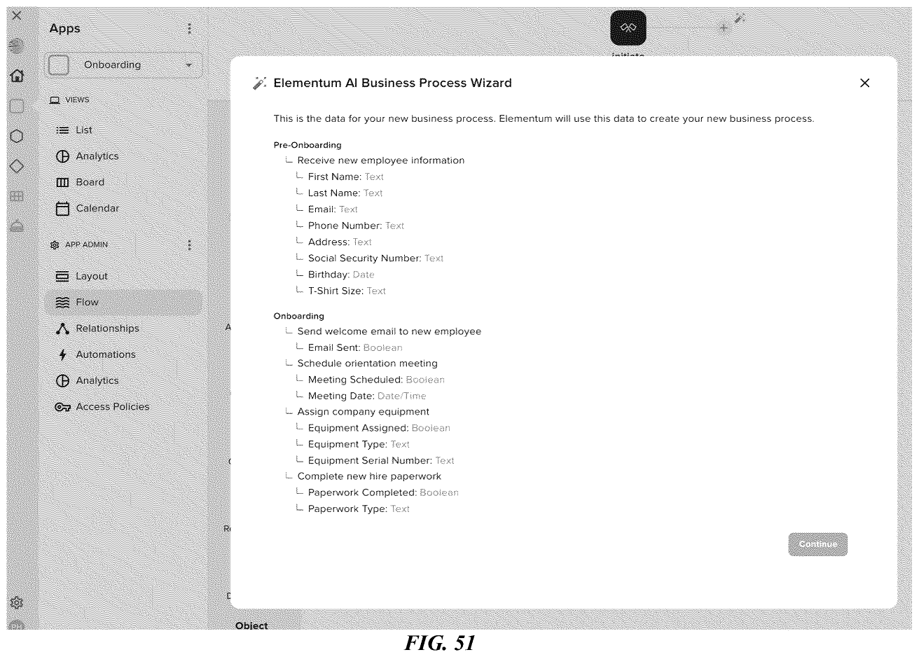

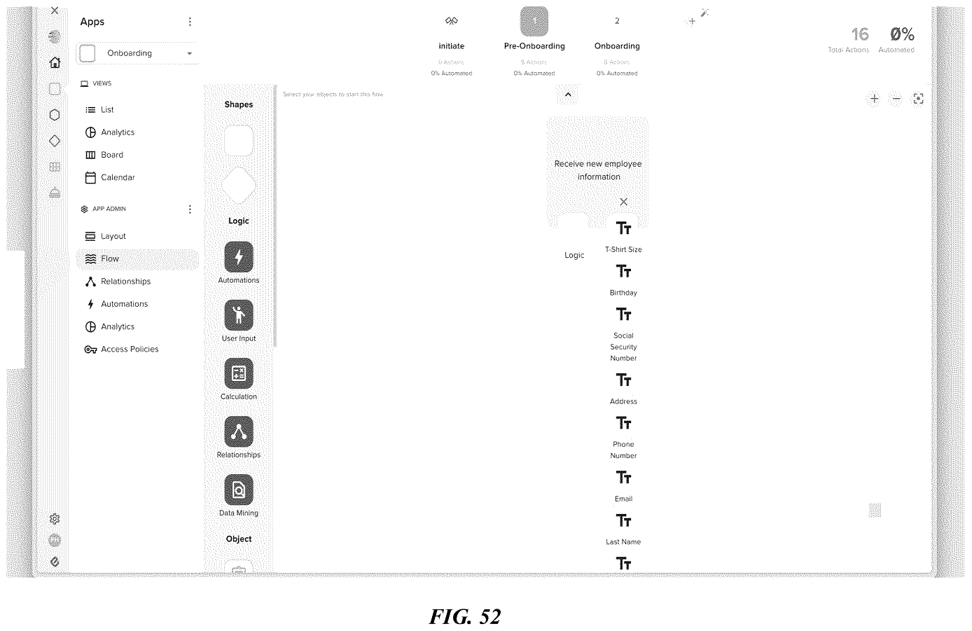

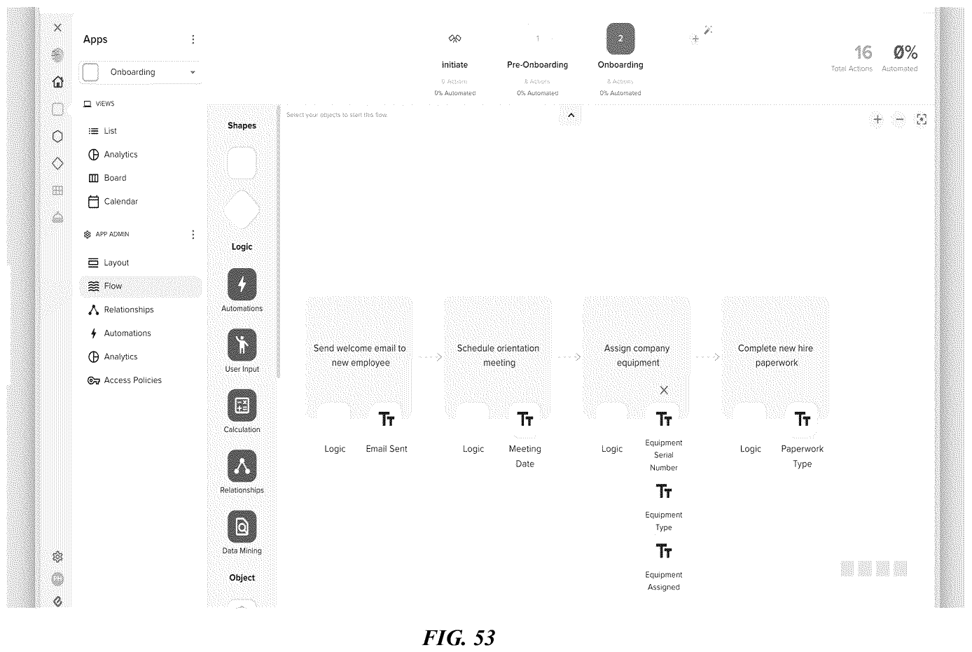

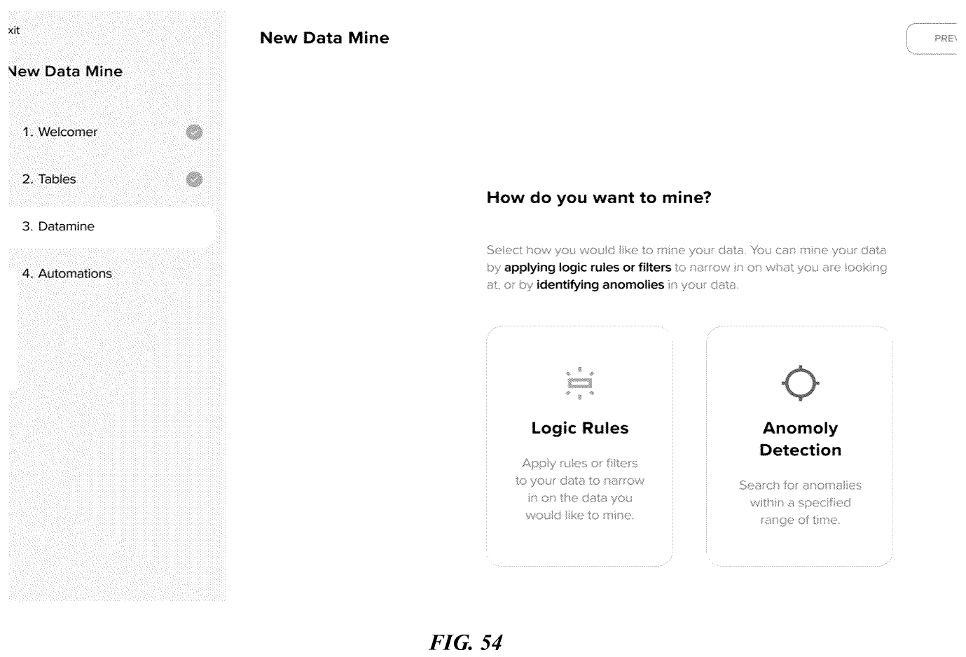

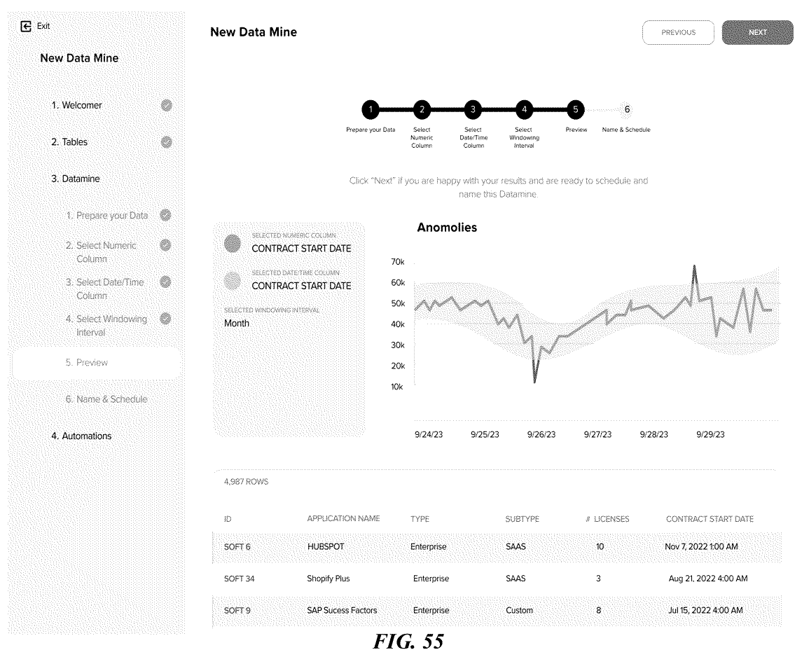

FIG. 54 shows an example of a GUI for creating a new data mine function. The GUI may allow users to set up a data mining function by applying logic rules (e.g., apply rules or filters to the data to narrow in on the data) as described above or by the machine-learning based anomaly detection. FIGS. 55-58 show various GUIs for configuring the data mine or the anomaly detection function. FIG. 55 shows an example of GUI for machine learning-based anomaly detection setup and report. The GUI may provide streamlined steps to guide a user setting up machine learning-based anomaly detection. In an example illustrated in FIG. 56, a user may be guided to set up a time window of the input data to the detection model (e.g., minutes, hour, day, week, month, etc.) and guided to segment the data by selecting columns (e.g., date/time column, numeric column, numeric column aggregation). For instance, a healthcare user may look for anomalies against all their patient data or they may segment the patient data by state or gender or another field in the patient data. The GUI may provide recommendation to the user for selecting a time window based on the user selected data.

In some cases, a user may be guided to identify columns as primary columns that have unique values. Upon selecting the columns, in some cases, the platform may further track state of data. For instance, the platform may use data identity to keep track of every time a row of data starts a workflow, making subsequent data lookups idempotent. For example, a process running hourly may trigger the same workflow multiple times if the system was not tracking that the row of data had already triggered the workflow. For example, a user may not be notified multiple times when the data is found until the data no longer passes the logic check. The platform herein uses the primary key of a data table for the identity. The platform provides the user a way to control the identity of their data to even allow idempotent data lookups on transactional data which does not by default have identity.

The output of the detection model may include an indication that the data is an anomaly or not and/or the range of what an anomaly is. The platform herein interfaces with the detection model and receive the output of the model then stores it in the Data Mine's function. The Data Mine feature of the platform then analyzes the model output to determine whether the data is changed from normal to anomaly or vice versa and triggers automations when a change is detected. The platform may allow users to set up the triggers to create workflows or automatically clean up workflows as described elsewhere herein. FIG. 57 shows an example of a GUI allowing a user to preview the detection result and confirm the setup or reconfigure the detection. The GUI may provide a ‘Percentile’ field where a user may input is a score below which a given percentage of scores in its frequency distribution falls. This beneficially allows the user to control the sensitivity level or how strict the anomaly detection algorithm to be. For instance, when the number is lower the anomaly detection algorithm may treat more events as anomalies.

FIG. 58 shows an example of GUI allowing a user to setup schedule for data mine process runs. The user may set up an Automation to create a new workflow with the found data. The user may schedule a frequency or time schedule for the data mine process runs.

In some cases, the platform may allow a user to retrain the underlying anomaly detection model. Alternatively, the platform may automatically retrain the underlying anomaly detection model upon detection of model drift or data drift.

### Cloud-Native Architecture

In an aspect, the present disclosure provides a system for providing a data-driven workflow platform. The system comprises a first module configured to operatively couple the data-driven workflow platform to one or more data clouds; a second module configured to map selected data objects to a data storage model of the data-driven workflow platform, where the selected data objects are stored on the one or more data clouds; and a visualization module configured to display, on a graphical user interface (GUI), an interactive flow for building a cloud application utilizing or managing the selected data objects. In some cases, the interactive flow comprises at least one graphical element corresponding to a rule for automating an action triggered by a triggering event of the selected data objects.

In some embodiments, the first module is configured to translate an instruction to perform an operation on at least one of the selected data objects received via the GUI into a database operation executable in the data cloud configuration. The database operation is executed on the selected data objects in the data cloud configuration without using an extract, transform and load (ETL) data integration process. In some cases, the selected data objects comprise transactional data or streaming data. In some cases, the data-driven workflow platform is configured to cache an intermediary result for performing the operation.

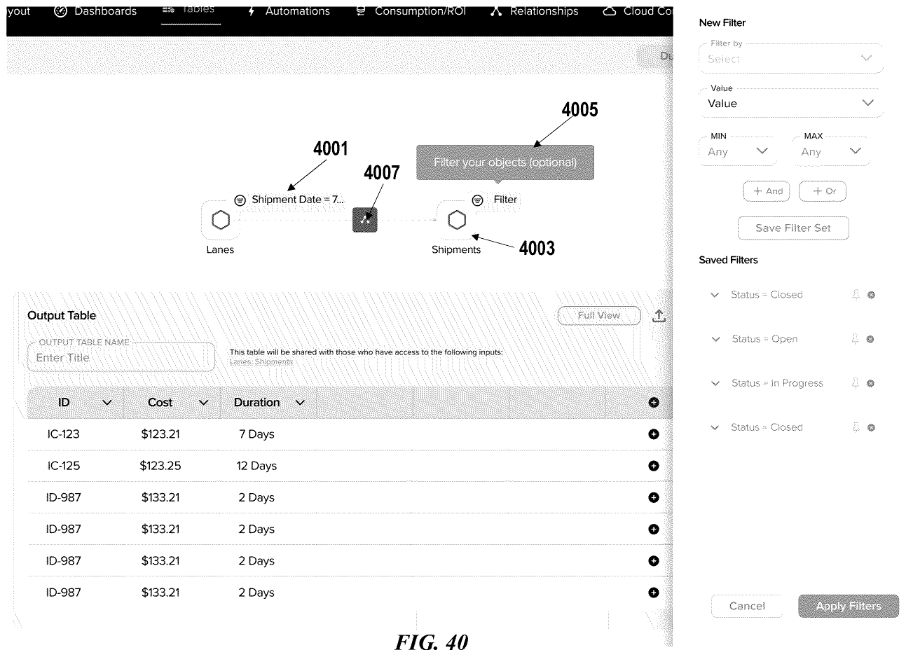

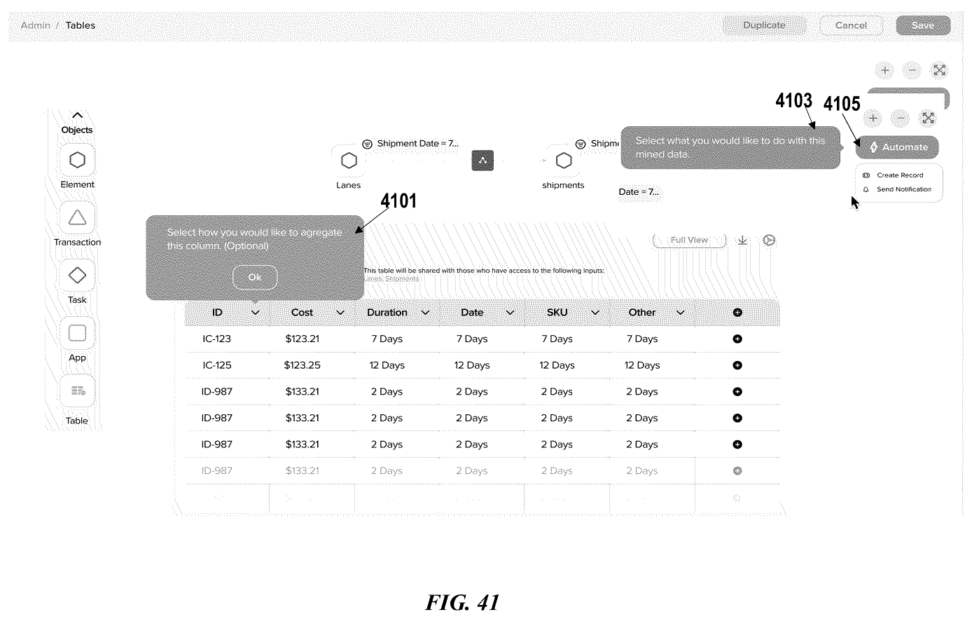

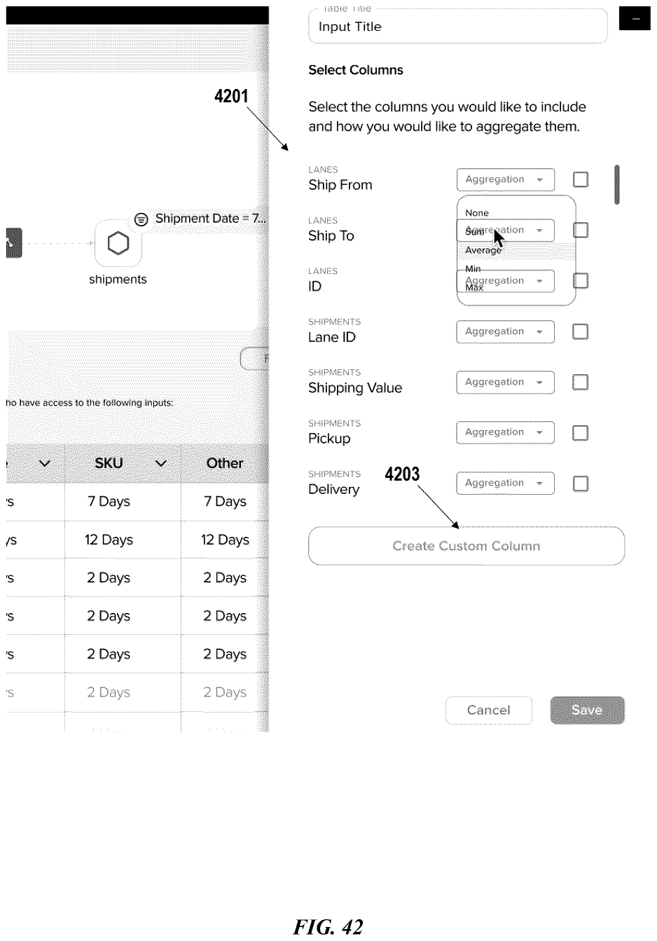

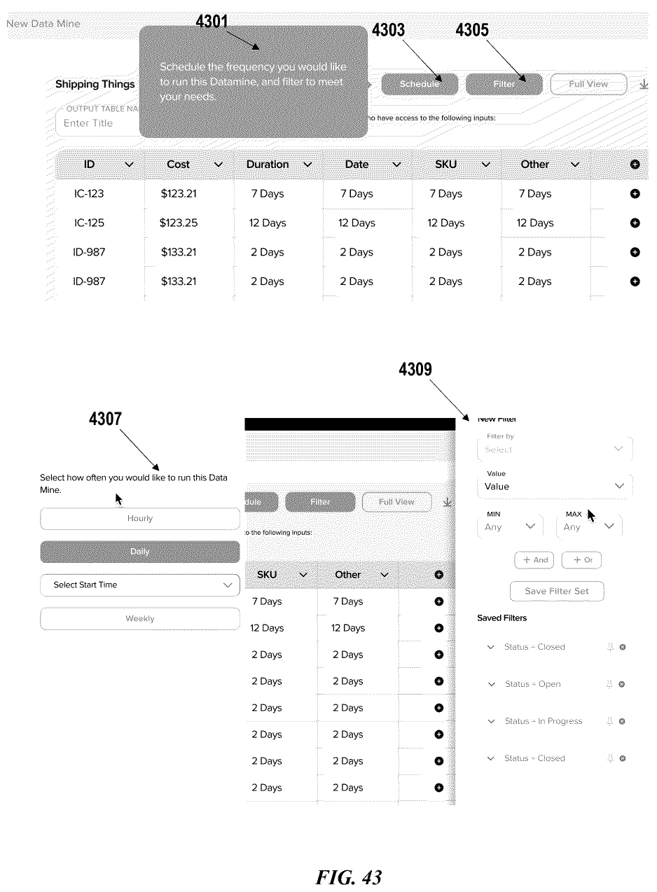

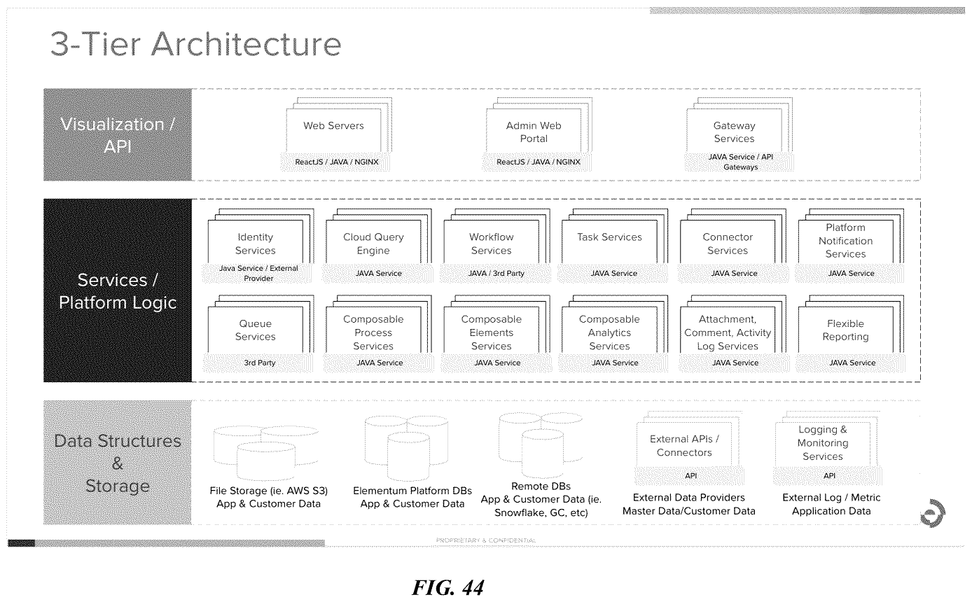

FIG. 44 schematically illustrates an architecture for the data-driven workflow platform. The architecture may be a tiered architecture comprising data structures and storage layer, a services/platform logic layer and a visualization/API layer. The tiered architecture may allow users to access and use data stored in any Data Cloud without the need to move that data to a central location. The data-driven workflow platform may execute workloads (e.g., queries) within the Data Cloud provider (e.g., AWS S3, Snowflake, Databricks, External data provider, etc.) and then stream the data and/or insights back to the user via the user experience interface (UI) provided by the visualization module. In some cases, the platform may employ buffering techniques to allow for live streaming or updating from a Data Cloud to an enterprise SaaS solution. For example, the platform may cache an intermediary result generated during a workflow action for a pre-determined time period (e.g., 15 seconds, 20 seconds, 30 seconds, etc.).

The platform may setup watching processes to be notified as data is changing in the source datasets in the data cloud via a cloud link connected to the notification services in the platform logic layer and the monitoring services in the data structures and storage layer. The watching feature may be utilized for triggering actions in the automation functions within platform. Query execution is performed in services layer. For instance, queries may be processed using “virtual warehouses” where each virtual warehouse is a massively parallel processing compute cluster compute cluster composed of multiple compute nodes from a cloud provider.

### AI-Based Application Discovery

In some embodiments, the platform may analyze the available data sets and leverage AI techniques to recommend one or more predefined applications. This beneficially allows a user to leverage the recommended application with their data.

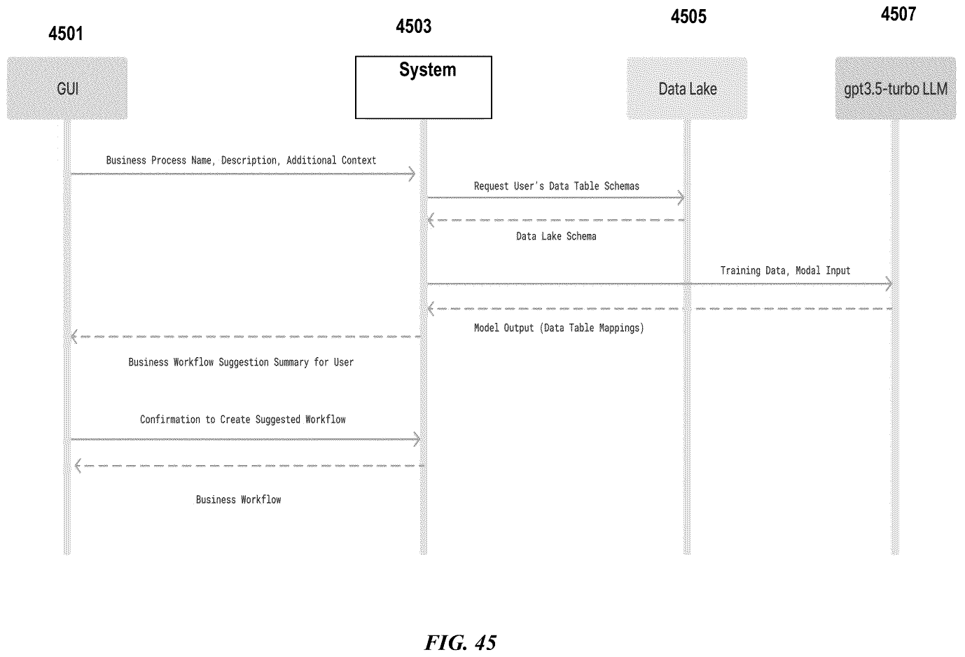

FIG. 45 schematically shows an example of AI-based Application discovery feature, in accordance with some embodiments of the present disclosure. The system 4503 may access the data schema for all the customer's data in the connected data lake 4505. The system 4503 can be the same as the data-driven workflow platform or service management cloud system as described elsewhere herein. For instance, the adapter of the system 4504 may enable data hosted in the data cloud (e.g., Snowflake) to appear like it is native inside of the system. For instance, during the configuration or integration between the data cloud (e.g., Snowflake) and the system for the targeted data, the adapter may setup a mapping and data type matching without changing the data or applying any type of modifications to the data within the data cloud. For example, the system 4505 may send a request to access the user's data Table schemas in the data lake 4505. The request may be generated based on the input received via the GUI 4501 such as business process name, description, or other input information.

The system 4504 may comprise a plurality of predefined applications organized or managed in an application marketplace that users or customers of the platform can install into their organization. For instance, the system 4504 may comprise a library of predefined applications suites, including logistics, merchandising, inventory management, risk management, procurement, finance, HR, business development, and the like as described elsewhere herein.

The system may train a large language model (LLM) 4507 on the availability of the predefined applications and the shape of the data tables (i.e., data lake schema) required to fulfill the application. The system trains the LLM on the shape of the data tables of the customer's data lake. The LLM may be personalized or customized using user data. As an example, a user may provide a list of data tables. The system may identify a list of available predefined workflows or business workflows with the required data to power them. The system may be instructed to look for data tables with similar shape and function to the predefined workflows. As an example, the system may return a JSON array of business process objects with the keys:
predefinedWorkflowId (String)
table-mapping:
   predefinedTableId (String)
   tableFieldName (String)
   predefinedTableFieldName (String)

After training the LLM, the system requests the LLM to look for pre-defined applications that can be powered with the data in the data lake. The LLM returns the data table mappings to the system which is used to create the predefined applications.

If a match to a predefined application is found, the LLM returns the data table mappings to the system and the system creates the application on behalf of the customer. If there are no matches, the system switches to a generative approach and asks the LLM to generate possible business workflows outside the predefined applications.

As described above, the input to the trained LLM may comprise shapes of data tables or schemas. Following is an example of input to the trained LLM:

User Data Tables:
<[{“name”: “USERS”,
“databaseName”: “financials”,
“schemaName”: “internal”},
{“name”: “SHIPMENTS”,
“databaseName”: “financials”,
“schemaName”: “internal”},
{“name”: “PRODUCTS”,
“databaseName”: “financials”,
“schemaName”: “internal”
The following is an example of output of the model:
“data”: {“aiCloudLinkAppDiscoveryCompletionExecute”: {“apps”: [{“name”: “Manage

Products”,

“description”: “Create, update, and delete product information”,
“tables”: [“PRODUCTS”,

“PRODUCT_LISTING”]},

{“name”: “Manage Shipments”,
“description”: “Create, update, and delete shipment

information”,

```
“tables”: [“SHIPMENTS”,
  “SHIPMENT_TRANSACTION”]},
{“name”: “Manage Users”,
“description”: “Create, update, and delete user information”,
  “tables”: [“USERS”]},
{“name”: “Manage Warehouses”,
“description”: “View and manage warehouse usage and
```

metering information”,

| “tables”: [“WAREHOUSE_METERING_HISTORY”, | |
|---|---|
| | “WAREHOUSE_LOAD_HISTORY”, |
| | “WAREHOUSE_EVENTS_HISTORY”]}, |
| {“name”: “Manage Contracts”, | |
| “description”: “View and manage contract information”, | |
| “tables”: [“CONTRACT_ITEMS” | ]}, |

{“name”: “View Usage Metrics”,
“description”: “View usage metrics for various services”,
“tables”: [“METERING_DAILY_HISTORY”,

“MONETIZED_USAGE_DAILY”,
“STAGE_STORAGE_USAGE_HISTORY”,
“STORAGE_USAGE”,
“USAGE_IN_CURRENCY_DAILY”]}]}}

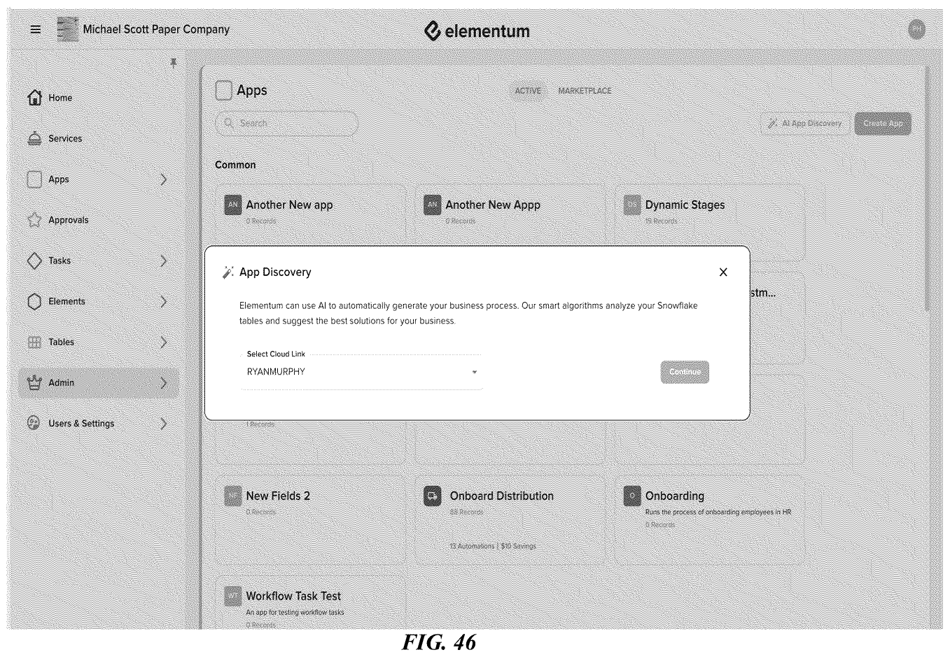

FIGS. 46-48 show examples of GUI for the AI-based Application discovery feature. As shown in FIG. 46, a user may provide input via the App Discovery function within the GUI such as by selecting a cloud link. The system may then automatically gather the data schema in the selected data lake and identify a list of available predefined workflows or business workflows with the required data to power them. FIG. 47 illustrates examples of predefined applications identified by the system as the model output.

A user may select from the plurality of predefined applications to create an application as shown in FIG. 48. For example, a user may be prompted to provide input in the data fields such as Name, Namespace, Handle, Description, Category to create an App.

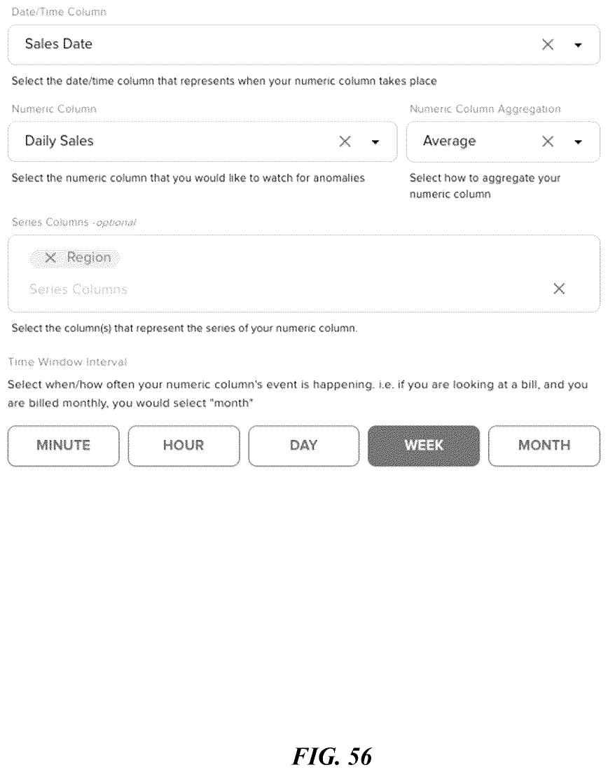

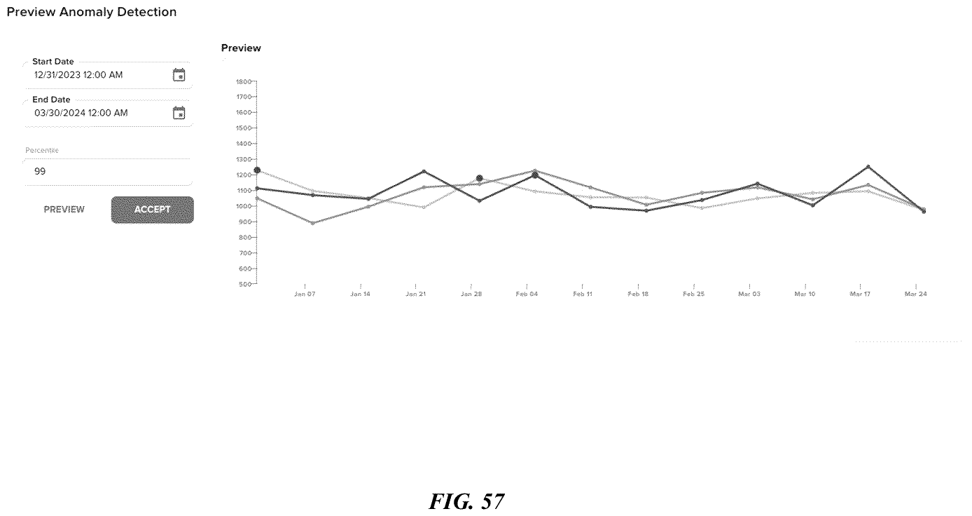

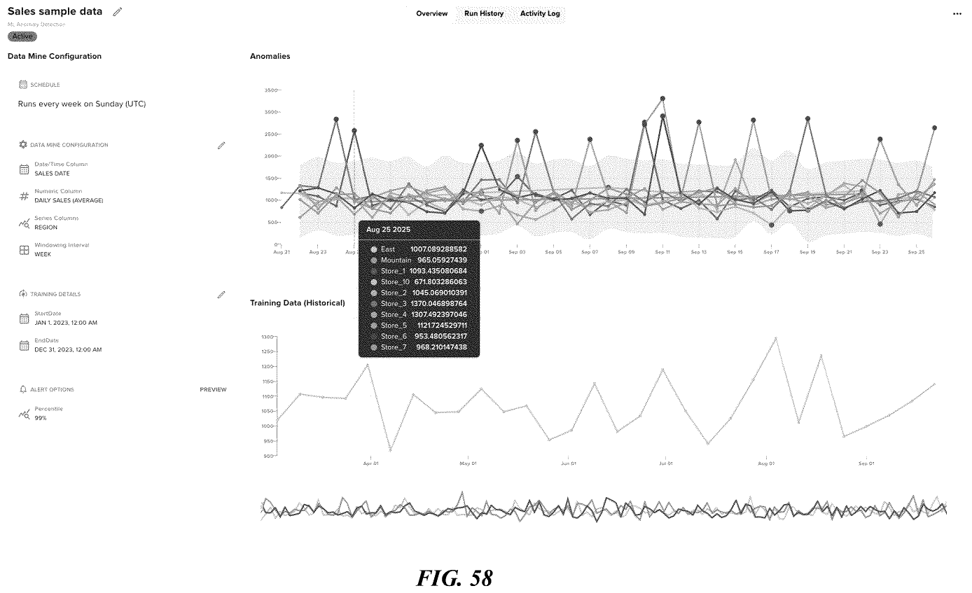

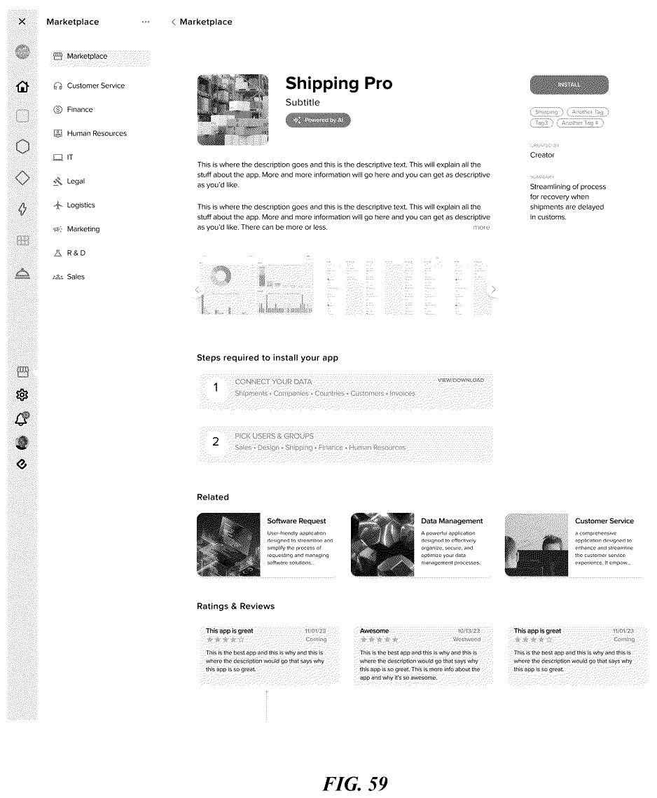

FIGS. 59-60 show additional examples of GUIs for AI-based application discovery. FIG. 59 shows an example of listing of applications discovered by the AI or LLM algorithms as described above. the GUI may guide a user to install a user selected application (e.g., connect data via cloud link, pick users and groups, etc.). FIG. 60 shows an example of GUI for creating an application list and publish to the platform to be used by other users. The GUI may allow users to input title, subtitle, select category, subcategory, select cover image, thumbnails, upload App file and the like.

In some cases, upon a user setting up a data driven workflow, the platform may provide the user multiple options for choosing how to initiate the workflow. In some embodiments, the multiple options may comprise heuristics, AI, machine learning, and LLMs. Upon a user selecting using LLM to initiate a workflow, a menu of options may be displayed within the GUI prompting the user to select an LLM from a plurality of LLMs. The GUI may display relevant information (e.g. effectiveness, cost, speed) assisting a user in making a decision. FIG. 63 shows an example of GUI displaying various LLM options for a user to initial a workflow. Relevant information associated with each LLM may be displayed and the plurality of LLMs may be compared with respect to effectiveness, cost, and speed so the user can make a decision. As illustrated in the example, prior to using an LLM to initiate a data driven workflow, the GUI allows users to compare LLM results across all the user's available LLMs (e.g., snowflake, ChatGPT, Gemini, Copilot, etc.). The platform may automatically connect to various LLM providers and extract the relevant information for each LLM thereby allowing the user to evaluate the effectiveness, cost, and speed of all the LLM options. This beneficially allows a user to view all the information that is needed and view a comparison result to choose the right LLM for the task in the workflow (e.g., business process). As shown in FIG. 63, relative cost, response time, and published token limit are extracted from the connected LLM providers and displayed in the GUI. The platform may automatically generate a comparison result, justification and explanation for each LLM to guide the user selection. For instance, the comparison result may be extracted from customer's review of the LLM and the customer experience that is relevant to the user's workflow or task may be displayed on the GUI.

### AI-Generated Workflow

In some embodiments, a workflow may be generated by an AI model. For instance, in the AI-based Application discovery feature, if the LLM cannot map the customer's data to a predefined application, the system may use AI to generate a business workflow. The AI workflow module herein may comprise a trained model taking as input a description of a business process (e.g., provided by a customer via a GUI for creating a business process), and outputting a workflow.

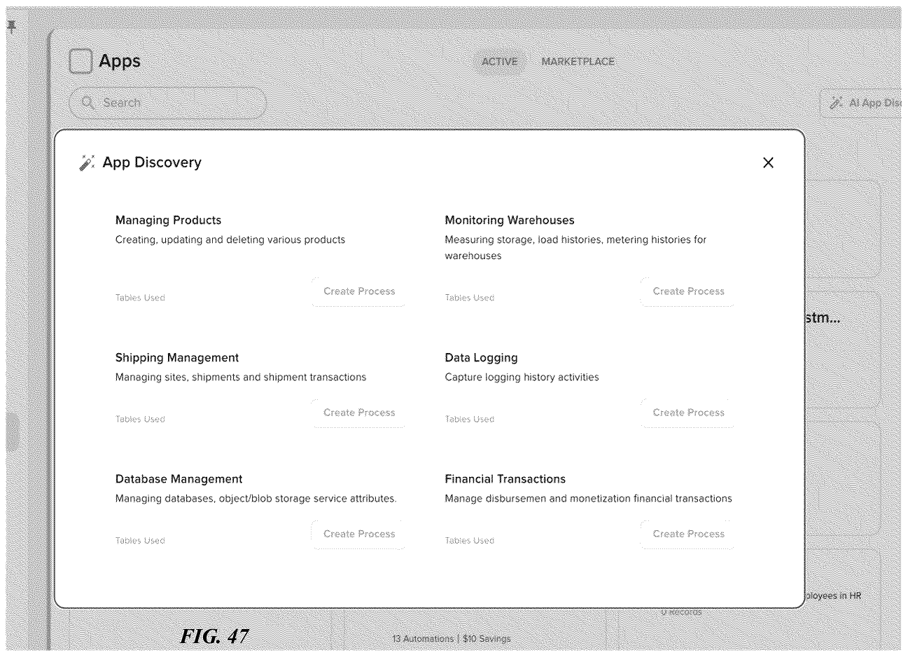

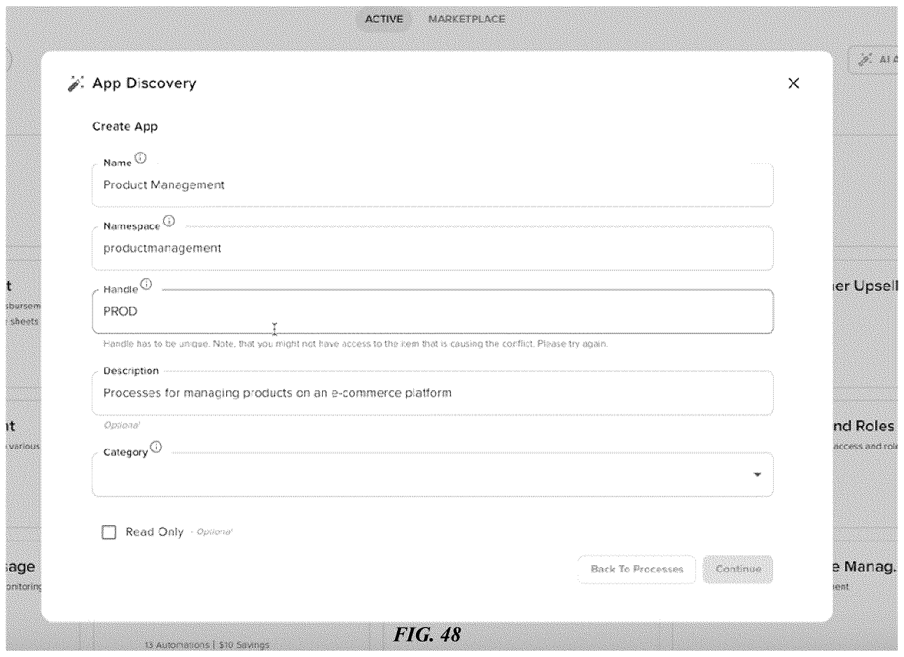

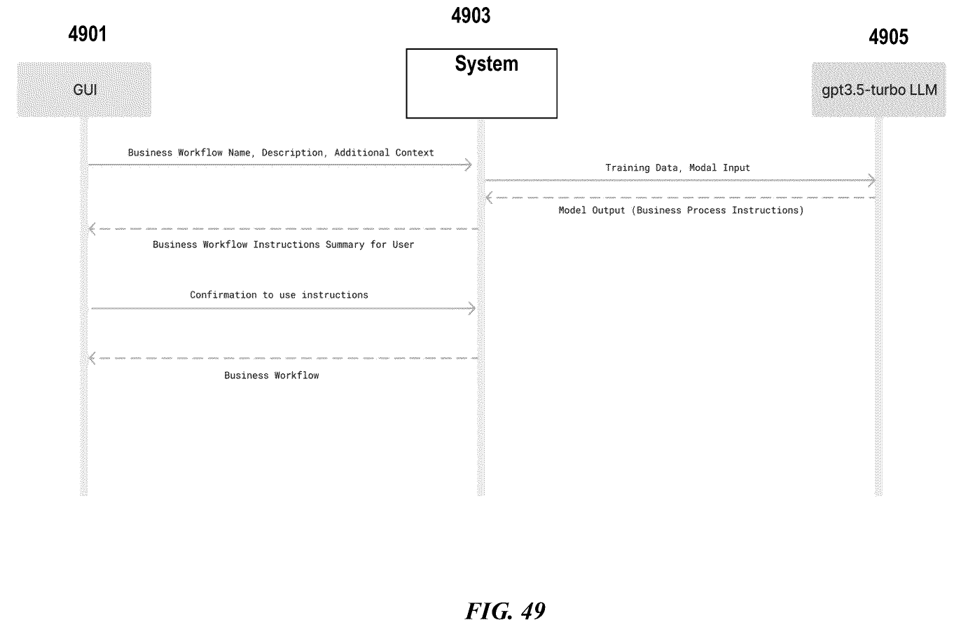

FIG. 49 schematically shows an example of AI-generated workflow feature, in accordance with some embodiments of the present disclosure. The system 4903 may receive input from the GUI 4901 such as business workflow name, description, or other input information. The system 4903 can be the same as the data-driven workflow platform or service management cloud system as described elsewhere herein.

The system 4903 may train an LLM to create a workflow. In some cases, the LLM may be trained by: i) instructing, by the system, the LLM to assume its purpose to create a business workflow, ii) instructing the LLM to break down the business process into one or more stages, iii) instructing the LLM to create one or more steps for each stage in the process, and iv) requesting the LLM to identify data that is relevant in tracking each step of the business process.

After the LLM is trained 4905, the system 4903 may supply the LLM with the name of the business process, a description of the process, and any additional context from the user (received via the GUI 4901) on how they would like their business process defined.

The LLM may be trained to output business workflow data. In some cases, the output of the LLM may include a list of instructions the system 4903 uses to create the business workflows on behalf of the customer.

The AI-generated workflow feature may be capable of automatically generating a business process for a user/customer. For example, the system may i) receive an instruction to create a new business workflow, ii) break business process down into named stages, iii) create named steps for reach stage, and iv) for each step, create data fields that are required to track the business process return only a json object. Following is an example of format:
stages:
name: stage name
steps:
description: step description
dataFields:
name: Field Name
fieldType: Only pick one of the following field types: BOOLEAN| TEXT| NUMBER| DECIMAL| DATE| DATETIME

The input to the trained LLM may be based on user input. For example, the user input may comprise business process name: <HR Onboarding>, business process description: <Runs the process of onboarding employees>, additional business process context: <Make sure to include tracking of social security number, birthday, and T-Shirt size so we can send them swag when they join the company>.

As described above, the output of the model may comprise instructions for the system to create a business workflow. Following is an example of the workflow:

“data”: {“aiFlowInstructionsCompletionExecute”: { “stages”: [

{“name”: “Pre-Onboarding”,
“steps”: [{“description”: “Receive new employee information”,
“dataFields”: [{“name”: “First Name”,
“fieldType”: “TEXT”},{“name”: “Last Name”,
“fieldType”: “TEXT”},
{“name”: “Email”,“fieldType”: “TEXT”},
{“name”: “Phone Number”,“fieldType”: “TEXT”},
{“name”: “Address”,“fieldType”: “TEXT”},
{“name”: “Social Security Number”, “fieldType”: “TEXT”},
{“name”: “Birthday”,“fieldType”: “DATE”},
{“name”: “T-Shirt Size”,“fieldType”: “TEXT”}]}]},
{“name”: “Onboarding”,“ steps”: [{“description”: “Send

welcome email to new employee”,

“dataFields”: [{“name”: “Email Sent”,“fieldType”:

“BOOLEAN”}]},{“description”: “Schedule orientation meeting”,“dataFields”: [{“name”: “Meeting
Scheduled”,“fieldType”: “BOOLEAN”},

{“name”: “Meeting Date”,“fieldType”:

“DATETIME”}]},{“description”: “Assign company equipment”,“dataFields”: [{“name”:
“Equipment Assigned”,“fieldType”: “BOOLEAN”},{“name”: “Equipment Type”,“fieldType”:
“TEXT”},

{name”: “Equipment Serial Number”,“fieldType”:

“TEXT”}]},{“description”: “Complete paperwork”,“dataFields”: [{“name”: “Paperwork
Completed”,“fieldType”: “BOOLEAN”},

{name”: “Paperwork Type”,“fieldType”: “TEXT.”}]}]}]}}

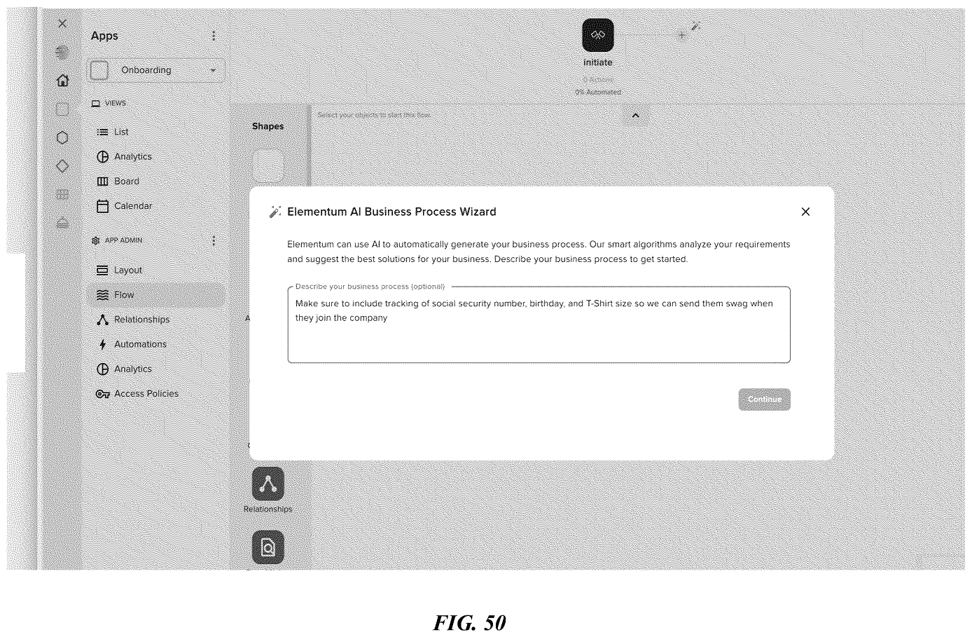

FIGS. 50-53 show examples of GUI of the AI-generated workflow feature. FIG. 50 shows examples of input provided via the GUI. As illustrated in the example, a user may provide a description of the business process to start the business process generation. As shown in FIG. 51, the system may automatically gather data associated with the user and the business process such as by the AI-based application discovery feature described above. As shown in FIG. 52, the LLM may output one or more stages e.g., initiate, pre-onboarding and onboarding for the business process. The LLM may output one or more steps or actions for each stage as illustrated in FIG. 53. The GUI may display the graphical elements representing the one or more stages and one or more steps for each stage upon executing the list of instructions outputted by the LLM.

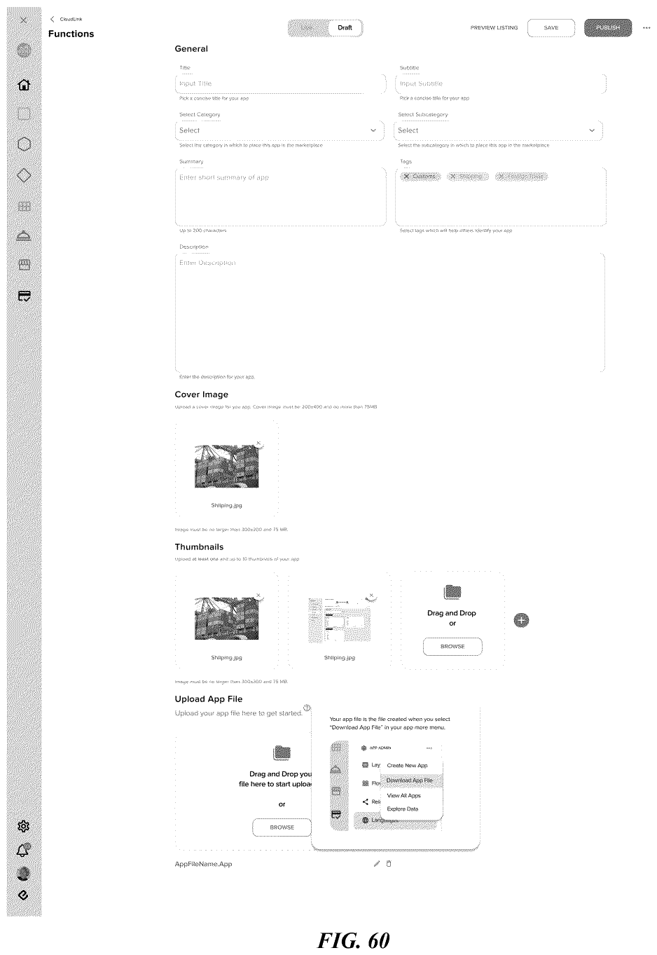

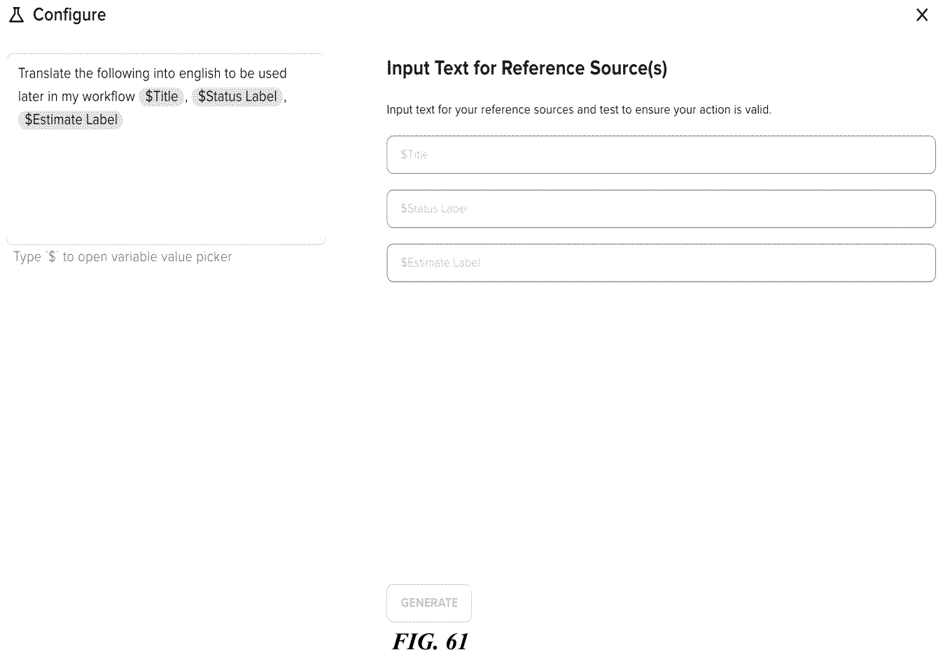

FIG. 61 shows an example of GUI allowing users to interact with the LLMs by creating custom questions (e.g., using the $ operator to reference their cloud data and process data). The results of the LLM can be used to create and update the cloud data or control the flow of an automation.

In some embodiments, the platform herein may send surveys to collect data as part of a workflow. For instance, at predetermined stages in the workflow, the platform allows a user to specify the due date, expiration date, instructions, supporting files, and recipients for the survey. Workflow builders may use survey completion events to automatically process survey results using Automations and can respond to individual surveys being completed or entire survey batches being completed or expiring. Users can get access to the survey data as part of their workflow, including question analytics and statuses for each of the survey recipients.

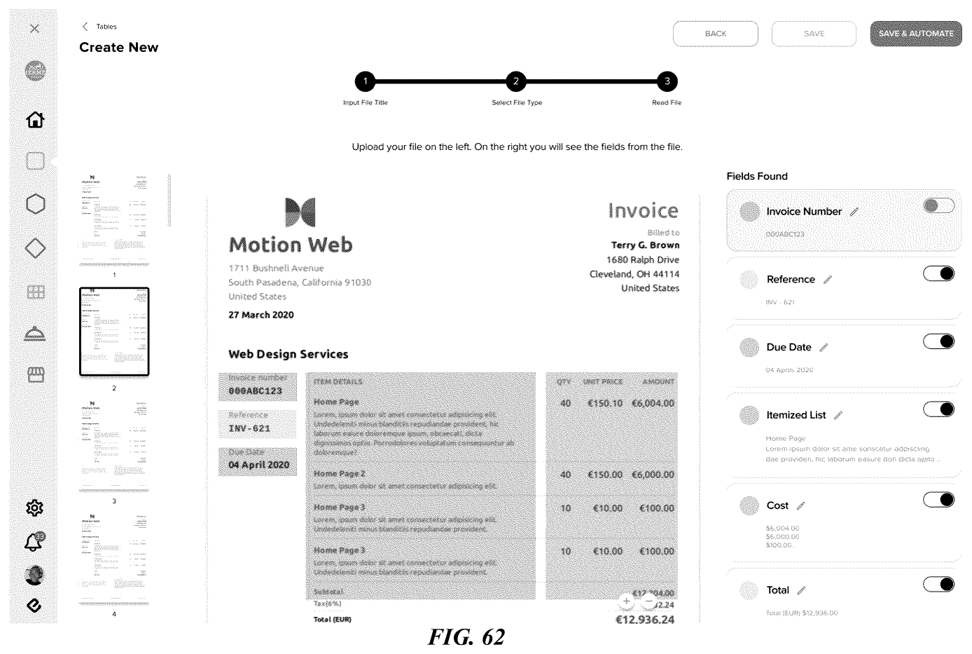

In some embodiments, the AI-generated workflow feature may further comprise an AI algorithm for document ingestion that is used for data driven workflows. FIG. 62 shows an example of GUI for document ingestion. The platform may provide AI Form Processor models to inject documents such as PDFs, Images, Excel and CSV documents to create a file reader that can be used in Automation (e.g., to be used for setting up a triggering event). The file reader may be trained by a user. After the file reader is trained, one or more fields found by the AI-based file reader may be used in automations to trigger various actions such as creating and updating data in the connected data cloud, processing control flow in the automation, or sending external notifications through email or API integrations.

In some embodiments, the various functions and visual features may be provided virtually without the need to install, configure or manage any software. The data-driven workflow platform system may be implemented on a cloud platform system (e.g., including a server or serverless) that is in communication with one or more user systems/devices via a network. The cloud platform system may be configured to provide the aforementioned functionalities to the users via one or more user interface or graphical user interfaces (GUIs), which may include, without limitation, web-based GUIs, client-side GUIs, or any other GUI as described above. For example, a user may access the various features or functions via a web-based-GUIs or within a web browser. In some cases, the graphical user interface (GUI) or user interface may be provided on a display. The display may or may not be a touchscreen. The display may be a light-emitting diode (LED) screen, organic light-emitting diode (OLED) screen, liquid crystal display (LCD) screen, plasma screen, or any other type of screen. The display may be configured to show a user interface (UI) or a graphical user interface (GUI) rendered through an application (e.g., via an application programming interface (API) executed on the user device or the user system, or on the cloud).

### AI-Driven Workflow Platform

In some embodiments, the platform herein may be an AI-driven workflow platform that allows users to leverage any AI agents, AI model, machine learning (ML) model or large language model (LLM) to extract insights and drive workflows without moving or duplicating data. An artificial intelligence (AI) agent can interact with its environment, collect data, and use the data to perform self-determined tasks to meet predetermined goals. An AI agent may comprise memory (“states”) and context management. AI agent's “state” refers to its current internal representation of the environment, including relevant information about its current situation, goals, and past interactions, essentially acting as the agent's “memory” that allows it to make informed decisions based on context. The state is typically stored in a structured format within the agent's memory system, which can include different levels such as short-term and long-term memory. Short-term memory stores temporary information needed for immediate decision-making, such as the last few user inputs in a conversation while long-term memory stores information that needs to be retained for a longer period, such as general knowledge or learned patterns. For example, AI agents may use “context window to store a limited amount of recent conversation history, acting as a form of short-term memory. As used herein, the term “AI agent” refers to a computational or software-based entity configured to perform goal-directed operations using artificial intelligence techniques. An AI agent may receive and interpret input data, apply reasoning or machine learning models to infer context or intent, and generate corresponding outputs or actions to achieve defined objectives. The agent may operate autonomously or semi-autonomously, maintain contextual state in the agent memory, and interact with users, other agents, or external systems.

Unlike traditional AI-driven workflow that requires AI agents to access and store state/memory in an external system for completing tasks, the architecture herein allows for implementing AI agent in automating workflow in a cloud execution without moving data outside of the cloud or persisting customer data externally. The present disclosure may provide an architecture and implementation of running an AI-driven agent on the platform that is operating on data objects stored on a customer's cloud data warehouse or storage without requiring data movement from the customer's cloud data warehouse or storage. The system and platform herein beneficially allows for real-time processing, decision-making, and workflow automation while maintaining data residency within the customer's environment. In particular, the architecture allows AI-driven automation in cloud execution without transferring or externally persisting customer data, thereby improving system-level security, latency, and compliance. The architecture introduces a compute-in-place execution framework that allows AI agents to execute natively within the customer's data warehouse or storage system. This improves the functioning of the underlying computing system by reducing I/O overhead from data movement, eliminating redundant data pipelines, and ensuring low-latency access to in-memory context. The platform and system herein provide runtime configuration for executing AI-driven workflows operating on cloud data stored in customer data storage, performing localized inference, context preservation, and state consistency across distributed cloud nodes.

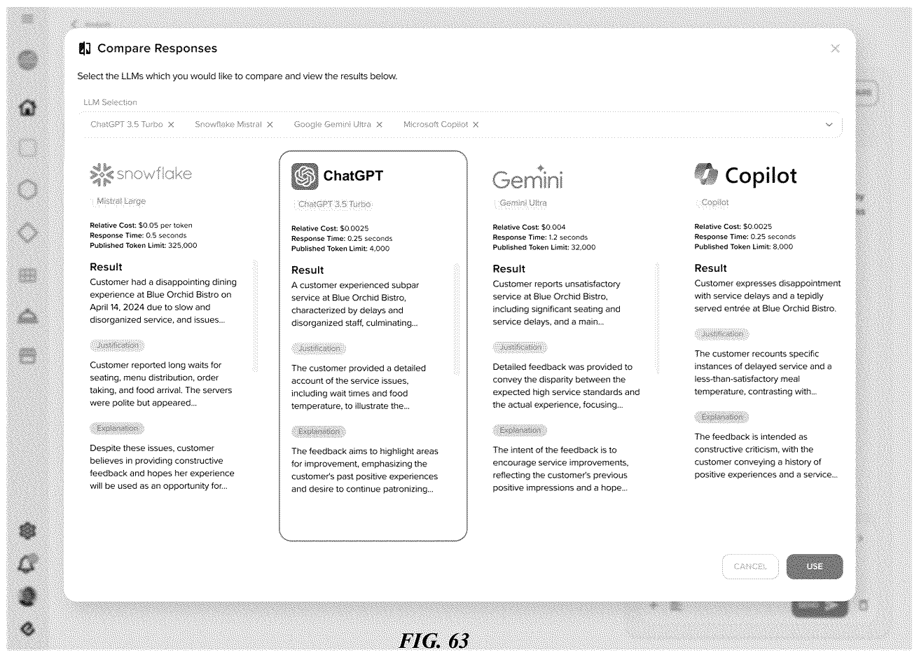

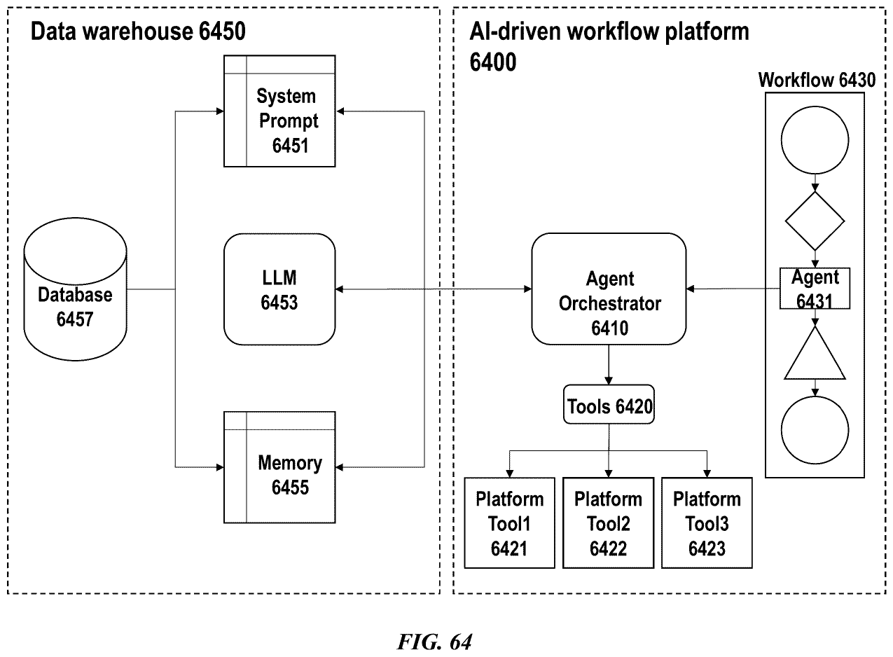

FIG. 64 shows an example of the platform 6400 that provides an architecture for implementing AI agents 6431 in a workflow 6430 without moving the cloud data from cloud services providers 6450. Unlike traditional systems that rely on centralized processing or external memory stores, the present platform implements a distributed execution topology where workflows 6430 are dynamically composed through a no-code interface and execute across multiple tenant-specific environments 6450. An AI agent 6431 may be orchestrated according to the workflow 6430 and the underlying corresponding AI agent 6453 (LLM agent) may be executed in a cloud configuration (with controlled permission to access) with access to contextually partitioned data streams, preventing cross-tenant data exposure. The AI agent 6453 may be called by the platform herein according to the AI agent 6431 in the workflow 6430 but the AI agent 6453 may be provided by the data warehouse 6450 or other external entities rather than the platform. This configuration beneficially allows for parallel execution, fine-grained context caching, and low-latency task handoff among workflow stages thereby improving the speed and reliability of workflow execution at the system level. In some cases, upon execution of the workflow, the AI agent LLM 6453 may be running in the customer environment or data warehouse 6450 and may be executed such as via API call to the customer environment or data warehouse 6450.

The workflow 6430 may be created utilizing the GUIs as described above. For instance, the workflow may be a configurable and automated data-driven workflows created via no-code applications. The workflow may comprise one or more stages each including one or more actions as described above. The workflow or the one or more stages may comprise AI agent for performing automated actions. A percentage of the workflow or the one or more stages may be automated by AI agent 6431 (e.g., 0, 10%, 20%, 30%, 40%, 50%, 60%, 70%, 80%, 90%, 100% or any number in between). In the illustrated example, a user may create the workflow by dragging and dropping an AI agent component 6431 to the workflow. the AI agent component may be added to the workflow and configured via the workflow user interface as described elsewhere herein. The agent may or may not be an LLM agent. In some cases, upon execution of the workflow, the LLM agent 6453 may be running in the customer environment or data warehouse 6450 and may be executed such as via API call to the customer environment or data warehouse 6450.

As shown in the example, the architecture may comprise an Agent orchestrator 6410 for managing the execution of the agent. The Agent orchestrator 6410 may run on the data-driven or AI-driven workflow platform 6400 that coordinates the AI agent workflows 6431 by dynamically generating structured prompts to the AI agent 6431. The Agent orchestrator 6410 may coordinate the actions of one or more independent AI agents, each with specialized tasks or functions. The Agent orchestrator 6410 may integrate the AI agents with other models, tools (tools 6420) and data sources (e.g., customer cloud data 6457, memory 6455) to automate and manage the workflows. The Agent Orchestrator 6410 operates as an execution controller that improves the coordination and efficiency of multi-agent processing within distributed computing environments. Rather than performing generic task scheduling, the orchestrator dynamically generates structured prompt objects that encapsulate task context, dependencies, and execution constraints. This architecture beneficially improves computer functionality by allowing for deterministic orchestration, and context persistence across concurrent threads or containers, without requiring an external memory store.

The Agent orchestrator 6410 may be implemented by rule-based model that may manage agents following pre-defined rules that beneficially provides predictable and transparent decision-making process. Alternatively, the Agent orchestrator 6410 may be implemented by deep learning models (e.g., LLM) that may leverage deep learning for flexible, context-aware responses and workflow management. In some cases, the Agent Orchestrator 6410 may be a hybrid rule-based and neural orchestration engine that runs as part of the workflow control plane. The Agent orchestrator may be implemented by any suitable models or algorithms that serves as an execution layer to generate inputs (e.g., structured prompt) for the agents 6431 or inputs for executing other components (e.g., tools 6420). In some cases, the agent orchestrator may be configured for dynamically generating structured prompts based on workflow context, customer data access policies, and/or execution parameters (e.g., confidence threshold, risk tolerance, priority level, time constraints, etc.).

In some cases, the input to the agent orchestrator 6410 for managing execution of agents may comprise a workflow state such as tasks status, user directives, system variables, customer-defined policies on data access and processing, and relevant metadata (e.g., corrective action, task outcomes) and context data. The agent orchestrator 6410 may then process the input and generate an output comprising structure prompts for a specific agent (e.g., LLM), a toolset execution parameter, and/or execution logs for monitoring and debugging. In some cases, the agent orchestrator may perform data transformation that converts unstructured operational context into a standardized, machine-readable control format suitable for low-latency AI execution.

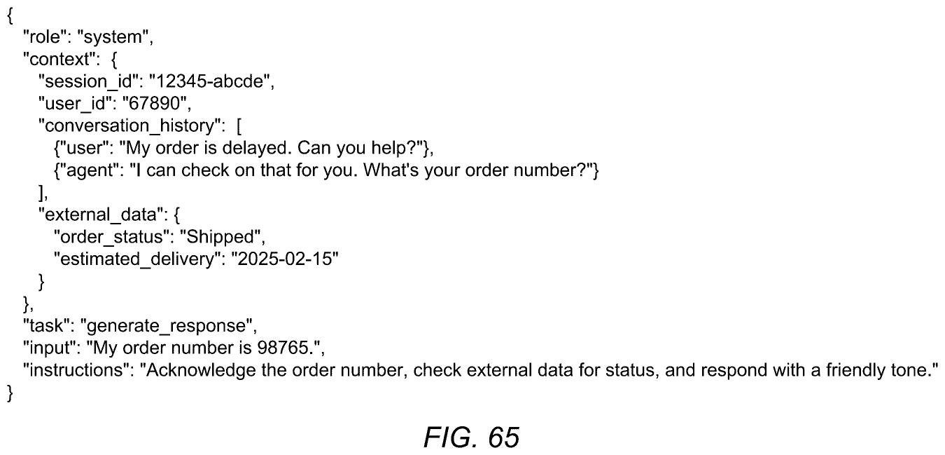

The structured prompt generated by the agent orchestrator may be received by an LLM or agent 6453. The LLM agent may be provided by the customer's data warehouse 6450 (e.g., Snowflake Cortex, Azure OpenAI, or Google Vertex AI, etc.) or integrated externally based on enterprise infrastructure. The system may employ runtime API gateways and secure credential tokens to manage access and authentication at the kernel or container level. In some cases, the structured prompt may be formatted for an LLM, or a given agent, with task-specific context and constraints. In some cases, the agent orchestrator may inject context data such as prior support history, sentiment analysis, and recent product updates, then refine the prompt to ensure the agent's response is informed and relevant, and align the interaction with past engagements to maintain continuity. FIG. 65 shows an example of a structured prompt. As shown in the example, the structured prompt may comprise context (e.g., session_id, user_id, conversation_history, external_data), task, and other constraints (e.g., instructions on the tone, template, format, etc.).

Referring back to FIG. 64, the Agent orchestrator 6410 may interface with customer's data warehouse 6450 such as via storage APIs to retrieve at least portion of the input data for generating the structured prompt. For example, the Agent orchestrator 6410 retrieves workflow state, agent memory 6455 (e.g., conversation data), and metadata (e.g., corrective action, task outcomes) inside of the customer's data cloud 6450. The Agent orchestrator 6410 may also store the generated prompt (e.g., system prompt 6451) to the customer data warehouse 6450.

The Agent orchestrator 6410 directs tasks to the LLM 6453 executed on the customer data environment 6450 such that the AI agent operates without leaving the customer data environment. The Agent orchestrator 6410 may further generate toolset execution parameters for the platform toolset 6420 to perform workflow actions (e.g., updating records, triggering notifications, etc.). The toolset may comprise one or more platform tools 6421, 6422, 6423 and the agent orchestrator 6410 generates the toolset execution parameters (e.g., tool selection, triggering event, condition, etc.) integrating the tools with the agent 6431. The platform 6400 may provide a suite of workflow automation and execution tools 6420 that interact with both structured and unstructured data while keeping all processing within the customer's data cloud. Examples of the platform tools 6421, 6422, 6423 may include, but not limited to, workflow automation tools for creating, updating, and managing workflow records, communication tools for sending emails, generating messages, triggering notifications, making a phone call, data retrieval tools for querying structured data, searching knowledge bases, and summarizing insights, integration APIs for connecting with enterprise systems (e.g., ERP, CRM) for real-time updates, and decision support tools for AI-assisted recommendations based on contextual analysis and the like.

The toolset 6420 interacts with local and external APIs while persisting data within the customer's data cloud 6450. For example, a platform tool 1 6421 may comprise an action/function for triggering notifications and the action may be created via the platform as described above without moving customer data from the data warehouse 6450. A platform tool 6421-6423 may interact with internal and external APIs using policy-enforced execution contexts, ensuring compliance and isolation.

The LLM agent 6453 may receive the structure prompt from the Agent orchestrator to perform the tasks. The agent processing occurs within an isolated execution environment (e.g., customer environment 6450) that directly queries customer storage (e.g., database 6457) for execution. The architecture supports multiple concurrent agent executions within the customer's environment. For example, multiple LLM agents may be managed and coordinated by the Agent orchestrator and the multiple LLM agents may or may not be in the same workflow. Multiple concurrent LLM agents 6453 may execute within parallelized containers, with orchestration handled by an asynchronous event bus.

The architecture may comprise memory and context management component 6455. The memory and context management component may be located at the data warehouse or cloud configuration 6450 such that the workflow state (e.g., all data regarding a workflow, agent memory such as conversation history, metadata) can be stored and retrieved without persisting the customer data externally (external to the data warehouse 6450). The memory and context management component 6455 provides an in-warehouse caching layer that allows iterative decision-making without external data persistence. For example, the memory 6455 allows the agent 6431 to refine its actions dynamically based on new data or changing conditions within the workflow, while access new data from the customer's data cloud 6457. This beneficially allows the agent 6431 to continuously adjust its actions and choices based on new information or changing circumstances within a workflow, by actively pulling in fresh data from a customer's data cloud 6457, essentially allowing it to adapt and optimize its behavior in real-time as the situation evolves. As an example of a supply chain AI agent tasked to review order delays, the agent may first suggest adjusting inventory distribution based on past trends, and if the issue persists, the agent fetches additional supplier reports from data in the customer's own data cloud 6450 and recommends alternate vendors. The decision loop continues until a resolution is reached. During the iteration process, external data extraction is not required since all processing happens within the customer's data cloud 6450. By maintaining temporal and contextual data locally, the architecture eliminates dependency on external vector databases or message queues. This beneficially provides improved I/O efficiency, state retention accuracy, and deterministic reasoning across sequential agent calls.

The architecture may comprise a system prompts component 6451 that is located within the customer data warehouse 6450. The system prompts component 6451 may guide agent interactions while keeping data within the customer's storage environment 6450 to enhance security. The system prompts component 6451 may comprise adaptive prompts that are adjusted dynamically based on workflow progression and historical context. The system prompts component 6451 may comprise adaptive prompt generated by an adaptive prompt refinement method which beneficially ensures context-aware responses, improving accuracy and effectiveness. As described above, the system prompts component 6451 may be in communication with the Agent orchestrator 6410 and the Agent orchestrator 6410 perform adaptive prompt refinement by dynamically adjusting prompts based on the workflow variables or execution parameters (e.g., priority level, urgency), context data (e.g., conversation history, or past agent executions etc.), and/or business logic (e.g., compliance rules). As an example, when an agent is tasked with responding to a customer inquiry, the Agent orchestrator may inject context data such as prior support history, sentiment analysis, and recent product updates, then refine the prompt to ensure the agent's response is informed and relevant, and align the interaction with past engagements to maintain continuity.

The architecture may further comprise a data residency and compliance framework that ensures the agent processing occurs within customer-specified data boundaries. For instance, data residency may be ensured through strict architectural design where AI agents do not have capabilities to persist data outside of the customer's data cloud. The framework may provide logging and monitoring features allowing audit trails to validate compliance with industry standards. The framework may ensure the workflow complies with industry regulations (e.g., GDPR, SOC 2, HIPAA) by restricting data movement.

As described above, architecture of the platform may allow it to use APIs to interface with customer data warehouses 6450 (e.g., Snowflake, AWS, Azure, etc.) without extracting raw data. The platform may comply with the security and access controls of customer data warehousing platforms (e.g., credentials and authority for access and utilization), leveraging the users' authentication methods (e.g., OAuth, API keys) to ensure controlled and compliant access. The platform beneficially supports various workflow automation tools (platform tools or other internal or external tools) and enterprise applications via APIs and webhooks.

### Examples of AI-Driven Workflows

The AI-driven workflow platform as described above may provide various applications such as automated data analysis without exposing sensitive data, agent-driven workflow automation within enterprise environments, and compliance-sensitive agent decision-making (e.g., financial audits, healthcare data processing).

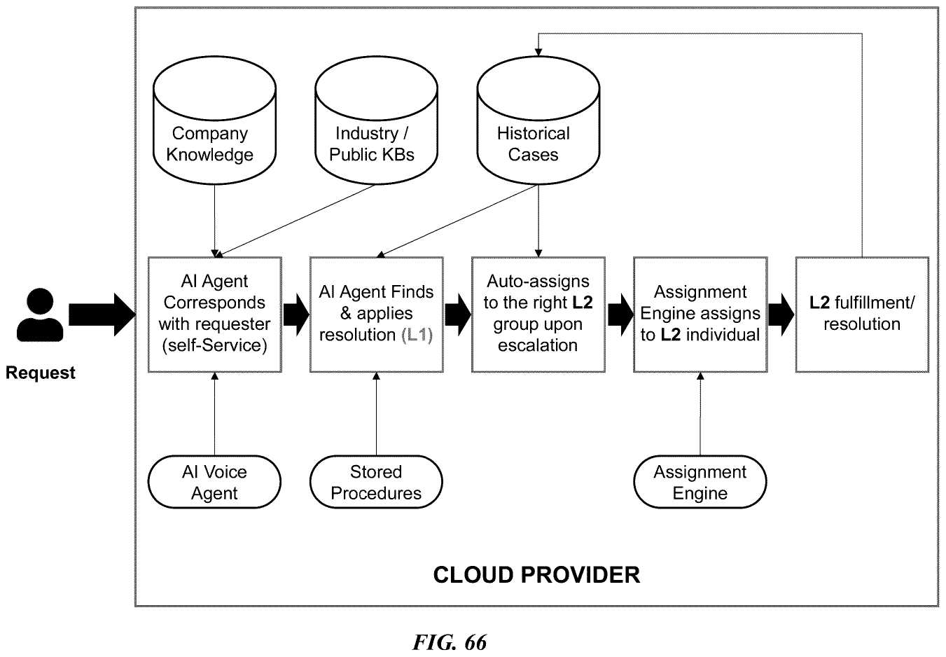

FIG. 66 illustrates an example of handoffs and data sources. In the example, a user/requestor may ask for help with an error message, ordering hardware and software, or help that requires specialized skill set. The Level 1 (L1) support may research historical cases to determine if there is knowledge available, if this is a known error, if a change has been made recently, how it was resolved in the past. The workflow may automate Level 1 Support with AI (e.g., LLM models) to determine the right Level 2 team and use workflows to quickly assign. The AI agent may provide human-in-the-loop in a workflow. For instance, the AI agent may comprise Agent-to-human communication tools such as phone, email, SMS, or video call. AI Agents may be able to reach out to human workflow resources to accomplish a task such as to get approval, verify a decision, accomplish tasks by receiving a high-level instruction and automatically determining detailed actions and logics to complete the task. The AI agent may be capable of communicating or interacting directly with a human as part of a workflow such as the “L1 support” or other tasks such as making a call to get the status of an invoice. In some cases, the Agent may be provided with user credentials to access an application (e.g., SaaS platform), automatically performing actions such as opening its own browser, signing in, and accomplishing tasks where such agent operations may be viewable via the GUI provided by the platform herein or through any other existing applications.

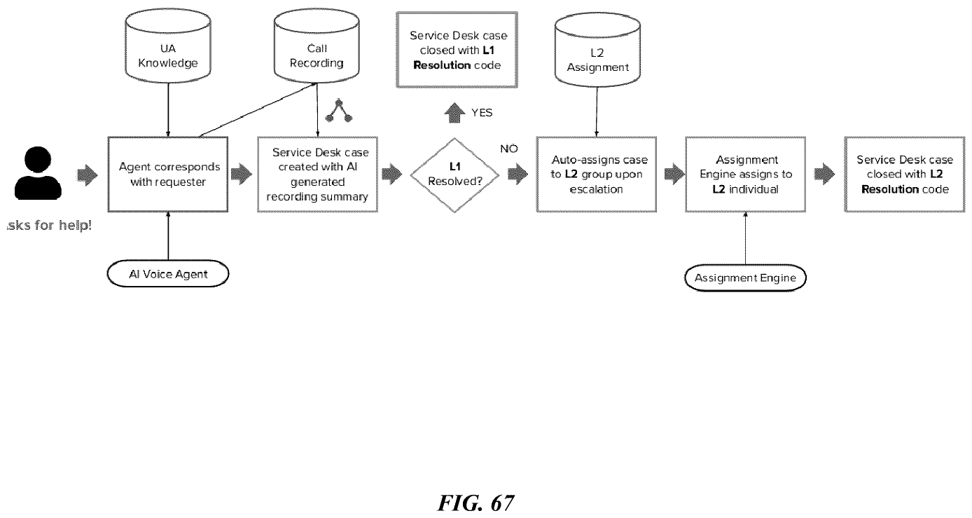

FIG. 67 shows an example of Level 1 agent provided by the platform herein. The workflow may comprise an assignment engine to automate assignment (AI, round robin, distributed workload). The examples illustrate a no-code workflow implemented to quickly adapt and modernize call center processes.

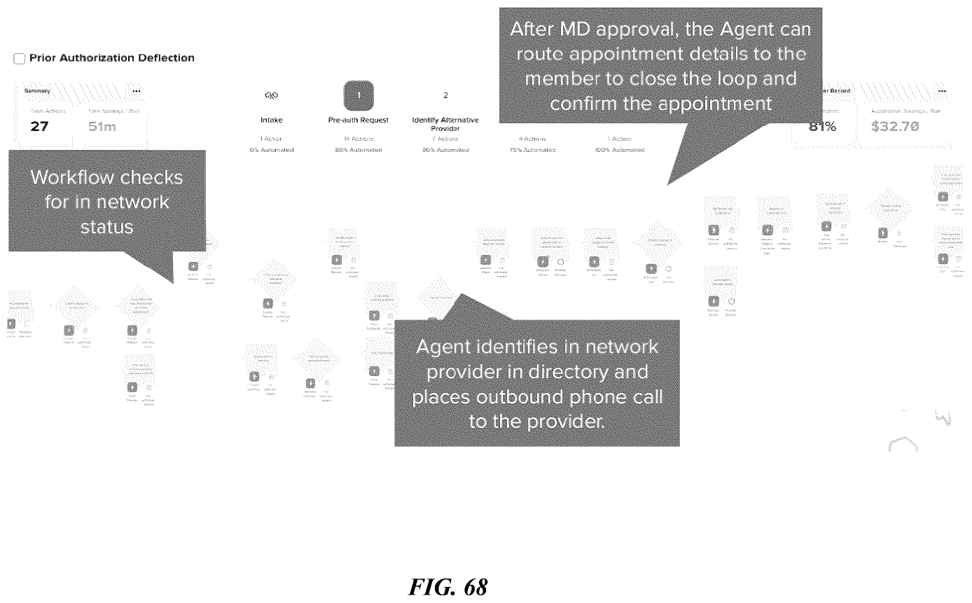

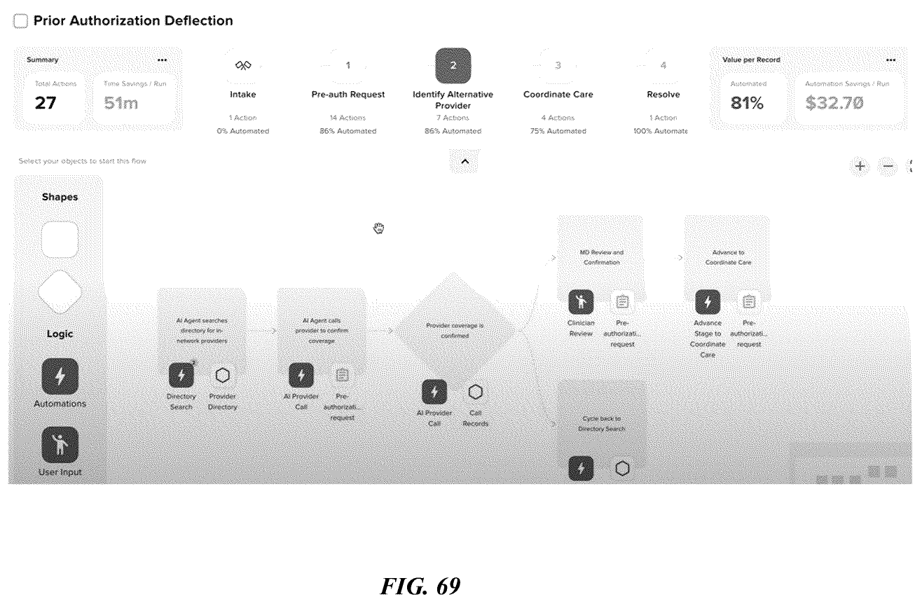

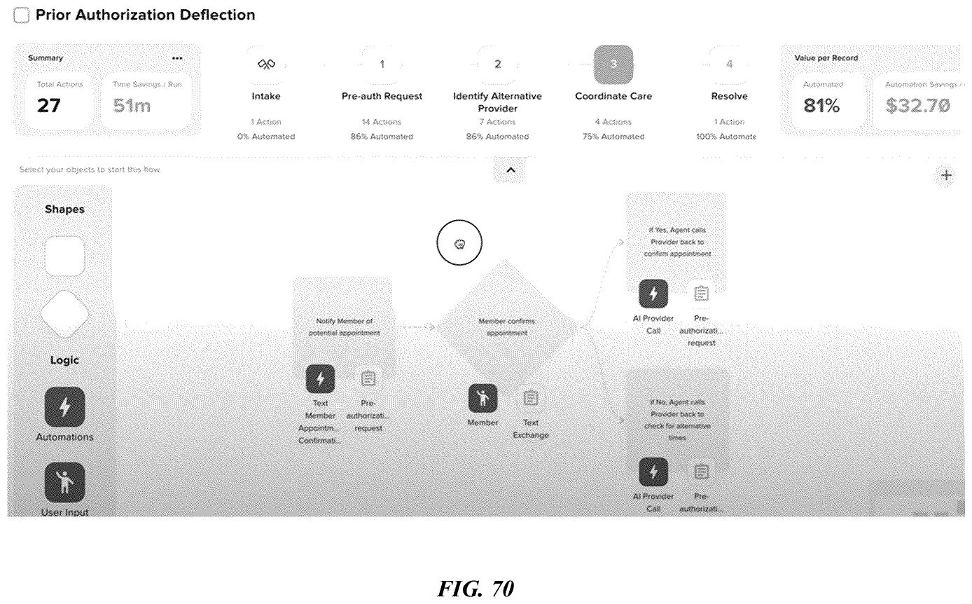

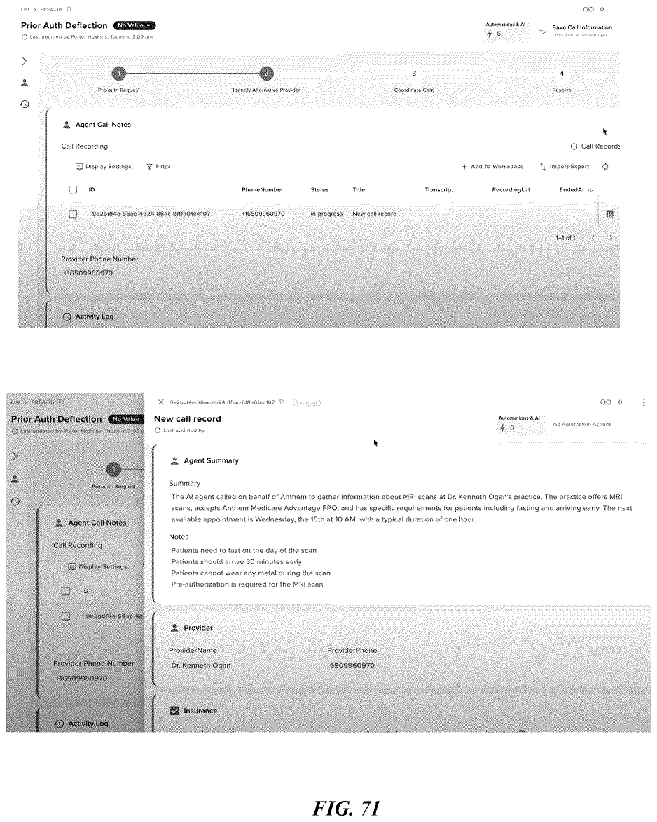

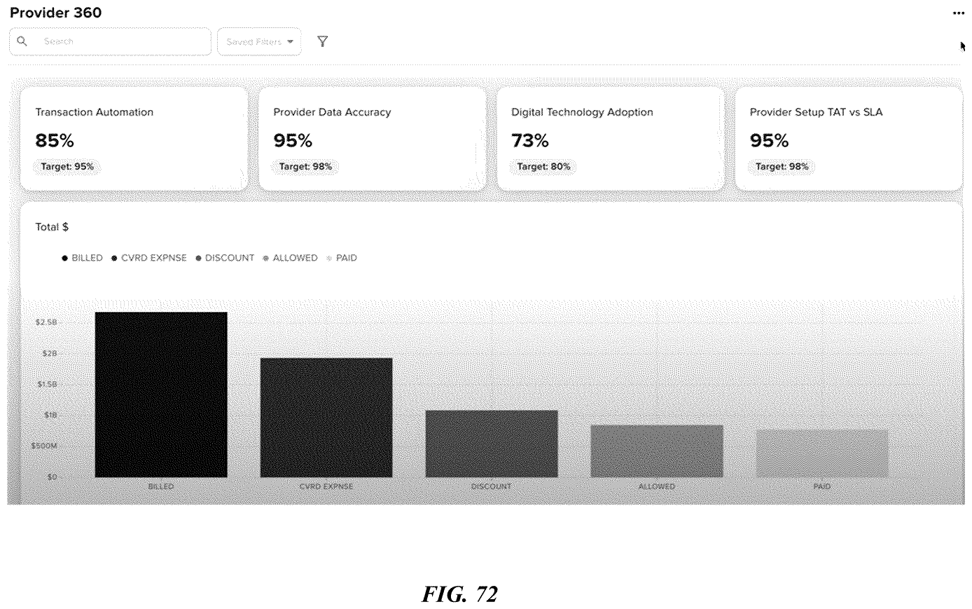

FIGS. 68-71 shows a GUI of AI-driven workflow provided by the platform herein for orchestrating prior-authorization deflection. The process may run in the platform workflow using AI agents. The AI agent in the workflow may manage prior authorization deflections for OON Providers, instead of simply denying the out of network provider, the agent may identify alternative providers and call the alternate provider to confirm ability and availability for the service. As shown in the example of GUI, the percentage of automation and automation savings/run may be displayed. FIG. 72 shows an example of provider management dashboard showing overall provider performance. The dashboard shows provider network that can be filtered on market, or line of business and display the key metrics and inventories. The dashboard information displays data built on top of the customer's data cloud data without moving the cloud data.

In some cases, the GUI (e.g., management dashboard or workflow GUI) may provide information that can be used for updating or continuously training a model after deployment of the AI agent model. In some cases, the GUI may display a number of interventions per workflow run. For instance, the platform may allow admins and process managers to intervene a workflow process by reporting and correcting the AI agent's action and such intervention may be tracked and saved by the platform (e.g., an intervention record may comprise the AI agent generated result/action and a human intervention, timestamp, tools, model, etc.). The intervention metric may be displayed on the GUI to the provider or process owner. In some cases, the process owner (e.g., user who owned/developed the workflow or owned the cloud data) may be provided with functions via the GUI to update the AI agent with the tracked interventions. For example, the tracked interventions may be presented as potential training data to correct or update an AI agent model. The user may be prompted to select from the tracked interventions, accept or reject selected interventions, and provide input/instruction to use the interventions to correct or update the AI agent model.

Alternatively or additionally, the platform may automatically identify, based on the tracked/reported interventions, whether an AI agent needs to be updated or corrected using the interventions. The platform may generate recommendations or suggest updates to agent training for a user to approve or reject, and/or may automatically train the AI agent to immediately improve processes such as based on the number of repeated interventions exceeding a predetermined threshold or other rules. In some cases, the platform may pass the interventions data to the cloud database or the AI agent provider without specifying how the interventions data should be based. In some cases, the platform may pass the interventions data to the cloud database or AI agent provider with recommendations depending on the training algorithm (e.g., using the intervention data to correct the AI model, update the policy or reward function in reinforcement learning and the like). In some cases, the platform may pass the intervention data as input to a reasoning LLM/agent and generate updated recommendation to the training prompts on the Agents involved in the intervention. In some cases, a recommendation from the reasoning LLM may comprise removing or adding training/tools to handle a situation better.

In some embodiments, the platform may provide GUI allowing users to provide Agent guidelines. The Agent guideline GUI may allow users to customize or modify a training of an Agent such as customizing which actions should be human approved and which actions are completed by agent to achieve a goal. As an example, the user or a process owner may be allowed to inject business logic into the agent's training via the GUI where if the agent takes a certain action then the agent needs to take certain following actions. The following actions may comprise, for example, requiring human approval, asking for permission to take an action, asking specific follow up questions to a human, uploading a file that it generated or downloaded, asking for approval or verifying certain regulatory rules are complied with.

### Reducing Hallucination in AI Agents Using Defined Tools in Data-Local Business Workflows

In some embodiments, the platform herein may be capable of reducing agent hallucinations where the AI generates plausible-sounding but incorrect outputs. Traditional mitigation techniques often involve increasing model size, fine-tuning, or post-processing. however, such traditional mitigation methods may not fully solve the problem or lack of the capability to scale securely.

The platform and system may reduce AI agent hallucinations by constraining agent behavior through defined tools. For instance, agents are guided or constrained to call approved tools instead of generating free-form answers. Each agent may operate within a bounded runtime context and is guided to invoke only approved tools via secure, typed interfaces, rather than generating unrestricted free-form text responses. The system may comprise a tool management interface and a runtime enforcement layer that verify tool invocation against metadata constraints before execution. These mechanisms collectively improve the reliability of automated workflows and reduce computational overhead by minimizing erroneous agent executions. The platform may provide user interface allowing users to define and manage a toolset. A toolset may include but not limited to, business logic, permission boundaries, and expected inputs/outputs schemas. The system or platform may allow AI agents to execute tools in-place (against the user's data environment or customer environment), without storing or persisting customer data. The system herein may further comprise observability and traceability features built into the tool invocation chain, allowing audits and debugging of agent reasoning.

The toolset may comprise one or more platform tools as described above and elsewhere herein. In some cases, the toolset may be implemented as callable functions or operations in an AI-driven workflow (e.g., API endpoint or containerized function). For instance, the tools may encapsulate logic or access patterns and are executed directly within the data's native environment (e.g., customer environment), ensuring that no data is persisted or stored outside of the isolated execution environment (e.g., customer environment).

In some embodiments, the system for reducing the AI agent hallucination may comprise a tool registry component. The tool registry component may register and manage a plurality of defined tools. The tools may be defined by a user, an entity, an organization. The tool registry may register a set of callable tools/functions that an AI agent may invoke. In some cases, a tool registry may be a centralized catalog of all available tools within the platform. The tool registry may have a standardized way for tools to be easily discovered and reused by different agents. For instance, the tool registry may comprise entries of tools that are described using consistent terms and formats, making it easier to compare and understand their capabilities. Each tool entry may comprise metadata including constraint for the tool, tool configuration or other information such as purpose, how the tool works, limitations, and the like. The tool registry component may be implemented as a structured metadata database. The registry stores standardized definitions of the available tools, each comprising a unique identifier, version control metadata, execution constraints, and input/output specifications. The registry may provide a discovery API allowing AI agents to query for available tools and their associated permissions. This standardized format allows agents to interoperate across heterogeneous data environments, reducing integration overhead and improving modularity of the AI workflow platform.

In some embodiments, each tool may be associated with one or more built-in constraints that define how the tool can be used. The one or more constraints can be enforced at runtime to control the agent's available actions. The tool and its constraints may be stored in a tool entry as described above. Constraints define allowable operations, input types, data domains, and permissible workflow stages. As an example, a web search tool may be limited to domains such as example.com or .gov. in another example, a data query tool may be constrained to expose only specific columns (e.g., order_id, status) or filtered rows (e.g., last 30 days). Another example may include a workflow interaction tool that is constrained to run in read-only mode or be restricted to certain steps in a workflow. In some cases, the one or more constraints may be defined in the tool configuration data and when the tool is called by an agent, these constraints may limit or define the operations, accessibility or instructions an agent can have when using the tool.

The platform may further comprise an Agent Policy Layer configured for selecting allowable tools at each workflow stage. The policy layer dynamically computes an execution profile based on the agent's task context, current workflow state, and organizational policy graph. In some cases, the system herein may retrieve the tool and its respective constraints at a stage or action of a workflow. The constraints may be different depending on the stage or action in the workflow. In some embodiments, the system for reducing the AI agent hallucination may comprise an Agent Policy Layer that is configured to determine which tools are available to the agent at a given step, a given action, stage or for a given task in a particular workflow. For example, a user may create a workflow comprising an agent to reconcile invoices across ERP and CRM systems. Instead of accessing raw data or crafting logic via LLM completion, the agent selects tools such as fetch_open_invoices( ), get_customer_details( ), and match_payment_records( ) as determined by the Agent Policy Layer. The Agent Policy Layer may generate typed, scoped outputs and the agent may receive only these output from the Agent Policy Layer such that the agent actions and the tools can be executed within the user's data cloud environment without leaving the cloud or moving the cloud data.

In some embodiments, the system may comprise a workflow orchestrator or agent orchestrator. The workflow orchestrator can be the same as the agent orchestrator described above that is configured to generate a structured prompt for the AI agent and one or more parameters for executing one or more tools provided by the AI-driven workflow platform. The structured prompt generated by the workflow orchestrator may further comprise toolset execution parameters for the platform toolset to perform workflow actions. The structured tool invocation in the structured prompt beneficially reduced hallucination.

In some embodiments, the system may comprise guardrails features configured to define how to validate inputs/outputs, enforce types, and/or use fallbacks. The guardrails features of the system may ensure that agent-tool interactions remain safe, predictable, and auditable. In some cases, the guardrails features may comprise an input validation feature that is configured to validate the input of the agent based on the constraints of the tool that is called. For example, a tool that submits a task creation request to a task management system may require a due_date in YYYY-MM-DD format. If the agent tries to pass a natural language date such as “next Thursday,” the tool rejects the input and prompts the agent to reformat. In some cases, the guardrails features may comprise an output validation feature that is configured to validate the output of the agent based on the constraints of the tool that is called. For example, a document summarization tool is configured to return no more than three bullet points. If the underlying LLM returns a paragraph in bullet points or too many bullets, the platform trims or retries until the output conforms to the constraints of the tool.

In some cases, the guardrails features may comprise a type enforcement feature that is configured to enforce strict typing to prevent ambiguous or unprocessable inputs. For example, a financial summary tool has a constraint on a type of input or output such as a numeric amount and a string currency_code, if the agent passes “twenty dollars” as the amount, it fails validation. In some cases, the guardrails features may comprise a fallback feature to handle the scenarios when the aforementioned validations fail. For example, if a data query tool fails (e.g., due to a schema change or permission error), a fallback may be defined to: Retry with adjusted parameters, Route the query to a backup data source, or Trigger a human-in-the-loop review step.

In some embodiments, the system comprises an execution interface that is configured to execute tools against data in-place, without persisting or storing externally. In some cases, the agent outputs are produced solely through structured calls to predefined executable interfaces with typed inputs and outputs.

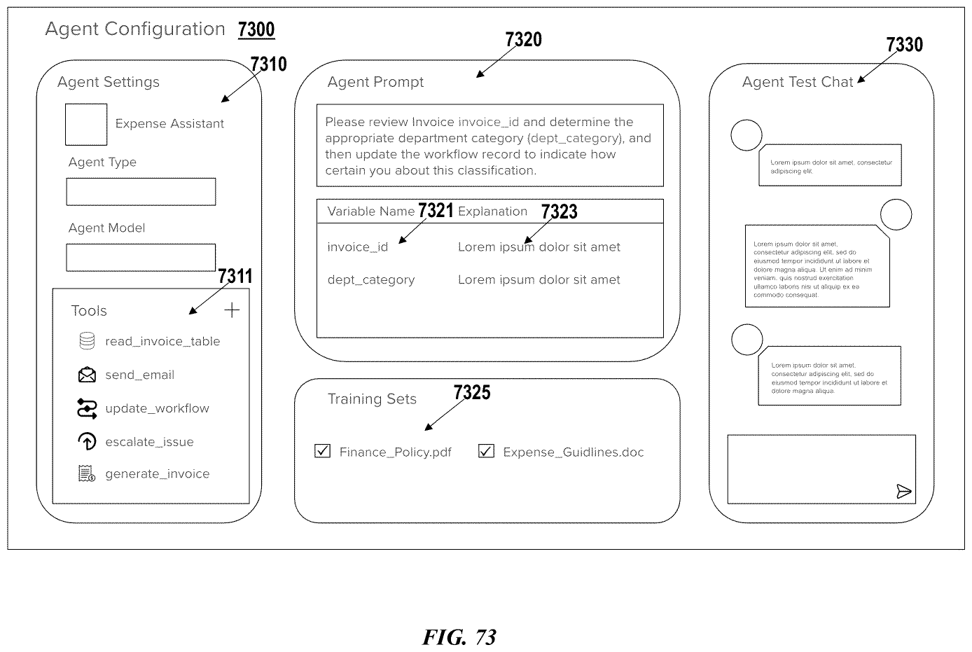

In some embodiments, the system may provide a user interface (UI) allowing users to define and manage the toolset. FIG. 73 shows an example of UI 7300 for defining and managing the toolset and the agent in a workflow. The UI may allow users to define and manage business logic, permission boundaries, expected inputs/outputs of an agent and various other functions.

As shown in the example UI 7300, the UI may display a Tools panel 7311 allowing users to define tools. The Tools panel 7311 may display various features related to the toolset, for example, prebuilt tools available (API, search, etc.), field-level access controls and filters, input/output validation, versioning and audit history and the like. A user may configure the toolset (e.g., set up the tool constraints), configure validation criteria, viewing validation history or versioning and audit history through the UI. This beneficially allows users to expose functionality safely-without over-permissioning or introducing risk.

The UI 7300 may also display an agent setting panel 7310 for users to configure one or more agents. For example, a user may configure an agent type, and/or agent model. In some embodiments, the UI may display an agent prompt panel 7320 allowing users to visualize the structured prompt generated by the system with the key variables 7321 and explanation 7323 in the prompt. The UI may also allow users to view or select the training sets 7325 for training the agent. In some embodiments, the UI 7300 may display an agent test panel 7330 allowing users to view the test result of the agent based on the configuration of the agent and tool thereby viewing the configuration effect in real-time. This beneficially allows users to adjust the agent or tool configuration in real-time based on the test result.

### Context-Constrained AI Agent in Workflow Automation

In another aspect, the present disclosure provides methods and systems comprising AI agents embedded within automated processes, controlled through structured inputs and outputs, with selective contextual field exposure to allow for deterministic, secure, and efficient task execution. As described above, when artificial intelligence is integrated into workflow processes, existing approaches may provide AI agents with unrestricted or broad access to enterprise data and systems. This creates several significant problems. First, overexposure of data occurs when AI agents access more information than required for their specific task, creating security, compliance, and governance risks. Organizations may inadvertently expose sensitive customer data, proprietary information, or regulated content to AI systems that only need limited contextual information to perform their designated function. Additionally, non-deterministic execution becomes problematic when agents operate without structural controls, potentially producing inconsistent or non-repeatable results across similar workflow instances. This unpredictability undermines the reliability that organizations expect from automated processes and makes it difficult to ensure consistent outcomes for business-critical operations. Further, complex integration challenges arise as embedding AI in workflows typically requires ad hoc engineering solutions, making it difficult to ensure reproducibility, governance, and scalability across different workflow types and organizational contexts. Each integration may require custom development, leading to maintenance overhead and inconsistent implementation patterns. Existing approaches often lack proper audit trails and compliance mechanisms, making it challenging for organizations to track AI decision-making processes, validate outputs, or demonstrate regulatory compliance. The absence of structured input-output contracts between workflow systems and AI agents further complicates integration efforts and reduces the ability to validate and govern AI behavior within automated processes.

There is a need for a structured approach that integrates AI agents into workflows with deterministic boundaries, scoped context exposure, and predictable interactions while maintaining the flexibility and reasoning capabilities that make AI valuable for complex workflow tasks.

The present disclosure provides systems and methods for embedding an artificial intelligence agent as an intermediate step within an automated workflow. In some embodiments, the agent operates only on structured inputs, with access to contextual data with predetermined scope such as by being limited to referential fields explicitly passed in from the automation, and its outputs being validated before continuing with the workflow execution.

In some embodiments, the method for embedding an artificial intelligence agent within an automated workflow comprises invoking the agent at a specified step of the workflow, providing the agent with structured inputs conforming to a predefined schema, selectively passing referential fields from workflow data as contextual inputs, receiving structured outputs from the agent, and integrating the outputs deterministically into the next workflow step.

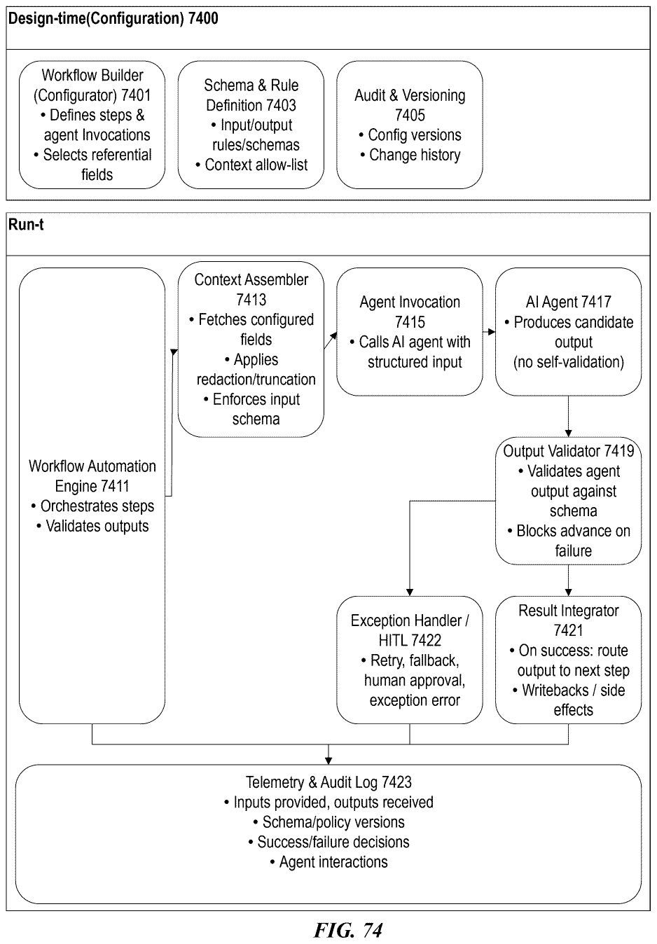

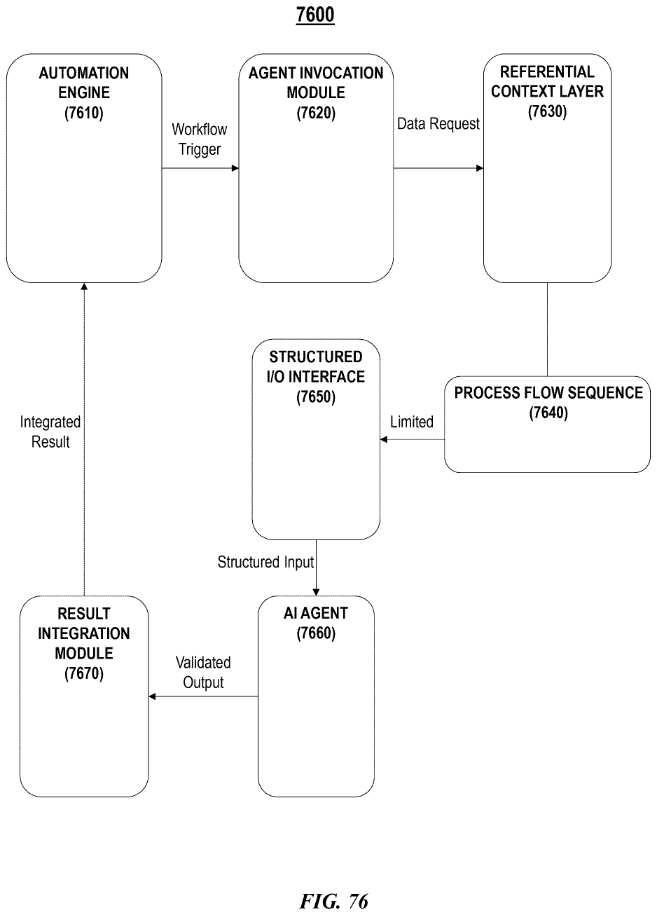

FIG. 74 shows an example system architecture for a workflow automation system. The system may comprise a design-time configuration 7400 and a run-time execution 7410. The system may comprise a plurality of components in the design-time configuration for workflow building 7401, schema definition 7403, audit and versioning 7405, and a plurality of components for context assembly 7413, agent invocation 7415, output validation 7419, and audit logging 7423. FIG. 76 shows an example of workflow 7600 for embedding a context constrained AI agent 7660 through the various components of the system. The various components may comprise an automation engine 7610, agent invocation module 7620, referential context layer 7630, structured I/O interface 7650, AI agent 7660, and result integration module 7670. The AI agent may reside on a data cloud configuration that is operatively coupled to the AI-driven workflow platform or the system.

In some embodiments, one or more components for embedding the context constrained AI agent can be part of the agent orchestrator as described above. In some embodiments, the agent orchestrator may be part of the workflow automation engine for orchestrating steps in the workflow. In some cases, the agent orchestrator may comprise the context assembler, the agent invocation component, the output validator, result integrator, exception handler in the runtime configuration as described herein. In some cases, the agent orchestrator may comprise the schema and rule definition in the design-time configuration. The one or more components for embedding the context constrained AI agent may reside on the AI-driven workflow platform while the AI agent residing on a data cloud configuration that is operatively coupled to the AI-driven workflow platform.

Referring to FIG. 76, a system for context-constrained agent operation in workflow automation may comprise an automation engine 7610 for workflow execution management, step sequencing control, data flow direction, and audit trail generation. The automation engine 7610 can be the same as the workflow automation engine 7411 shown in FIG. 74 that may be executed in the run-time execution and manage the overall workflow state, coordinate between different processing steps, and validate outputs generated at least by the embedded AI agent.

The system may comprise an agent invocation module 7620 functions as a middleware bridge layer that provides an AI agent communication interface and workflow integration point with trigger management capabilities. The agent invocation module can be the same agent invocation module 7415 as shown in FIG. 73 and may determine when and which AI agent should be invoked within the workflow sequence, prepare the data requests for agent processing, and manage the communication protocol between the workflow system and the AI agent. The agent invocation module may comprise a triggering mechanism configured to determine when conditions are met for invoking an AI agent within the workflow, a step designation handler configured to identify which specific AI agent or agent configuration should be used for a particular workflow step, and a communication protocol configured to define the specific methods and formats used for exchanging data with AI agents. The agent invocation module 7620 may comprise an integration interface configured to provide the technical connectivity between the workflow system and various AI agent implementations.

The system may comprise a referential context layer 7630 or context assembler component 7413 for processing the data request, selective data filtering, context scope limitation, and sensitive data protection. The referential context layer may ensure that only necessary and authorized data elements are exposed to the AI agent, reducing security risks and improving processing efficiency by limiting the scope of information that needs be processed. This context constraint approach may provide significant privacy protection benefits by implementing a least-privilege data access model, where AI agents receive only the minimum data required for their specific task, thereby reducing the risk of sensitive information exposure, unauthorized data access, and compliance violations.

The system may implement comprehensive privacy protection mechanisms through context constraints that limit AI agent access to selected data while preserving functional capabilities. In some cases, the referential context layer may enforce privacy boundaries limiting only essential data elements being exposed to AI agents based on their specific processing requirements. This approach may significantly reduce privacy risks by preventing AI agents from accessing personally identifiable information (PII), financial data, health records, or other sensitive content that is not directly relevant to their assigned tasks.

Context constraints may provide multi-layered privacy protection through field-level access controls that can be configured based on data sensitivity classifications, user authorization levels, and regulatory requirements. For example, in a customer service workflow, the system may provide an AI agent with order status and product information while excluding customer payment details, social security numbers, or personal contact information that is not necessary for resolving the specific customer inquiry.

In some cases, dynamic privacy controls may be employed to adjust the level of data exposure based on contextual factors such as the sensitivity of the workflow, the trustworthiness of the AI agent, and the potential impact of data disclosure. For example, the context assembler 7413 may implement adaptive privacy policies that provide more restrictive data access for high-risk scenarios and more permissive access for low-risk operations. This contextual approach to privacy protection may enable organizations to balance functional requirements with privacy obligations while maintaining operational efficiency.

In some cases, the context assembler 7413 may identify which specific data fields from the workflow context should be made available to the AI agent, based on predefined configuration rules and the requirements of the specific workflow step. In some cases, the context assembler 7413 may apply transformation, redaction, or truncation operations to the selected data fields to ensure that only necessary information is exposed to the AI agent. In some cases, the context assembler 7413 may implement access control policies and ensure that data exposure complies with organizational security requirements and regulatory constraints. In some cases, the context assembler 7413 may handle metadata information about the data being processed, such as data types, source systems, sensitivity classifications, and processing requirements, which may be used to guide the filtering and security enforcement processes.

Limited data exposure may reduce the risk of insider threats by ensuring that AI agents, even if compromised or misused, cannot access sensitive information beyond their designated scope. In some cases, the context assembler 7413 may implement role-based access controls that restrict agent permissions based on their specific functions and the sensitivity of the data they process. This granular access control approach may prevent privilege escalation attacks and limit the potential damage from compromised agent credentials or malicious agent behavior. For example, the system may implement data compartmentalization strategies that isolate sensitive information from AI agent processing environments. The context assembler 7413 may maintain detailed records of data sensitivity classifications, access patterns, and usage restrictions that allow for fine-grained control over information exposure. This compartmentalization approach may ensure that even if an AI agent is compromised, the attacker cannot access data outside the agent's designated operational boundaries.

The system may comprise a structured I/O interface 7650 providing a communication contract layer with schema validation capabilities for JSON/XML, data format enforcement, and deterministic governance. The structured I/O interface may be part of the workflow automation engine that is configured to define and enforce the specific format and content requirements for data exchanged between the workflow system and the AI agent, ensuring consistent and predictable interactions.

The system may comprise an output or schema validator 7419 within the structured I/O interface 7650 or the workflow automation engine 7610, and may be configured to perform multi-stage validation of agent outputs through a validation process. In some cases, the validation may comprise checking the AI agent output against the predefined schema for the respective workflow step. The checking may comprise, for example, whether required fields are missing, types match, or the format is correct. In some cases, the validation process may begin with syntactic validation that verifies the basic structure and format of the output data. In the example of JSON outputs, this may comprise checking for proper object nesting, field presence, and data type conformance. The schema validator 7419 may then perform semantic validation to examine the content and meaning of the data, including range checks for numeric values, pattern matching for strings, and relationship verification between interdependent fields. In some cases, business rule validation may apply domain-specific constraints such as transaction limits, timing requirements, or regulatory compliance checks.

In some cases, syntactic validation may verify that data structures conform to the basic formatting requirements of the specified schema language. For JSON schemas, this may include verifying proper bracket and brace matching, correct comma placement, valid string escaping, and adherence to JSON syntax rules. For XML schemas, syntactic validation may include checking element nesting, attribute formatting, namespace declarations, and compliance with XML well-formedness requirements. The validation process may generate detailed error messages that identify specific syntax violations, including line numbers, character positions, and descriptions of the detected problems. In some cases, semantic validation may examine the content and meaning of data elements to ensure they meet the logical requirements specified in the schema definition. This may include data type verification that confirms numeric fields contain valid numbers within specified ranges, string fields meet length and pattern requirements, and date fields contain properly formatted temporal values. Semantic validation may also include referential integrity checks that verify foreign key relationships, cross-field consistency validations that ensure related fields contain compatible values, and business rule enforcement that applies domain-specific constraints.

In some cases, upon validation failures (e.g., missing field, type mismatch), workflow engine or a compliance validator of the workflow engine may implement an exception handling framework. The framework may first attempt automatic recovery through retry mechanisms with modified parameters or alternative processing paths. If automatic recovery fails, the system may apply predefined fallback values from validated libraries while logging the substitution. For more severe validation failures, a workflow router of the workflow engine may implement escalation routing that directs issues to a human user based on failure type, workflow criticality, and reviewer expertise. All validation failures and recovery attempts may be logged with detailed contextual information to support analysis and system improvement.

The system may comprise a result integration module 7670 that is configured to incorporate the agent's output into the continuing workflow execution through a deterministic integration process. This integration may comprise output routing to specific subsequent workflow steps based on predefined routing rules and conditional logic, systematic updating of workflow variables and state information to reflect the agent's processing results, triggering of additional downstream processes or parallel workflow branches as specified in the workflow configuration, and performing writebacks to external systems or databases to persist the agent's contributions to the overall business process. Data transformation and mapping operations may be performed during the integration process to ensure that the agent's output format aligns with the input requirements of subsequent workflow steps.

Audit trail capabilities may enhance security by providing comprehensive monitoring and logging of all data access activities performed by AI agents. The system may comprise an audit trail generator 7423 configured to record detailed information about which data elements were accessed, when they were accessed, how they were used, and what outputs were generated. This comprehensive logging may enable security teams to detect suspicious activities, investigate potential security incidents, and demonstrate compliance with data protection regulations and organizational security policies.

Referring back to FIG. 74, the design-time configuration may comprise a workflow builder component 7401 configured to provide a visual canvas where users can design automated workflows by dragging and dropping workflow steps, decision points, and AI agent components from a comprehensive toolbox as described elsewhere herein. For example, the graphical interface may display workflow steps as interconnected nodes or blocks, with visual connectors that illustrate data flow and process dependencies between different workflow components. Users may configure AI agent invocations by selecting agent components from the toolbox and positioning them at appropriate points within the workflow sequence, with the interface providing real-time validation to ensure that agent placements conform to workflow logic and dependency requirements. The drag-and-drop functionality may enable users to easily reposition workflow elements, modify process sequences, and adjust agent invocation points without requiring manual code editing or complex configuration file modifications. The interface may provide visual feedback during drag operations, including snap-to-grid alignment, connection point highlighting, and compatibility indicators that help users understand valid placement options and potential configuration conflicts. When users drop an AI agent component onto the workflow canvas, the system may automatically present configuration dialogs that guide users through the process of defining agent parameters, input schemas, and output validation rules.

In some cases, the system may also provide a referential field selection interface for defining context allow-lists through visual data exploration and field selection mechanisms. The interface may display the complete data structure available at each workflow step in a hierarchical view, showing primary record fields, related entity data, external system references, and computed values in an organized, navigable format. For example, users may explore available fields, with the interface providing detailed metadata about each field including data type, sensitivity classification, source system, and usage history. As an example, the interface may allow users to build context allow-lists by checking boxes next to desired fields, dragging fields from the available data structure into an allow-list panel, or using search and filter functionality to locate specific fields within large data structures. The interface may provide real-time feedback about field selections, including security warnings for sensitive data elements, compliance notifications for regulated fields, and dependency alerts when selected fields require additional related fields to maintain data consistency and contextual coherence. The system may comprise field recommendation algorithms that suggest commonly used field combinations for specific workflow types or agent functions, helping users make informed decisions about context allow-list configurations.

During the design-time phase 7400, a workflow builder 7401 may define workflow steps and agent invocations, select referential fields that should be made available to AI agents, and configure the overall workflow structure through the comprehensive graphical user interface components described above. The schema and rule definition component 7403 may allow users to define context allow-lists which may serve as fundamental security and privacy control mechanisms that operate across both design-time configuration and run-time execution phases to ensure deterministic and secure data exposure to AI agents. The context allow-list may function as a predefined whitelist that explicitly specifies which data fields from the workflow context are permitted to be exposed to AI agents, implementing a least-privilege data access model that minimizes security risks and ensures compliance with organizational policies and regulatory requirements.

During the design-time configuration phase, workflow builders and users may utilize graphical user interfaces to create and manage context allow-lists for each AI agent integration point within automated workflows. The workflow builder component may provide intuitive tools that allow users to define the data structure available at each workflow step, including primary record fields, related entity data, external system references, and computed values derived from previous workflow operations. Users may selectively choose which specific fields should be included in the context allow-list for each AI agent invocation. In some cases, the design-time configuration process may require different levels of authorization based on data sensitivity classifications. For example, including personally identifiable information (PII) fields such as social security numbers, financial account details, or health records in a context allow-list may require approval from data governance officers, compliance teams, or senior management. The system may automatically classify data fields based on predefined sensitivity rules and apply appropriate approval requirements to ensure that sensitive data exposure decisions receive proper oversight and documentation.

The context allow-list versioning and change management features may track all modifications to allow-list configurations over time, maintaining detailed audit trails of who made changes, when changes were made, what specific fields were added or removed, and the business justification for each modification. The schema and rule definition component 7403 may implement version control mechanisms that allow for rollback to previous allow-list configurations if issues are discovered, while ensuring that all workflow instances use consistent allow-list versions to maintain deterministic behavior across different execution environments.

During run-time execution 7410, the context assembler 7413 may enforce context allow-list restrictions through validation and filtering processes that ensure only approved data fields are exposed to AI agents. As described above, the context assembler 7413 may implement real-time allow-list checking that compares each available data field against the configured allow-list for the specific workflow step and AI agent being invoked. This validation process may occur immediately before agent invocation to ensure that the most current allow-list configuration is applied and that no unauthorized data elements are inadvertently exposed. The context assembler 7413 may apply additional run-time transformations to allowed fields based on contextual factors such as the current user's authorization level, the sensitivity classification of the specific data instance, or dynamic risk assessments based on workflow execution context. For example, a field that is included in the context allow-list may still be subject to data masking, truncation, or aggregation operations if the current execution context indicates elevated security risks or if the specific data values exceed predefined sensitivity thresholds. As described above, the context assembler 7413 may perform dynamic allow-list evaluation to make context-sensitive data exposure decisions that adapt to changing conditions during workflow execution. The context assembler 7413 may implement conditional logic that evaluates runtime parameters such as time of day, geographic location, user authentication strength, or workflow execution priority to determine whether additional restrictions should be applied to the configured allow-list. This dynamic approach may provide enhanced security for high-risk scenarios while maintaining operational efficiency for routine workflow executions.

During run-time execution 7410, the workflow automation engine 7411 may orchestrate the execution of workflow steps and validate outputs at each stage. When a workflow step involving AI agent is reached, the context assembler 7413 may fetch the configured fields, apply any necessary redaction or truncation, and enforce the input schema as described above. The agent invocation component 7415 may call the selected AI agent with the structured input data. The AI agent 7417 may process the input and generate candidate output without performing self-validation, relying instead on the workflow system's validation mechanisms. An output validator 7419 may validate the agent output against the predefined schema and may block workflow advancement if the output fails validation. If validation fails, an exception handler 7422 may implement retry logic, fallback procedures, human approval processes, or error handling as appropriate for the specific workflow and organizational requirements. Upon successful validation, a result integrator 7421 may route the output to the next workflow step and handle any necessary writebacks or side effects. Throughout this process, a telemetry and audit log system 7423 may track inputs provided, outputs received, schema and policy versions used, success/failure decisions, and all agent interactions for compliance and analysis purposes.

The system and method herein may achieve deterministic AI agent behavior through constrained and structured inputs that beneficially allow for consistent, predictable, and repeatable processing outcomes across different workflow executions. By limiting AI agents to structured inputs that conform to predefined schemas, the system may eliminate the variability and unpredictability that can arise from unstructured or inconsistently formatted data. This deterministic approach may enable organizations to deploy AI agents in mission-critical workflows where consistent behavior and reliable outcomes are essential requirements.

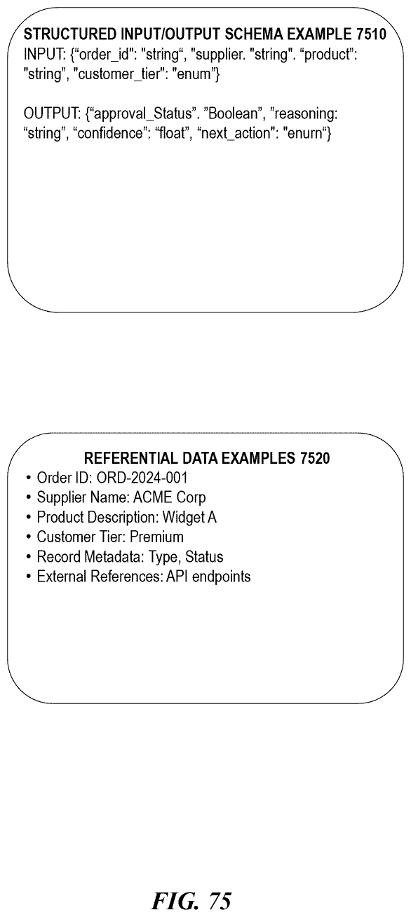

FIG. 75 shows an example of structured input and output 7510 generated by the system for an AI agent and the referential data 7520 processed by the context assembler. The input schema example shown in FIG. 75 may demonstrate a JSON Schema structure that defines the contract for data provided to an AI agent during workflow execution. The input schema may be defined as follows:
{“type”: “object”, “properties”: {“ticket_id”: {“type”: “string” }, “issue_type”: {“type”: “string”, “enum”: [“Delivery Delay”, “Damaged Item”, “Billing Issue” ]), “order_id”: {“type”: “string” }, “delivery_date”: {“type”: “string”, “format”: “date” }, “required”: [“ticket_id”, “issue_type”, “order id” ]).

This schema may specify a root object type with multiple required properties, each having defined data types and validation constraints. The “ticket id” property may be defined as a string type, which may serve as a unique identifier for customer support tickets within the workflow system. The ticket_id field may be constrained by pattern validation rules that ensure the identifier follows a specific format, such as requiring a prefix followed by a numeric sequence. The input schema may further include an “issue type” property that constrains the AI agent's understanding of the problem category being addressed. This field may be defined as a string type with enumerated values that limit the possible inputs to a predefined set of valid issue categories including “Delivery Delay”, “Damaged Item”, and “Billing Issue”. The enumeration constraint may ensure that the AI agent receives only recognized issue types, preventing processing errors that could occur with free-form or invalid category descriptions. Additional properties in the input schema may include “order_id” defined as a required string field and “delivery_date” defined as an optional string field with date format validation. The schema may specify that “ticket_id”, “issue_type”, and “order id” are required fields that must be present in all input data, while “delivery_date” may be optional depending on the specific workflow context.

The output schema example may define the structure and constraints for data that the AI agent must return upon completing its processing task. The output schema may be defined as follows:
{“type”: “object”, “properties”: {“draft_response”: {“type”: “string” }, “confidence_score”: {“type”: “number”, “minimum”: 0, “maximum”: 1}}, “required”: [“draft_response” ]).

The output schema may specify required response fields that ensure the agent provides all necessary information for subsequent workflow steps. For example, the output schema may include a “draft response” property defined as a required string type, which may contain the AI agent's generated response text for customer communication or internal processing purposes. The output schema shown in FIG. 75 may also include a “confidence_score” property that requires the AI agent to provide a numerical assessment of its certainty in the generated response. This confidence score may be defined as a number type with specific range constraints, requiring values between 0 and 1 inclusive, where 0 indicates no confidence and 1 indicates complete confidence in the response. The confidence_score field may be optional in the output schema, allowing agents to omit this field when confidence assessment is not applicable or available. The inclusion of confidence scoring in the output schema may enable the workflow system to make informed decisions about whether to accept the agent's output, request human review, or trigger alternative processing paths based on the agent's self-assessed reliability.

As an example, when the automation engine prepares to invoke an AI agent, the structured I/O interface may validate that all input data conforms to the defined input schema before transmitting the data to the agent. This pre-processing validation may include checking data types, verifying that required fields are present, ensuring that string fields meet length and pattern requirements, and confirming that enumerated fields contain only acceptable values. When the AI agent returns its processed output, the structured I/O interface may apply the output schema validation rules shown in FIG. 75 to ensure that the agent's response meets all specified requirements. The schema validator may verify that the draft_response field contains valid string content, that the confidence_score field contains a numerical value within the specified range, and that all required fields are present in the response. If any validation failures are detected, the result integration module may trigger an error handling procedure and may stop invalid data to proceed to subsequent workflow steps.

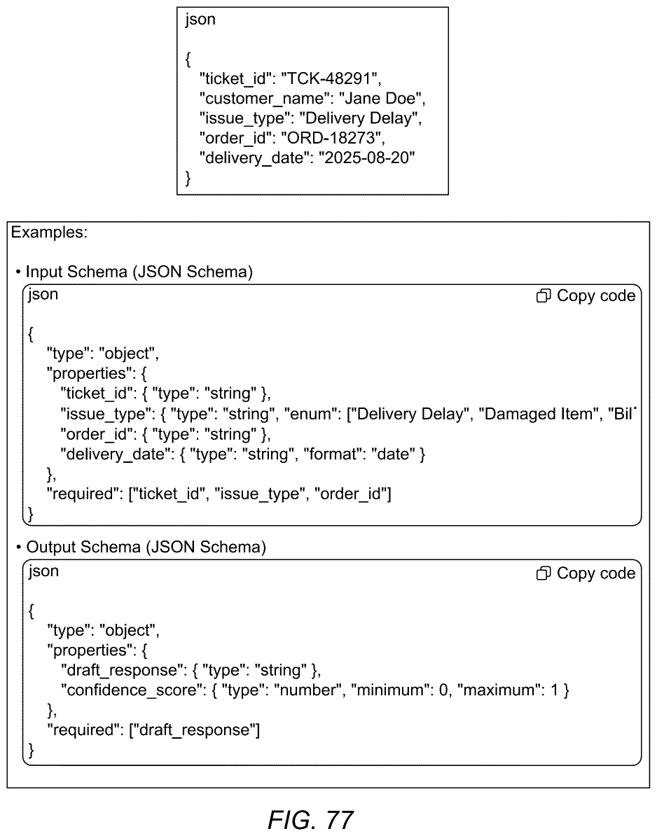

FIG. 77 shows additional examples of input schema and output schema. The schema definitions beneficially provide extensibility and reusability across different workflow contexts. The schema structures may accommodate inheritance and composition patterns that allow common field definitions to be shared across multiple workflow types while enabling specialized extensions for specific use cases. For example, a base customer interaction schema may define common fields such as customer_id and interaction_timestamp, which may then be extended by more specific schemas for different interaction types such as support tickets, sales inquiries, or billing disputes.

The structured input/output mechanisms may allow for deterministic AI agent integration within automated workflows. The structured inputs may comprise well-defined data objects that follow strict formatting requirements and validation rules to ensure consistent, predictable processing by AI agents. These data objects may be serialized in standardized formats including JSON (JavaScript Object Notation), XML (eXtensible Markup Language), YAML (YAML Ain′t Markup Language), or custom key-value pair structures depending on the specific workflow requirements and organizational preferences. In JSON format, structured inputs may be represented as objects containing typed fields with specific validation constraints. For example, a customer support workflow structured input may include a ticket_id field defined as a string with a specific pattern requirement (e.g., “TCK-[0-9]{5}”), an issue_type field constrained to an enumerated list of valid values (e.g., “Delivery Delay”, “Product Defect”, “Billing Issue”), and a priority_level field defined as an integer within a specified range (e.g., 1-5). Each field may include metadata specifying its data type, format constraints, validation rules, and whether the field is required or optional for agent processing. In some cases, the output structures may include result fields containing the agent's primary response, confidence_score fields indicating the agent's certainty level in its output, metadata fields providing processing context, and status fields indicating successful completion or error conditions. For instance, a document summarization agent may return a structured output containing a summary field with the generated text, a confidence_score field ranging from 0.0 to 1.0, a word_count field indicating the length of the summary, and a processing time field recording the duration of the summarization task.

FIG. 75 shows an example of referential data 7520. As described above, the determination and selection of referential fields may be through a multi-layered configuration process that operates during both design-time workflow construction (by the rule definition) and run-time execution phases (by the context assembler). During design-time configuration, workflow builders may utilize graphical user interfaces to specify which data elements from the workflow context should be made available to AI agents at each processing step. Selection criteria may determine whether a field is required for the agent's processing logic, security classification evaluations that assess the sensitivity level of each data element, compliance requirement checks that ensure selected fields meet regulatory constraints, and performance optimization considerations that balance information completeness with processing efficiency. For example, in a financial transaction workflow, the system may select transaction_amount, merchant category, and transaction_date fields as necessary for fraud detection processing, while excluding sensitive fields such as full_account_number, customer_ssn, or detailed_transaction_history. During runtime, the referential context layer or the context assembler may implement dynamic field selection mechanisms that can adjust the set of exposed fields based on runtime conditions, user permissions, or contextual factors. For example, the referential context layer may evaluate conditional logic rules that specify different field sets for different scenarios, such as providing additional context fields for high-priority transactions or restricting field access based on the requesting user's authorization level.

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

The invention includes methods that may be performed using the subject systems and configurations. The methods may comprise the act of providing such a suitable system, device, or apparatus. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only,” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. A computer-implemented method for an artificial intelligence (AI)-driven workflow platform, the method comprising:
(a) generating a workflow in the AI-driven workflow platform, wherein at least a portion of the workflow is automated by calling an AI agent, wherein the AI agent is executed natively within cloud data warehouse that is separate from and operatively coupled to the AI-driven workflow platform;
(b) maintaining, by a memory residing on the cloud data warehouse, context data or workflow states generated during an execution of the workflow;
(c) accessing, by an agent orchestrator residing on the AI-driven workflow platform, the context data or the workflow states stored in the memory on the cloud data warehouse without persisting the context data or the workflow states external to the cloud data warehouse:
(d) generating, by the agent orchestrator, a structured prompt for the AI agent and one or more parameters for executing one or more tools provided by the AI-driven workflow platform, wherein the structured prompt is generated based at least in part on the context data or the workflow states; and
(e) prompting the AI agent with the structured prompt and executing the workflow to perform an operation on one or more data objects within the cloud data warehouse without using an extract, transform and load (ETL) data integration process.

2. The computer-implemented method of claim 1, wherein the structured prompt comprises context information and constraints injected by the agent orchestrator thereby limiting data to be accessed by the AI agent.

3. The computer-implemented method of claim 1, wherein the agent orchestrator is configured to generate the context information by selecting one or more referential fields of the one or more data objects to be accessed by the AI agent.

4. The computer-implemented method of claim 3, wherein the one or more referential fields of the one or more data objects are defined in a design-time configuration and are dynamically adjusted by the agent orchestrator in a run-time configuration.

5. The computer-implemented method of claim 1, wherein the structured prompt is generated further based on an execution parameter or a data access policy.

6. The computer-implemented method of claim 1, wherein one or more tools comprise at least one of a workflow automation tool, a communication tool, a data retrieval tool, an integration application programming interface (API), and a decision support tool.

7. The computer-implemented method of claim 6, further comprising storing one or more constraints associated with the one or more tools in a toolset registry residing on the AI-driven workflow platform.

8. The computer-implemented method of claim 7, wherein the toolset registry is configurable by a user via a graphical user interface (GUI) provided by the AI-driven workflow platform.

9. The computer-implemented method of claim 8, wherein executing the one or more tools comprises validating an input or output of the AI agent against the one or more constraints associated with the one or more tools.

10. (canceled)

11. The computer-implemented method of claim 1, wherein the cloud data warehouse configuration comprises one or more data clouds storing the one or more data objects, and wherein the AI-driven workflow platform is granted permission to access, process, and edit the one or more data objects stored on the one or more data clouds.

12. The computer-implemented method of claim 11, wherein executing the workflow comprises mapping selected one or more data objects stored on the one or more data clouds to a data storage model of the AI-driven workflow platform.

13. The computer-implemented method of claim 12, further comprising defining a relationship between the selected one or more data objects and an element of the data storage model.

14. The computer-implemented method of claim 13, wherein the relationship is defined by a user via a graphical user interface (GUI) provided by the AI-driven workflow platform.

15. The computer-implemented method of claim 14, wherein the GUI permits the user to link one or more data fields of selected one or more data objects to one or more data fields or the element of the data storage model.

16. The computer-implemented method of claim 14, wherein the workflow is an interactive workflow and is built via the GUI.

17. The computer-implemented method of claim 16, wherein the interactive workflow permits a user to add, remove or modify one or more components of a cloud application by dragging and dropping one or more graphical elements to the interactive workflow.

18. A system for providing an artificial intelligence (AI)-driven workflow platform, the system comprising at least one processor and instructions executable to cause the at least one processor to perform operations comprising:
(a) generating a workflow in the AI-driven workflow platform, wherein at least a portion of the workflow is automated by calling an AI agent, wherein the AI agent is executed natively within a cloud data warehouse that is separate from and operatively coupled to the AI-driven workflow platform;
(b) maintaining, by a memory residing on the cloud data warehouse, context data or workflow states generated during an execution of the workflow;
(c) accessing, by an agent orchestrator residing on the AI-driven workflow platform, the context data or the workflow states stored in the memory on the cloud data warehouse without persisting the context data or the workflow states external to the cloud data warehouse;
(d) generating, by the agent orchestrator, a structured prompt for the AI agent and one or more parameters for executing one or more tools provided by the AI-driven workflow platform, wherein the structured prompt is generated based at least in part on the context data or the workflow states; and
(e) prompting the AI agent with the structured prompt and executing the workflow to perform an operation on one or more data objects within the cloud data warehouse without using an extract, transform and load (ETL) data integration process.

19. The system of claim 18, wherein the structured prompt comprises context information and constraints injected by the agent orchestrator thereby limiting data to be accessed by the AI agent.

20. The system of claim 18, wherein the agent orchestrator is configured to generate the context information by selecting one or more referential fields of the one or more data objects to be accessed by the AI agent.

21. The system of claim 20, wherein the one or more referential fields of the one or more data objects are defined in a design-time configuration and are dynamically adjusted by the agent orchestrator in a run-time configuration.

22. The system of claim 18, wherein the structured prompt is generated further based on an execution parameter or a data access policy.

23. The system of claim 18, wherein the one or more tools comprise at least one of a workflow automation tool, a communication tool, a data retrieval tool, an integration application programming interface (API), and a decision support tool.

24. The system of claim 18, wherein one or more constraints associated with the one or more tools are stored in a toolset registry residing on the AI-driven workflow platform.

25. The system of claim 24, wherein the toolset registry is configurable by a user via a graphical user interface (GUI) provided by the AI-driven workflow platform and wherein executing the one or more tools comprises validating an input or output of the AI agent against the one or more constraints associated with the one or more tools.

26. The system of claim 18, wherein the cloud data warehouse comprises one or more data clouds storing the one or more data objects, and wherein the AI-driven workflow platform is granted permission to access, process, and edit the one or more data objects stored on the one or more data clouds.

27. The system of claim 26, wherein executing the one or more tools comprises mapping selected one or more data objects stored on the one or more data clouds to a data storage model of the AI-driven workflow platform.

28. The system of claim 27, wherein the operations further comprise defining a relationship between the selected one or more data objects and an element of the data storage model.

29. The system of claim 28, wherein the relationship is defined by a user via a graphical user interface (GUI) provided by the AI-driven workflow platform.

30. The system of claim 29, wherein the GUI permits the user to link one or more data fields of selected one or more data objects to one or more data fields or the element of the data storage model.

31. The system of claim 29, wherein the workflow is an interactive workflow and is built via the GUI and wherein the interactive workflow permits a user to add, remove or modify one or more components of a cloud application by dragging and dropping one or more graphical elements to the interactive flow.
